(19) United States
(12) Patent Application Publication
(10) Pub. No.: US 2026/0269651 A1
(43) Pub. Date: Sep. 10, 2026

(54) DOCKING STATION FOR HUMANOID ROBOT

(71) Applicant: Figure AI Inc., San Jose, CA (US)

(72) Inventors: Ryan Benyshek, San Jose, CA (US); Basel Zohny, San Jose, CA (US); Adeel Zaheer, San Jose, CA (US); Sydney Hardy, San Jose, CA (US)

(21) Appl. No.: 19/558,420

(22) Filed: Mar. 5, 2026

Related U.S. Application Data
(60) Provisional application No. 63/767,281, filed on Mar. 5, 2025.
(60) Provisional application No. 63/839,474, filed on Jul. 7, 2025.
(60) Provisional application No. 63/839,479, filed on Jul. 7, 2025.
(60) Provisional application No. 63/850,760, filed on Jul. 25, 2025.
(60) Provisional application No. 63/875,074, filed on Sep. 3, 2025.
(60) Provisional application No. 63/874,723, filed on Sep. 3, 2025.
(60) Provisional application No. 63/875,558, filed on Sep. 4, 2025.

(51) Int. Cl. H02J 50/10; B25J 9/16; B25J 19/00

(52) U.S. Cl. CPC H02J 50/10; B25J 9/162; B25J 19/005

(57) ABSTRACT

A docking station for a humanoid robot comprises a wireless charging mat assembly with a base housing, a platform cover coupled to the base housing's upper surface, the platform cover comprising a wireless charging surface and a ramped portion extending forward and downward from the wireless charging surface, a wireless power transmitter within the base housing comprising at least one transmitter coil assembly beneath the wireless charging surface configured to generate an electromagnetic field for wireless power transfer to a humanoid robot, and at least one thermistor within the base housing. A charging controller is communicatively coupled to the transmitter coil assembly and thermistor, configured to receive temperature data, determine when a predetermined temperature threshold is exceeded, and adjust the electromagnetic field accordingly.

### CROSS REFERENCE TO RELATED APPLICATIONS

This application claims the benefit and priority to U.S. Provisional Application Nos. 63/767,281 filed Mar. 5, 2025, 63/839,474 filed Jul. 7, 2025, 63/839,479 filed Jul. 7, 2025, 63/850,760 filed on Jul. 25, 2025, 63/875,074 filed on Sep. 3, 2025, 63/874,723 filed on Sep. 3, 2025, and 63/875,558 filed on Sep. 4, 2025, each of which is expressly incorporated by reference herein in its entirety.

### TECHNICAL FIELD

The present disclosure relates to designing, manufacturing, and using a docking system, that is designed for use in charging a humanoid robot.

### BACKGROUND

The current workplace landscape is marked by an unparalleled labor shortage, evident in over 10 million unsafe or undesirable jobs within the United States. To counter this ever-expanding labor shortage, it has become imperative to design and integrate advanced robots capable of handling unappealing and even hazardous workplace tasks. With the goal of performing these tasks in an optimal and efficient manner, advanced robots are typically general-purpose humanoid robots tailored for human-centric environments. To work in human-centric environments, the general-purpose humanoid robot must include a battery to enable said robot to move from location to location without being coupled to an external power source. To this extent, the general-purpose humanoid robots must be able to recharge its internal battery. Accordingly, a need exists for an improved charging system that offers safe and enhanced power delivery, superior thermal management, and faster charging.

### SUMMARY

According to an aspect of the present disclosure, a humanoid robot is provided. The humanoid robot includes a torso. The humanoid robot includes a battery pack housed within the torso and configured to provide power to the humanoid robot. The humanoid robot includes a magnetic receptacle arranged on the torso of the humanoid robot. The magnetic receptacle includes at least one magnet configured to magnetically couple with a corresponding magnet of a magnetic connector of a cable assembly. The humanoid robot includes a receiver coil assembly positioned within the magnetic receptacle. The receiver coil assembly is configured to receive wireless power from a transmitter coil assembly housed within the magnetic connector of the cable assembly. The humanoid robot includes a charging controller electrically coupled to the receiver coil assembly and the battery pack. The charging controller is configured to convert alternating current induced in the receiver coil assembly to direct current for charging the battery pack.

According to another aspect of the present disclosure, a humanoid robot is provided. The humanoid robot includes a torso. The humanoid robot includes a battery pack housed within the torso and configured to provide power to the humanoid robot. The humanoid robot includes a magnetic receptacle arranged on the torso of the humanoid robot. The magnetic receptacle includes at least one magnet configured to magnetically couple with a corresponding magnet of a magnetic connector of a cable assembly. The magnetic receptacle includes a plurality of conductive contacts configured to electrically couple with corresponding conductive contacts of the magnetic connector when the magnetic connector is coupled to the magnetic receptacle. The humanoid robot includes a charging controller electrically coupled to the plurality of conductive contacts and the battery pack. The charging controller is configured to receive direct current via the plurality of conductive contacts for charging the battery pack. The humanoid robot includes a compute communicatively coupled to the charging controller and configured to establish a data communication link with a docking station via the cable assembly.

According to another aspect of the present disclosure, a system is provided. The system includes a humanoid robot. The humanoid robot includes a torso. The humanoid robot includes a battery pack housed within the torso and configured to provide power to the humanoid robot. The humanoid robot includes a magnetic receptacle arranged on a rear extent of the torso of the humanoid robot. The magnetic receptacle includes at least one magnet. The system includes a docking station. The docking station includes a cable assembly comprising a cable and a magnetic connector coupled to an end of the cable. The magnetic connector includes a corresponding at least one magnet configured to magnetically couple with the at least one magnet of the magnetic receptacle when the magnetic connector is brought into proximity to the magnetic receptacle. The docking station includes a power supply unit configured to provide power to the cable assembly for charging the battery pack of the humanoid robot when the magnetic connector is coupled to the magnetic receptacle.

In various embodiments, the physical configuration of the humanoid robot and its charging system includes specific structural features and placements for the magnetic receptacle. The receptacle may be located at the lower torso near the waist, or on the rear of the torso either above or below the cervical-thoracic junction. The magnetic coupling mechanism can utilize an electromagnet configured to selectively de-energize to release the connector, or it can be arranged to enable passive self-attachment when the components are in close proximity. For inductive charging, the magnet may be positioned behind the receiver coil, and the charging controller can incorporate a rectifier and a DC-to-DC converter to properly regulate the voltage. In variations utilizing conductive contacts, the receptacle may employ an array of non-directional spring-loaded pins for orientation-independent connection, or alternatively, an asymmetrical port housing that dictates a predetermined mating orientation. Additionally, the broader charging system may include a docking station equipped with a retractor assembly to smoothly extend and retract the cable as the robot moves.

According to further aspects, the humanoid robot features advanced operational capabilities and communication protocols while interacting with the charging system. The robot is configured to move and perform tasks within a designated working area defined by the cable's reach, utilizing the tethered connection to partly or entirely power itself during operation. If a task requires the robot to move outside this working boundary, it can proactively determine this requirement and autonomously detach the magnetic connector. To initiate charging, the robot may even utilize its own arm and hand assemblies to physically grip and insert the connector into the receptacle. Furthermore, the robot can integrate a compute unit to establish a data communication link with the docking station via the cable, allowing for the real-time transmission of vital charging information such as the battery's state of charge, temperature, received voltage, and any fault data.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an operating environment of a humanoid robot(s), and a network in which one or more humanoid robots may operate, connect, command and/or be commanded by, control and/or be controlled by, and/or interact;

FIG. 2 is a block diagram illustrating software and hardware components of the humanoid robot of FIG. 1;

FIG. 3A is a perspective view of the humanoid robot of FIGS. 1-2;

FIG. 3B is a diagram illustrating actuators contained within the humanoid robot of FIG. 3A and the corresponding rotational axes of said actuators;

FIG. 4 is a block diagram of numerous sensors for the humanoid robot of FIGS. 2-3B;

FIG. 5 is a block diagram of a communication interface for the humanoid robot of FIGS. 2-3B;

FIG. 6 is a block diagram of a movement controller for the humanoid robot of FIGS. 2-3B, the movement controller including a coordination engine and other components;

FIG. 7 is a block diagram of behavior manager components for the humanoid robot of FIGS. 2-3B;

FIG. 8 is a block diagram of an onboard or local artificial intelligence (AI) system for the humanoid robot of FIGS. 2-3B, the local AI system including AI data storage, a fine-tune training sub-system and other components;

FIG. 9 is a perspective view of the docking station and includes: (i) the base with the transmitter device arranged in a charging tower of the base, (ii) the support stand with a flared base, a vertical support member, and the support cradle, and (iii) the station electronics assembly;

FIG. 10 is a front view of the docking station of FIG. 9;

FIG. 11 is a side view of the docking station of FIG. 9;

FIG. 12 is an exploded view of the docking station of FIG. 9, and showing components of the base, the support stand, and the station electronics assembly;

FIG. 13 is an exploded view of the base and the station electronics assembly of FIG. 12, and showing the base includes: (i) a base housing, (ii) a charging tower that extends from the base housing and encloses around components of the transmitter device, and (iii) a thermal transfer device to transfer heat from the transmitter device;

FIG. 14 is a perspective view of a charging coil included in the charging tower of the docking station of FIG. 13;

FIG. 15 is an exemplary simultaneous localization and mapping “SLAM” image of the operational environment of the humanoid robot of FIGS. 1-3B;

FIG. 16A is a side view of the humanoid robot of FIGS. 1-3B and the docking station of FIG. 9, wherein the humanoid robot is in a forward approaching state approaching the docking station;

FIG. 16B is an image showing the view of the docking station from the robot's vision sensors while in the forward approaching state of FIG. 17A;

FIG. 17A is a side view of the humanoid robot of FIGS. 1-3B and the docking station of FIG. 9, wherein the humanoid robot is in a rearward approaching state;

FIG. 17B is an image showing the view of the docking station from the robot's vision sensors while in the rearward approaching state of FIG. 17A;

FIG. 18 is a side view of the humanoid robot of FIGS. 1-3B and the docking station of FIG. 9, wherein the humanoid robot is in a docked state;

FIG. 19 is a front view of the humanoid robot of FIGS. 1-3B and the docking station of FIG. 9, wherein the humanoid robot is in a docked state;

FIG. 20 is a flow diagram of an exemplary docking and recharging process shown in FIGS. 15-19;

FIG. 21 is a schematic diagram of the docking station and the humanoid robot of FIGS. 19-20;

FIG. 22 illustrates a block diagram of the wireless charging system of FIG. 21;

FIG. 23 is a front perspective view of a second embodiment of the docking station of FIG. 9, showing a support cradle of the docking station that permits wireless charging of the humanoid robot;

FIG. 24 is a front perspective view of a third embodiment of the docking station of FIG. 9, showing a support cradle of the docking station that permits contact charging of the humanoid robot;

FIG. 25 is a perspective view of a fourth alternative embodiment of a docking station that includes a support structure that allows the humanoid robot of FIGS. 1-3B to charge in a seated position as shown in FIG. 26;

FIG. 26 is a side view of the docking station of FIG. 25 showing the humanoid robot in the seated position on the support structure of the docking station;

FIG. 27 is a side view of a fifth embodiment of a docking station configured as an overhead docking station that provides for upright recharging of the humanoid robot of FIGS. 1-3B;

FIG. 28 is a perspective view of a sixth embodiment of a docking station for the humanoid robot of FIGS. 1-3B, showing a magnetically coupled cable assembly for wireless charging;

FIG. 29 is a perspective view of a seventh embodiment of a docking station for the humanoid robot of FIGS. 1-3B, showing a magnetically coupled cable assembly for conductive charging;

FIG. 30A is a rear view of a torso of the humanoid robot of FIGS. 1-3B, showing a magnetic receptacle for the docking stations of FIGS. 28 and 29 may be located on a lower extent of the robot's torso;

FIG. 30B is a rear view of a torso of the humanoid robot of FIGS. 1-3B, showing the magnetic receptacle for the docking stations of FIGS. 28 and 29 may be located on a central extent of the robot's torso; and

FIG. 30C is a rear view of a torso of the humanoid robot of FIGS. 1-3B, showing the magnetic receptacle for the docking stations of FIGS. 28 and 29 may be located on an upper extent of the robot's torso.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. INTRODUCTION

The factory floor of tomorrow will run on humanoid robots that walk, think, and work their way through warehouses, assembly lines, and logistics hubs- and every one of them will eventually need to recharge. That deceptively simple requirement is one of the hardest unsolved problems in commercial robotics, because the docking stations that serve today's squat, wheeled platforms are fundamentally incompatible with a machine that stands upright on two legs, carries its heaviest sensors and manipulators on its front side, and can topple the moment its motors lose power. This disclosure describes a docking station architecture and a family of related charging systems purpose-built for the mechanical, electrical, and operational realities of a humanoid form factor—a system that lets a bipedal robot navigate to its charger without human help, settle into a secure resting posture, power down almost entirely, and return to work with a full battery, all while occupying no more floor space than the robot itself.

Conventional docking stations assume forward engagement: a wheeled platform rolls nose-first into a cradle, and its low center of gravity and broad wheelbase keep it stable throughout. A humanoid robot upends every one of those assumptions. Its center of gravity sits high, roughly at waist level. Its most valuable hardware—cameras, LiDAR, communication antennas, dexterous arms—faces forward, so a front-engaging dock would obstruct the systems the robot needs to stay aware of its surroundings. And unlike a wheeled base that can cut power to its drive motors and stay put, a bipedal robot must actively fire dozens of leg, hip, and ankle actuators every moment it stands, burning precious energy on balance alone. A docking solution that ignores these realities either blocks the robot's senses, wastes the energy it is trying to replenish, or risks a dangerous fall the instant the robot tries to sleep.

The system disclosed here solves these problems with a rear-engagement strategy. The docking station extends a support cradle from a vertical stand behind and above a low-profile base, so that the robot backs into the cradle rather than driving forward. The cradle's inner surface is contoured to match the three-dimensional geometry of the robot's waist, and vertical alignment posts seat into corresponding recesses on the robot's body to lock it into a precise, repeatable position. Because engagement happens from behind, the robot's entire front side-eyes, arms, speakers-remains unobstructed, allowing it to monitor its environment, respond to voice commands, and perform light manipulation tasks while charging. The wide, flared base keeps the combined center of gravity planted over the most stable region of the platform, and the cantilevered cradle geometry ensures the robot's weight reinforces rather than undermines the station's resistance to tipping.

Once the cradle bears the robot's weight, it can shut down nearly every motor in its body. Maintaining an upright bipedal stance is an energy-intensive, continuous control problem; by transferring the gravitational load onto the station's rigid frame, the system allows the robot to de-energize those actuators entirely and drop into a deep-sleep state that would be physically dangerous without external support. Optional mechanical clutches or brakes lock joints in place so that even an unexpected power loss cannot compromise posture. The practical payoff is significant: nearly all incoming charging energy flows straight into the battery cells instead of being siphoned off for balance, dramatically shortening recharge time, reducing actuator wear, and enabling fleets of humanoid robots to cycle through rest-and-work periods with minimal human oversight.

Charging energy travels wirelessly through a pair of transmitter coil assemblies inside a charging tower that rises from the center of the base. Their flat, racetrack-shaped Litz-wire coils face outward through magnetically transparent sidewalls; when the robot stands on the base in its neutral stance, its shins—each containing a corresponding receiver coil—flank the tower on either side across a small air gap. A high-frequency alternating current generated by wide-bandgap semiconductor inverters (gallium nitride or silicon carbide) energizes the transmitter coils and creates an oscillating magnetic field that induces current in the receivers through electromagnetic induction. Impedance matching networks on each side tune the circuit to resonance for maximum transfer efficiency, while a closed-loop control architecture continuously monitors received power, battery voltage, cell temperature, and coil alignment, adjusting transmitted power in real time. Ferrite shield layers behind each coil guide magnetic flux toward the receiver and protect the station's electronics from stray fields.

High-power wireless charging generates substantial waste heat, and the disclosure addresses thermal management with equal rigor. Heat spreaders bonded to each coil assembly conduct thermal energy through copper or heat-pipe conductors to a finned thermal transfer device at the rear of the base, where fan assemblies force air along serpentine channels to carry the heat away. Unshielded thermistors—chosen specifically so the charging field does not inductively heat the sensor—feed continuous temperature readings to the controller, which can throttle or terminate power transfer if temperatures approach safe limits. This active cooling infrastructure sustains high charging currents without thermal throttling, further compressing the time the robot spends off the job.

The entire docking sequence is autonomous. The robot's power management system continuously monitors battery state and computes a dynamic threshold that accounts for distance to the charger, return-trip energy cost, and terrain. When charge drops below that threshold, the robot consults a SLAM-generated environment map, plans an energy-optimal path, and begins walking. Forward-facing cameras perform visual servoing for coarse alignment; the robot then pivots and backs toward the cradle using rear-facing sensors for fine guidance. Its foot placement controller steers each shin beside the charging tower, and a coordinated squat lowers the waist into the cradle. Force-torque sensors in the spine and hips confirm balanced contact, and a haptic click as the alignment posts seat provides unambiguous dock confirmation. A digital handshake over a short-range wireless link triggers the station to energize its coils, and the robot enters deep sleep. When charging completes—or a high-priority task arrives—the robot reverses the sequence, verifies postural stability, and walks away ready for work.

Beyond the primary standing-dock configuration, the disclosure describes a broad family of alternative embodiments. A direct-contact variant replaces the wireless tower with conductive charging posts in the cradle arms, delivering high-amperage current through spring-loaded, self-wiping pins into waist recesses—suited to wet or washdown environments where ground-level electronics are impractical. Another variant relocates the wireless transmitter coil into the cradle body, transferring power at waist level while hardwired communication posts handle high-bandwidth data, decoupling power and data so each can be independently optimized. A seated-charging embodiment embeds transmitter coils in a flexible mat that drapes over a chair, bench, or vehicle seat, letting the robot top off its battery during seated work or transit without a dedicated docking session. An overhead tethered configuration mounts the power source on a ceiling track and delivers energy through a retractable cable terminated by a magnetic connector that self-aligns with a torso-mounted receptacle, allowing continuous powered operation within a defined area and clean magnetic detachment when tasks take the robot beyond the cable's reach.

Each magnetic-connector embodiment exploits a carefully engineered interplay of permanent magnets—and in some cases controllable electromagnets—to achieve passive self-alignment within a few centimeters, a breakaway force calibrated to prevent accidental disconnection yet permit clean separation, and, in the conductive variant, concentric annular contact rings that complete circuits regardless of rotational orientation. The robot can even plug itself in by gripping the connector with one hand, reaching around to its back using proprioceptive joint knowledge, and bringing the connector close enough for the magnets to snap it into place. Combined with the overhead track system's ability to follow the robot along a rail, this creates a charging architecture that can keep a humanoid robot energized almost indefinitely within a workspace, fundamentally changing how long it can stay on task.

Taken together, these systems represent a comprehensive engineering response to a problem that will only intensify as humanoid robots move from laboratories into factories, warehouses, hospitals, and homes. The disclosed architecture treats charging not as an interruption but as a seamlessly integrated phase of operational life-one that preserves situational awareness, minimizes downtime, protects mechanical systems from wear, and scales from a single station to a networked grid managing an entire fleet. By rethinking the relationship between a bipedal machine and its power source from first principles, the invention lays the groundwork for humanoid robots that work around the clock, recharging as naturally and autonomously as they walk.

### B. DEFINITIONS

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

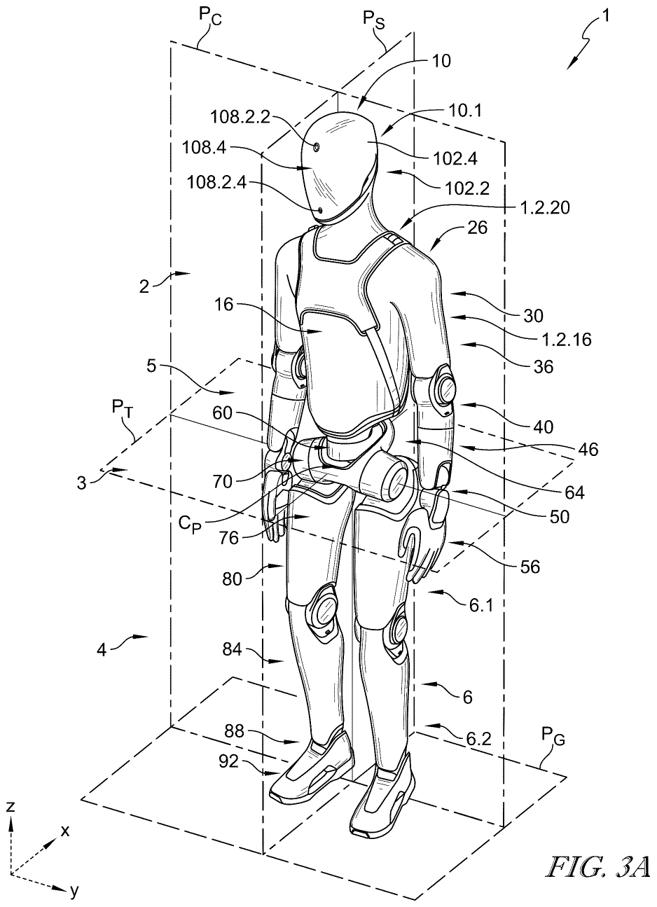

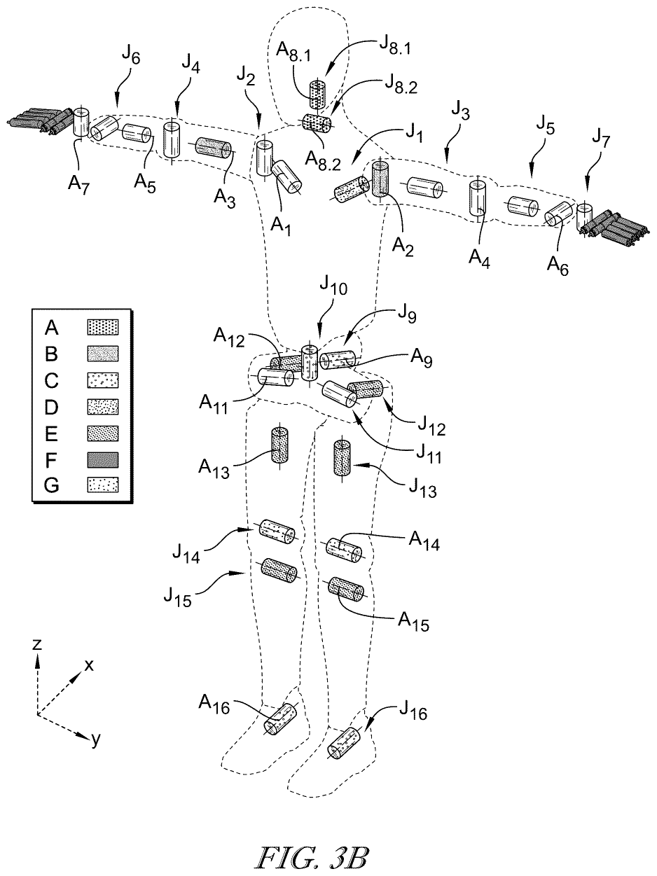

Neutral State: a state where the robot is standing upright on a horizontal support surface (P_{G}) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (P_{C}) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (PT) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (Cp) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. ROBOT(S) AND ENVIRONMENT

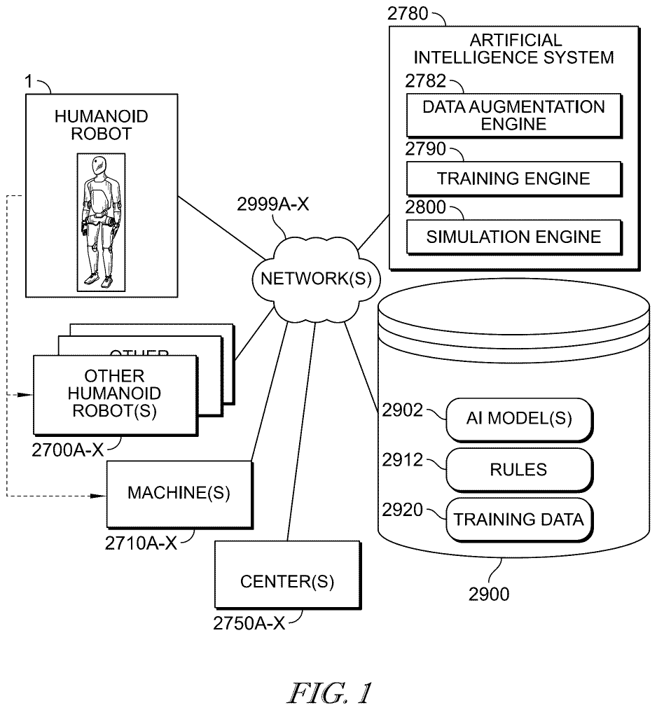

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals, and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of visual data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. HUMANOID ROBOT

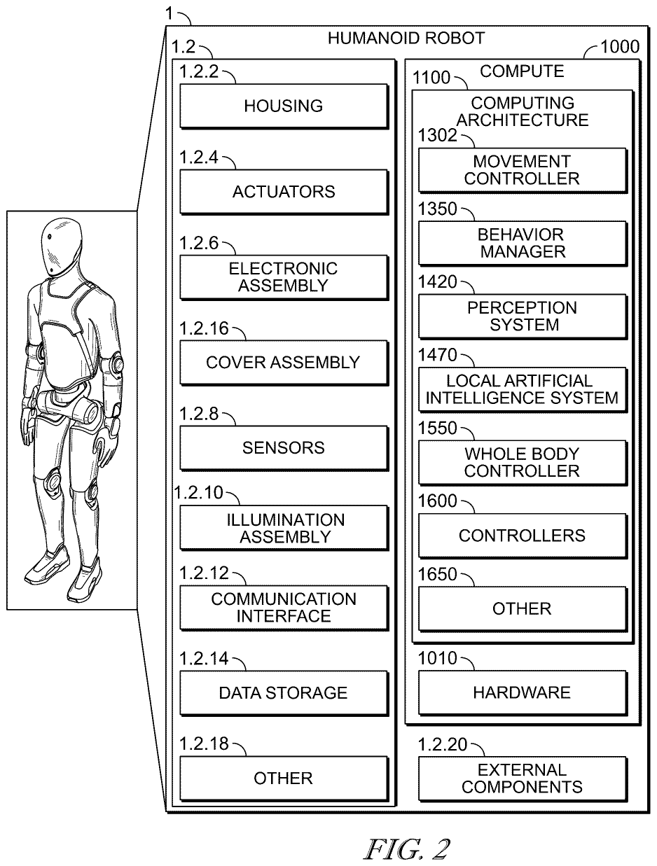

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, exterior covering assembly 1.2.16, external components 1.2.20, other components 1.2.18, and (ii) compute 1000 that includes a computing architecture 1100.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

i. Robot Components

In addition to the general systems, assemblies, components, and parts described above, the humanoid robot 1 in the illustrative embodiment shown in FIG. 3 may include the following systems, assemblies, components, and parts, which can be broadly categorized into three regions. As shown in FIG. 3, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane P_{S} but is asymmetrical about Z-Y and X-Y planes that intersect the head and are parallel to the coronal plane (P_{C}) and the transverse plane (P_{T}), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane. This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences-without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head 10.1 about axis A_{8.1,} which is a vertical (yaw) axis when the robot is in the neutral state, and a head nod actuator (J8.2) 140, which enables rotation of the head 10.1 about the axis A_{8.2}, which is a horizontal axis when the robot is in the neutral state. Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. This head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head 10.1 accurately, enabling the humanoid robot 1 to track objects, focus on specific areas of interest, or maintain eye contact during human-robot interactions. The actuators may be controlled, in conjunction with input from visual and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle.

Variations of this design may include the addition of a third actuator to provide roll motion, which would further increase the range of movement of the head 10.1 to three degrees of freedom (3-DoF) and could enable more expressive head gestures, such as tilting the head sideways to convey curiosity or empathy. Alternatively, for specialized applications, the actuators (J8.1) and/or (J8.2) may be replaced with compact linear actuators or parallel-link mechanisms.

Additionally, variations of head 10.1 may include modular head designs that allow for the quick customization or replacement of sensory and communication components. These modular designs may facilitate easy upgrades or modifications to the capabilities of the humanoid robot 1 without requiring extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback.

### 2. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 contains various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a charging system, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

The arm assemblies include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 4. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

i. Actuators

The actuators 1.2.4 contained within the robot 1 include thirty actuators (J1)-(J16), excluding the end effectors, that are housed within various components of the robot 1 to actuate movement of said components. An additional aggregate total of twelve actuators are in both hands 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the below table.

TABLE 1

| Actuator | Qty | Actuator Name | Informal Actuator Name(s) | Axis |
|---|---|---|---|---|
| (J1) 190 | 2 | arm | primary arm | A₁ |
| (J2) 280 | 2 | shoulder | (none) | A₂ |
| (J3) 320 | 2 | upper arm twist | upper arm x, upper arm roll | A₃ |
| (J4) 374 | 2 | elbow | arm z, arm yaw, lower humerus | A₄ |
| (J5) 468 | 2 | lower arm twist | lower arm x, lower arm roll | A₅ |
| (J6) 484 | 2 | wrist flex | wrist/hand y, wrist/hand pitch, flick | A₆ |
| (J7) 520 | 2 | wrist pivot | wrist/hand z, wrist/hand yaw, wave | A₇ |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, forward kick | A₁₁ |
| (J12) 768 | 2 | hip roll | hip x, hip/leg roll, sideways kick | A₁₂ |
| (J13) 782 | 2 | leg twist | hip z, hip/leg yaw | A₁₃ |
| (J14) 820 | 2 | knee | lower thigh, lower leg y, lower leg pitch, rear kick | A₁₄ |
| (J15) 860 | 2 | foot flex | foot y, foot pitch, or first ankle | A₁₅ |
| (J16) 900 | 2 | foot roll | talus, foot roll, foot x, second ankle | A₁₆ |

It should be understood that in other embodiments, some of these systems, assemblies, components, and/or parts may be omitted, combined, or replaced with alternative systems, assemblies, components, and/or parts.

ii. External Cover Assembly

The illustrative embodiment robot 1 includes various components (e.g., assemblies) with housings 1.2.2 (e.g., to form an exoskeleton) that are designed to protect the operational systems of the robot 1, such as actuators 1.2.4 and electronics assembly 1.2.6, provide structural support, and give form to the robot 1. Said housings 1.2.2 can be comprised of hard or rigid casings that may include internal mounting features designed to support systems in specific locations, structural features engineered to withstand operational loads, and internal and/or external features that allow for interoperation between adjacent components and/or are formed to resemble human features. Some housings 1.2.2 additionally include one or more detachable shells that may overlay a casing to allow access to internal assemblies or to complete the form of the component.

The requirements of the housings 1.2.2 can vary in shape and form based on the individual structural or material requirements for each specific component. While it may be desirable to utilize a particular material for all housings 1.2.2 to create a consistent exterior appearance, fabrication may be complicated by specific structural or operational needs at different locations. It may not be necessary to utilize the same materials in different housings 1.2.2 that experience different load requirements. Various materials may be preferred for a specific housing 1.2.2 based on properties such as strength, toughness, elasticity, weight, and conductivity. Similarly, the complexity of some housing 1.2.2 designs may be better suited for one type of manufacturing process, such as machining, die casting, injection molding, or composite fabrication, over another. Because there is a desire or need to use different materials within different regions and/or use materials that do not have a consistent exterior appearance, the illustrative embodiment robot 1 includes exterior coverings of the exterior covering assembly 1.2.16 that are designed to at least partially hide the housings 1.2.2 under a textile exterior layer that can be easily swapped if damaged, serve to protect internal components from dust and debris, are designed to fit the form of the robot 1 without substantial wrinkling, and/or allow for venting or address thermal considerations at specified locations.

The exterior coverings may have a multi-layered assembly, which may include: (i) an energy-absorbing material that is coupled to the coupling layer, (ii) a coupling layer (e.g., plastic or polymer based), wherein the coupling layer facilitates attachment to, or attachment at, a housing 1.2.2, and/or (iii) an exterior coverings material (e.g., a textile). Alternatively, the multi-layered assembly may omit the coupling layer, the energy-absorbing material, and/or exterior covering material. In each case, the movement of the nearby joint may cause one housing 1.2.2 to impact or crush the energy absorbing layer instead of another housing 1.2.2, thereby mitigating or eliminating structural stress or load on either housing 1.2.2 and/or the respective actuator 1.2.4. Additionally, the energy attenuation members help to reduce pinch points, and/or allow for a more human-like appearance.

### 1. Energy Attenuation Assembly

The energy attenuation assembly may be composed of a plurality of integrated or removable energy attenuation members, such as pads, panels, or bumpers, that are attached to housings 1.2.2 of the robot 1 and/or are positioned within the external covers. Said energy attenuation members may: (i) be attached directly to a particular exterior side of a housing 1.2.2 (e.g., overlie the housing), (ii) surround an exterior of a housing 1.2.2 and not be directly attached (e.g., friction fit), (iii) be attached to the edges of an opening formed in the housing 1.2.2 (e.g., act as a deformational extent of the housing), and/or (iv) be attached to or retained by the exterior coverings.

The disclosed robot 1 includes a torso energy attenuation member, elbow energy attenuation members, and leg energy attenuation members. Additionally, energy attenuation members may be included at the hip, shin, and/or foot. Some or all energy attenuation members may also be omitted. Energy attenuation members can be configured to enhance or alter the shape of the robot 1 without adding substantial weight and to provide a deformable structure with energy absorption properties to protect underlying components.

The energy attenuation members can be made from a wide variety of materials, including: (i) polymers, such as polyethylene foam (PE Foam), ethylene vinyl acetate (EVA) foam, polyurethane foam (including Memory Foam and Open-cell Polyurethane Foam); (ii) rubber foams; (iii) natural foams; (iv) engineered foams; (v) composite and hybrid materials; (vi) expanded polystyrene (EPS); (vii) expanded polypropylene (EPP); (viii) Koroyd®; (ix) D30®; (x) Poron® XRD; (xi) thermoplastic elastomers (TPE) or thermoplastic polyurethane (TPU); (xii) any other material known to one of skill in the art that accomplishes the desired energy absorption characteristics; (xiii) any combination of the above. Furthermore, the energy-absorbing material may alternatively or additionally include other structures of said materials, wherein said structures may include lattices and/or repeating units, such as a cube, sphere, cylinder, cone, pyramid, torus, prism, tetrahedron, dodecahedron, octahedron, icosahedron, ellipsoid, paraboloid, cuboid, or hexahedron. It should be understood that the repeating unit or lattice cell may be contained in a specific region or may propagate throughout the entire energy attenuation member. Additionally, the energy attenuation members and/or the assembly may have varying properties, such as thickness, density, C/D ratio, and stiffness. This variation may be arranged in a gradient manner, wherein the energy-absorbing materials transition from softer to firmer layers or regions to provide progressive energy dissipation.

### 2. Exterior Coverings

The exterior coverings, which can include a neck cover, a torso cover, an upper leg cover, a shin cover, a foot cover, a lower arm cover, and a hand cover, are designed not to interfere with the robot's range of motion, to allow access to underlying components, to potentially add indicators to the external surface, and to improve the robot's overall aesthetic appearance. As shown in the figures, a single exterior covering does not extend over all actuators in the robot 1, and typically does not cover more than five actuators at a time. In other words, the exterior covering does not resemble an oversized jumpsuit with a closure running from, e.g., the robot's pelvis to its head region, nor does it include a hood that extends around a substantial portion of the robot's head. Instead, the exterior covering is strategically and tightly fitted in certain regions and may include different inserts (e.g., a different textile) that are positioned between the moving aspects of joints.

Exterior coverings materials of the exterior covering assembly 1.2.16 can be made from one or more textiles and can be customized or selected to reduce wrinkling and to allow for the twisting or movement of the underlying components without restriction or substantial distortion. For example, the exterior coverings materials may be designed to allow the lower arm to twist and rotate from about −120 degrees to about 180 degrees. Additionally, the exterior coverings materials may be selected to allow for the cooling of components, the viewing of indicator lights, or the operation of buttons through said exterior coverings. This provides a substantial benefit over conventional systems that lack these advanced features. It should be understood that this disclosure contemplates using or including exterior coverings materials that: (i) integrate lights from the robot 1 into said exterior covering, and specifically into a textile itself, (ii) may be translucent or temporarily translucent (e.g., based on time or environment), and/or (iii) can be formed (e.g., woven) in a manner that allows light to be transmitted through the textile.

As such, various types of lights (e.g., fiber optic lighting, led strip lights, led rope lights, micro-led string lights, led neon flex, phosphorescent paint, OLED panels (organic light-emitting diode), laser diode lighting, neon tubing, electroluminescent panels, led edge-lit panels, flexible led sheets, flexible OLED strips, inductive electroluminescent displays, laser fiber cables, quantum dot light-emitting displays, phosphor-coated led strips, laser-activated fluorescent materials, electroluminescent paint, laser-illuminated fiber bunches, phosphor-coated electroluminescent (PCEL) materials, smart RGB led strips, light-up silicone tubing (LED or EL-based), laser wire, or other electroluminescent materials such as EL wire, EL tape, or EL film) that are coupled to the humanoid robot 1 may be visible through the exterior coverings material. The exterior coverings material can include reflective yarn or night-luminous yarn that changes its appearance when light is shining on its surface. In other embodiments, a shiny, reflective, iridescent, matte, or textured polyurethane film can be applied to the surface of the exterior coverings material (e.g., a textile) in certain areas to provide an additional reflective effect or for another purpose, such as displaying a logo, pattern, or labels.

The exterior coverings material can also include features to accommodate the thermal considerations of the robot 1. In various examples, the exterior coverings material can be a custom textile that utilize different weaves in different locations to allow for ventilation in specific areas. Additionally, the exterior coverings material can include textiles or threads that are heat-sensitive and change color with a change in temperature. In summary, the exterior coverings may additionally be made from, include, or specifically omit any one or any combination of the following material types: durable materials, flame-resistant materials, waterproof materials, hazard materials, chemical-resistant materials.

Alternatively or additionally, the exterior covering assembly 1.2.16 may include features such as closures (e.g., a zipper that runs a partial or full length of the exterior covering assembly 1.2.16), attachment points, couplers, self-cleaning nanocoatings, thermoelectric materials, photochromic dyes, or electromagnetic shielding layers, as well as modular, quick-release panels or e-textile technology with conductive fibers woven throughout to create a distributed sensor network that is capable of detecting impacts, monitoring joint angles, or even harvesting energy from movement. The exterior covering assembly 1.2.16 may be designed to include inserts (which may also be textiles or may be other materials) that are positioned strategically between moving joint components to further ensure that pivoting motion is not restricted at the joints of the humanoid robot 1. Different textile materials, patterns, knits, weaves, etc. may be incorporated to facilitate movement in specific regions, thereby enhancing the functional dexterity of the robot 1.

iii. Sensors

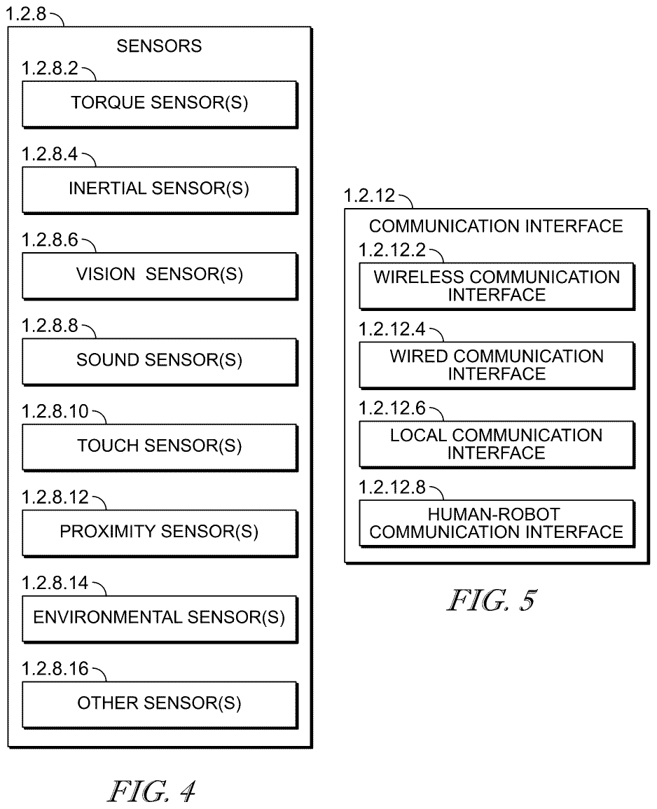

As illustrated in FIG. 4, sensors 1.2.8 may be embodied as any hardware, software, and/or circuitry for providing sensor data indicative of perceived stimuli, conditions, and measurements to enable the humanoid robot 1 to process, reason, and act appropriately (e.g., based on a given task, a set of rules, and/or other constraints). The sensors 1.2.8 may include one or more torque sensors 1.2.8.2, inertial sensors 1.2.8.4, visual sensors 1.2.8.6, auditory sensors 1.2.8.8, touch sensors 1.2.8.10, proximity sensors 1.2.8.12, environmental sensors 1.2.8.14, and other sensors 1.2.8.16. The sensors 1.2.8 may provide sensor data (e.g., torque, inertia measures, audiovisual sensor data, touch data, proximity data, environmental data, etc.) to the compute 1000 processors, further described below, to enable appropriate interaction between the humanoid robot 1 and the environment.

The torque sensors 1.2.8.2 may comprise one or more torque cells that are positioned within the actuators and are designed to measure the amount of force or torque applied to a part of the humanoid robot 1. The measurements may be transmitted to other components of the humanoid robot 1, such as the whole body controller 1550 or one or more controllers 1600, to enable balance, locomotion, manipulation, and handling by the humanoid robot 1.

The inertial sensors 1.2.8.4 may comprise sensors for measuring the motion, position, and orientation of the humanoid robot 1 relative to the environment for purposes of navigation, stabilization, and interaction with the environment and surroundings. For example, the inertial sensors 1.2.8.4 can include one or more accelerometers (e.g., to measure acceleration forces in one or more directions for use in determining changes in velocity and orientation), gyroscopes (e.g., to measure angular velocity for use in tracking rotational movement and maintaining balance), IMUs (e.g., combining the accelerometers and gyroscopes for use in providing comprehensive motion and orientation data), and Global Positioning System (GPS) receivers (e.g., to provide location data based on satellite signals, for use in outdoor navigation and positioning).

The visual sensors 1.2.8.6 may comprise sensors for capturing visual data, including cameras (e.g., red-green-blue (RGB) standard color cameras, grayscale monocular cameras, and stereo cameras (e.g., to capture depth perception)), depth cameras (e.g., depth cameras using technologies such as structured light or time-of-flight to measure distance to objects, Azure® Kinect® depth camera, Intel® RealSense® depth camera, etc.), LIDAR (Light Detection and Ranging) sensors (e.g., to measure distance to objects by emitting laser pulses, analyze the reflections, and provide detailed 2D or 3D maps of the environment), radar (e.g., to detect objects via radio waves and measure distance and speed for use in various applications including navigation and obstacle detection). Visual sensors 1.2.8.6 may also include event-based cameras, which report changes in pixel intensity rather than full frames, offering advantages in speed and data efficiency for dynamic scenes. Examples of said visual sensors 1.2.8.6 include the cameras 108.2.2 and 108.2.4 contained in the head 10.1 of the robot 1.

The auditory sensors 1.2.8.8 may comprise sensors for capturing audio data, including microphones (e.g., to capture audio signals for voice recognition, environmental noise detection, or communication), ultrasonic transducers (e.g., to capture distance measurement and obstacle detection through high-frequency sound waves), spatial audio sensors such as microphone arrays and direction of arrival sensors (e.g., to capture sound from different locations to determine the direction and distance of sound sources for 3D positioning). Auditory sensors 1.2.8.8 could also include specialized acoustic sensors for detecting specific sound patterns, such as the sound of failing machinery or distress calls, further enhancing the robot's environmental awareness.

The touch sensors 1.2.8.10 may comprise sensors for detecting physical contact or pressure applied to the surface of the humanoid robot 1, e.g., to enable tactile feedback, safety and collision avoidance, object handling and manipulation, and interaction with the environment and surroundings. Example touch sensors 1.2.8.10 may include pressure sensors to measure an amount of pressure applied to a surface by the humanoid robot 1, such as capacitive sensors (e.g., to detect touch or proximity through changes in capacitance), resistive sensors (e.g., to detect pressure or touch by measuring changes in resistance), piezoelectric sensors (e.g., to generate an electrical charge in response to mechanical stress or pressure and detect vibrations or impact), force-sensitive resistors (e.g., to change resistance based on the amount of applied force), and optical touch sensors (e.g., to use light beams or infrared to detect touches or proximity). Alternative touch sensors 1.2.8.10 may involve artificial skin technologies that provide a more distributed and nuanced sense of touch, capable of detecting not only contact but also shear forces and temperature changes on the robot's surfaces.

The proximity sensors 1.2.8.12 may comprise sensors for detecting the presence or absence of objects within a given range without necessarily making physical contact with the object, e.g., to provide obstacle avoidance, navigation, and object detection. Example proximity sensors 1.2.8.12 can include ultrasonic sensors (e.g., to measure distance by emitting ultrasonic waves and detecting reflection of the waves for avoiding obstacles and measuring distance) and infrared rangefinders (e.g., to detect, using infrared light, the presence or distance of objects for proximity sensing and simple obstacle detection). Capacitive proximity sensors may also be used as part of proximity sensors 1.2.8.12, particularly for close-range interactions.

The environmental sensors 1.2.8.14 may comprise sensors for measuring various physical parameters of the environment and surroundings to enable the humanoid robot 1 to interact with the environment and surroundings, adapt to changes in the environment and surroundings, and perform a given task. Example environmental sensors 1.2.8.14 can include thermocouples (e.g., to measure temperature by generating a voltage proportional to temperature difference), thermistors (e.g., to measure temperature based on changes in resistance), magnetometers (e.g., to measure magnetic fields for navigation and orientation), light sensors (e.g., to measure intensity of light in the environment), gas sensors (e.g., to detect presence and concentration of various gases and monitor air quality), and humidity sensors (e.g., to measure relative humidity in the air). Other environmental sensors 1.2.8.14 could include barometric pressure sensors for altitude determination or weather prediction, radiation sensors for operation in hazardous environments, or particulate matter sensors for air quality assessment in industrial settings.

iv. Communication Interfaces

The communication interfaces 1.2.12 may be embodied as any hardware, software, or circuitry to enable the exchange of data, signals, and other forms of communication between different components within the humanoid robot 1, and between the humanoid robot 1 and other systems (e.g., other humanoid robots 2700A-X, the command centers 2750A-X, the remote AI system 2780), and other components and devices interconnected over the networks 2999A-X. Specifically, FIG. 5 shows that the humanoid robot 1 may be configured with a variety of communication interfaces 1.2.12. The communication interfaces 1.2.12 may be embodied as any combination of a communication circuit, device, or collection thereof, capable of enabling communications over a network (e.g., the networks 2999A-X). The communication interfaces 1.2.12 may be configured to use any one or more communication technology (e.g., wired or wireless communications) and associated protocols to effect such communication.

Referring to FIG. 5, examples of communication interfaces 1.2.12 include a wireless communication interface 1.2.12.2 (e.g., Bluetooth®, Wi-Fi®, WiMAX, Cellular (e.g., 3G, 4G, 5G), Zigbee, LoRa (Long Range) and RF (Radio Frequency)), a wired communication interface 1.2.12.4 (e.g., Ethernet, USB, Serial Communication (e.g., RS-232, RS-485), and Controller Area Network (CAN) interface)), a local communication interface 1.2.12.6 (e.g., an I2C (Inter-Integrated Circuit), SPI (Serial Peripheral Interface)), and a human-robot communication interface 1.2.12.8 (e.g., voice recognition systems to enable communication through spoken commands using speech recognition technology, touch interfaces such as touchscreens or physical buttons for direct human interaction with the humanoid robot 1). Alternatively or additionally, the human-robot communication interface 1.2.12.8 may include gesture recognition systems or gaze tracking, allowing for more intuitive and non-verbal interaction with human operators. The communication interfaces 1.2.12 may also include a network interface controller (NIC) (not illustrated), which may also be referred to as a host fabric interface (HFI). The NIC may be embodied as one or more add-in-boards, daughtercards, controller chips, chipsets, or other devices that may be used by the humanoid robot 1 for network communications with remote devices.

v. Data Storage

Referring back to FIG. 2, the data storage 1.2.14 may be embodied as any hardware, software, or circuitry for storing, retrieving, and maintaining data for the humanoid robot 1. More particularly, the data storage 1.2.14 may be embodied as any type of device configured for short-term or long-term storage of data. The data storage 1.2.14 may be embodied as memory devices and circuits, solid state drives (SSDs), memory cards, hard disk drives, USB flash drives, or other data storage devices. The data storage 1.2.14 can be embodied as one or more SSDs that expose internal parallelism to components of the humanoid robot 1, allowing the humanoid robot 1, for example, via the compute 1000, to perform storage operations on the data storage 1.2.14 in parallel.

The data storage 1.2.14 may also include memory devices, which may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards, and similar standards, may be referred to as DDR-based standards and communication interfaces of the storage devices that implement such standards may be referred to as DDR-based interfaces.

The memory device is a block addressable memory device, such as those based on NAND or NOR technologies. A memory device may also include a three dimensional crosspoint memory device (e.g., Intel® 3D XPoint® memory), or other byte addressable write-in-place nonvolatile memory devices. In an embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the device itself and/or to a packaged memory product. For data storage 1.2.14, a hierarchical storage architecture may be employed, using faster, smaller caches for frequently accessed data and larger, slower storage for archival or less critical data, optimizing both speed and capacity.

vi. Wireless Power Receiver System

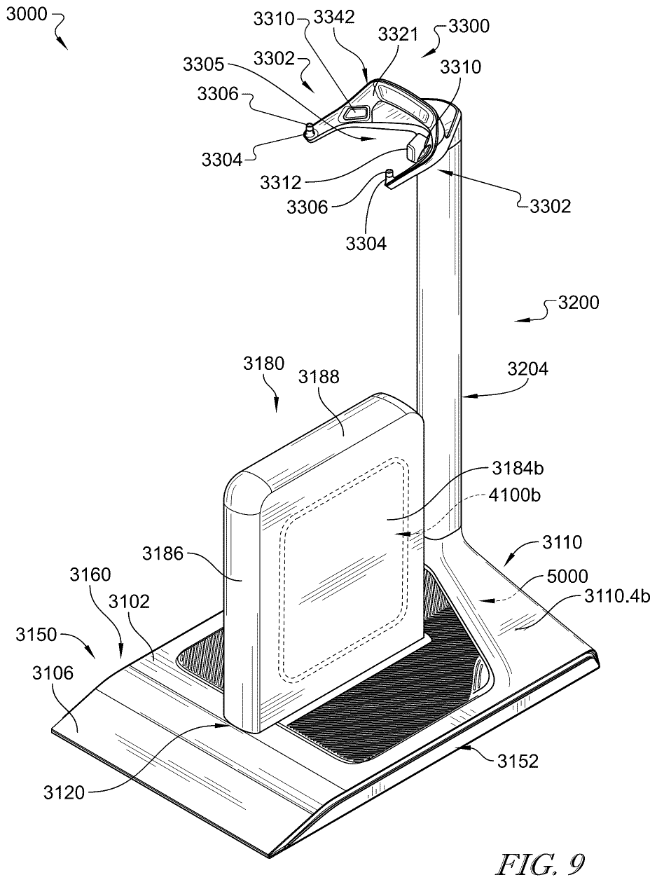

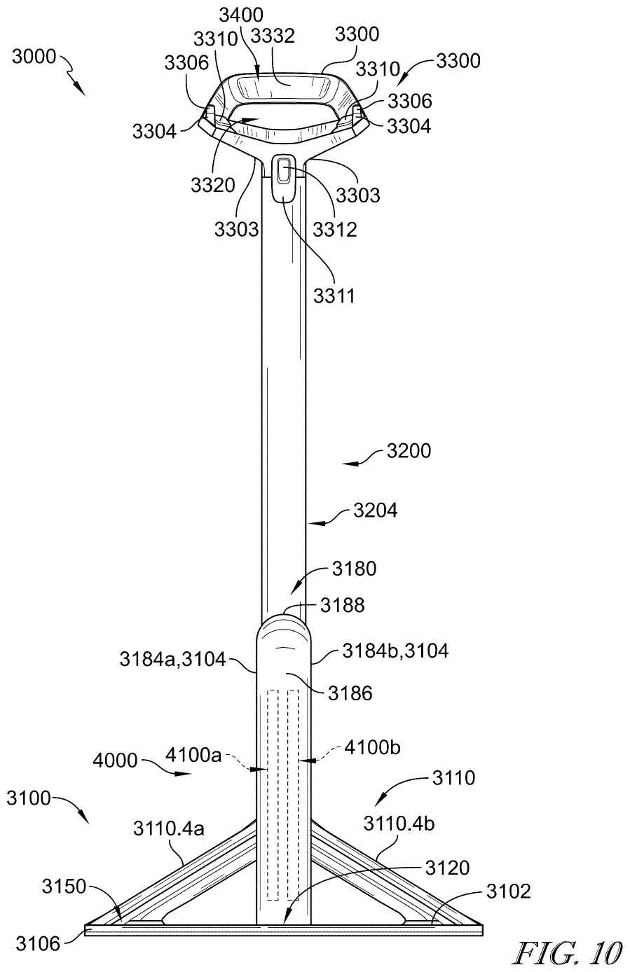

As illustrated in at least FIGS. 9-16 and 21-22, the wireless power receiver system 212.6 is configured to (i) deliver power to charge the battery pack 202 and (ii) communicate charging information to another device, such as a docking station 3000. The wireless power receiver system 212.6 includes a wireless power receiver 212.6.2 electrically coupled to the battery pack 202 and communicatively coupled to compute 1000 and at least one communication interface 1.2.12. The wireless power receiver 212.6.2 may include a receiver coil assembly 936 and a charging controller 888 in each leg 6. Both charging controllers 888a, 888b are further coupled to compute 1000, which may be further coupled to at least one communication interface 1.2.12. In the illustrative embodiment, the at least one communication interface 1.2.12 includes a communication transceiver 604.34 configured to connect with a communication transceiver 3400 housed within the docking station 3000. In alternative embodiments, the robot 1 and/or docking station 3000 may be configured with other means of communication.

Including a receiving coil 936 and a charging controller 888 in each leg 6 provides for faster charging and redundancy. For example, if a receiving coil 936 is not functioning properly, the robot 1 may communicate a need for maintenance to an operator or a command center, while slowly charging the battery pack 202 using the other operational receiving coil 936. This change in power distribution, monitoring, and communication may be monitored by the individual charging controller 888, the charge monitor 1610, and/or other controllers 1600 contained in the robot 1.

### 1. Wireless Power Receiver

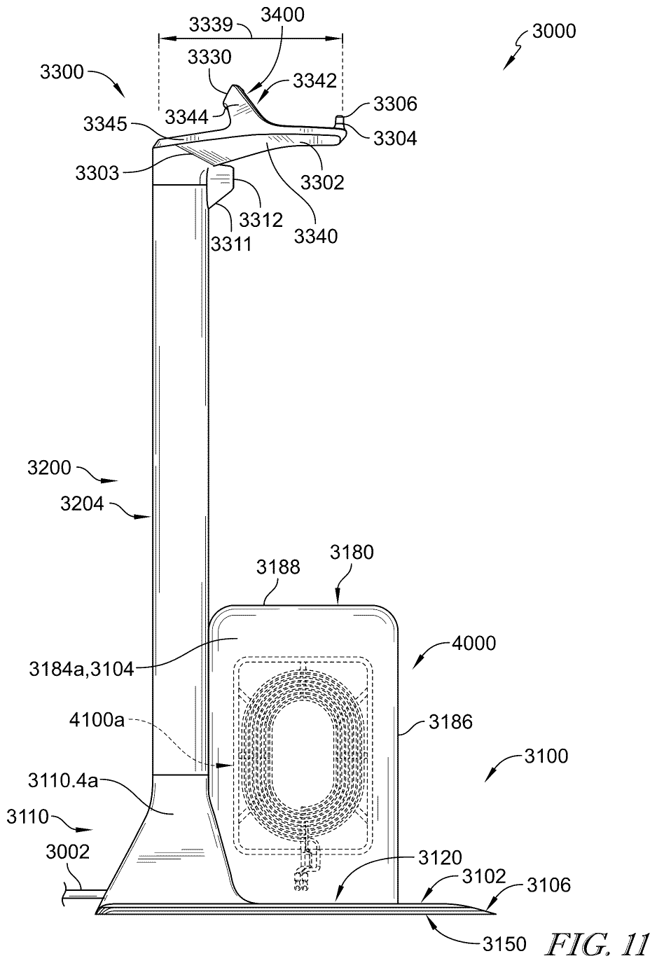

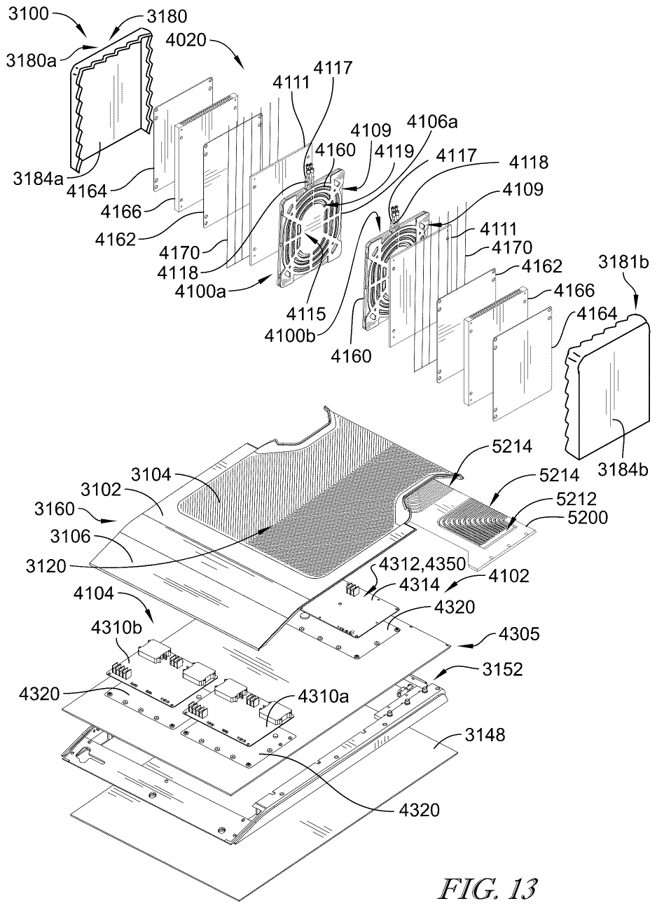

Referring to FIGS. 9-16 and 21-22, the wireless power receiver 212.6.2 includes a receiver coil assembly 936 (also referred to as receiver coil, charging coil, leg charging coil, or charging coil assembly) and a charging controller 888 in each leg 6 that are electrically coupled with the battery pack 202. The receiver coil assemblies 936a, 936b arranged in the lower leg assembly 6.2 of leg 6, more specifically in the shin 84 of the lower leg 6.2 as shown in FIGS. 11 and 13. In the illustrative embodiment, the receiver coil assemblies 936 in each leg 6 is electrically coupled to a charging controller 888 housed in the same (e.g., shin 84) or another portion of the leg 6. Each receiver coil assembly 936 is configured to receive power by electromagnetic induction. The charging controllers 888a, 888b are configured to (i) deliver power to the battery pack 202 and (ii) communicate with the compute 1000 and communication transceiver 604.34.

a. Receiver Coil Assembly

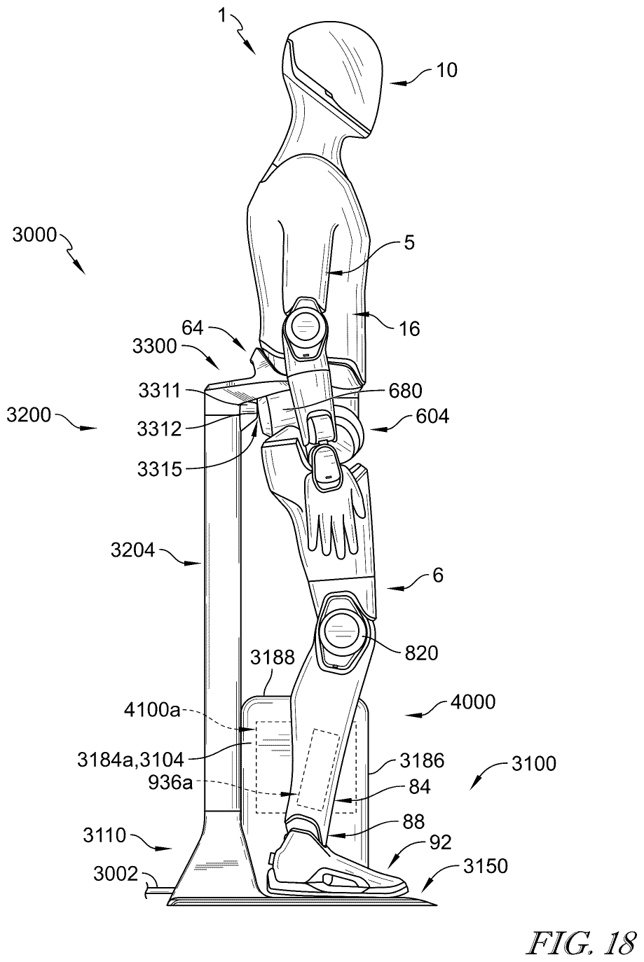

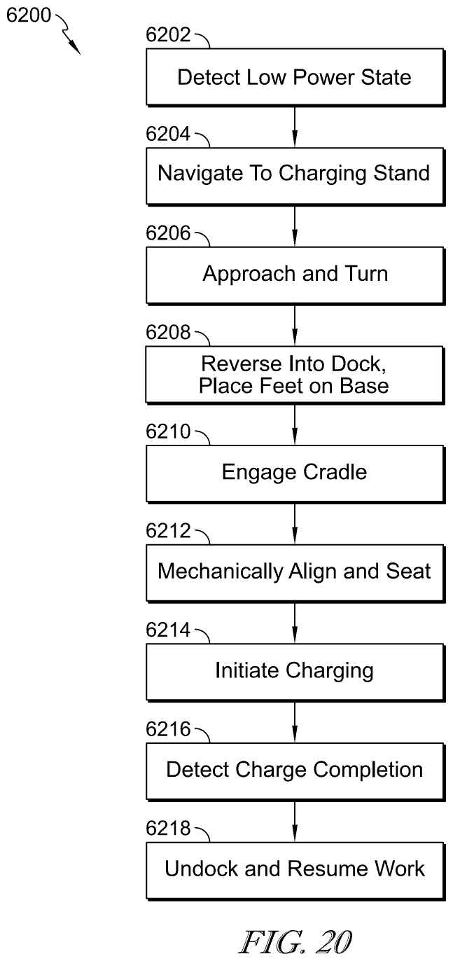

In the illustrative example, the robot 1 includes receiver coil assemblies 936a, 936b arranged in each leg 6 and configured to create an alternating electric current when positioned within an oscillating magnetic field 4150. In the example shown in FIGS. 18-21, the robot 1 is configured to stand on a base 3100, so that the receiver coils 936a, 936b are substantially aligned with the transmitter coils 4100a, 4100b of the docking station 3000 to receive wireless power. With the receiver coil assembly 936 positioned within the oscillating magnetic field 4150 created by the wireless power transmitter device 4020 of the docking station 3000, the receiver coil assembly 936 receives an alternating electric current. The alternating electric current is transferred to the receiver charging controller 888 to convert the AC power into DC power that may be used to charge the battery pack 202 of the robot 1. For example, the robot battery may be charged from a predetermined low level (e.g., 5%-25%, preferably 10%) to a predetermined high level (e.g., between 75%-95%, preferably 80%) in a predetermined amount of time (e.g., less than 15 minutes, less than 30 minutes, less than 60 minutes, or any value between 5 minutes and 240 minutes). In various embodiments, this arrangement may add weight in the leg 6 and may require active cooling (e.g. a fan in the leg 6) to dissipate heat generated by the coil assembly.

For example, each shin 84 of the robot 1 may be configured with a receiver coil assembly 936 enclosed by at least a left extent or right extent of the shin 84. The receiving coil 936 includes a wire that may be wound to include a number of turns to form a planar coiled wire layer, a first end lead, and a second end lead. For example, the wire may be Litz wire and the number of turns may be between 3 and 20, preferably between 5 and 10. The coiled wire layer may have a substantially oval or oblong shape dimensioned to be less than a length of the shin 84. The first end lead and the second end lead may be insulated and extended from planar coiled wire layer to deliver power to the charge controller 888.

The housing 842 of the shin 84 may be formed of a material that allows the magnetic field to interact with the receiver coil assembly 936 to transfer power. The receiver coil assembly 936 may include at least a receiving coil. The receiver coil assembly 936 may include a base or housing configured to hold the receiving coil and shielding layers configured to shield against electromagnetic interference (EMI) and/or to insulate and resist heat buildup. For example, the shielding layers may include a nanocrystalline material. The housing 842 or shin cover member 850 of the shin 84 may be made from a flame retardant material to protect against thermal damage.

Each receiver coil assembly 936 may include a receiving coil module, a heat transfer device, a shin shield. The coil module may include a receiving coil, a coil shield, and a module base. The heat transfer device is configured to be received in the shin 84 and coupled to a left or right extent thereof, which ever faces inward toward the wireless power transfer (WPT) device 4020 in the base 3100. The shield is positioned on an inner extent of the receiving coil module. The shin shield and the coil shield may each be configured to reduce electromagnetic interference.

The coil shield has a substantially oval or oblong shape configured to overlay the shape of the receiving coil. The coil shield is substantially planar and may include one or more layers of shielding material. In an example, the coil shield may include a first layer configured to shield against electromagnetic interference (EMI) and a second layer configured to insulate and resist heat buildup, where the second layer may be positioned between the first layer and the receiving coil. For example, the first layer may be a nanocrystalline material and the second layer may include a polyimide film, such as Kapton® or other high-performance film. The coil shield includes a shield openings configured to allow passage of the first and second end leads of the receiving coil through the coil shield. In some embodiments, the coil shield may further include a slit or narrow gap opening that extends between the shield openings configured to reduce the eddy current losses. The coil shield may be adhered to the planar coiled wire layer with the first and second end leads extending through the shield openings.

The module base has a shape substantially similar to an extent of the shin 84 and is sized to be received in the housing 842 of the shin 84. For example, the module base is dimensioned to have a perimeter that is substantially the same as, or less than, the depth of the shin 84, such that the charging module may be coupled within the shin 84. The module base may include a coil receptacle that is shaped to receive the coiled wire layer of the receiving coil, with the second end lead positioned toward the front end of the module base. The coil receptacle may include an oblong recess dimensioned to substantially match the depth, general shape, and total width based on the number of turns of the planar coiled wire layer. The coil receptacle also includes an interior portion having the same thickness as the module base, where the coiled wire layer is received into the oblong recess surrounding the interior portion. The coil shield substantially encloses the coiled wire layer within the module base. The module base may be formed of a thermoplastic material. For example, the module base may include a polybutylene terephthalate (PBT) and fiberglass (FG) substrate and an ethylene vinyl acetate (EVA) surface material.

The shin shield is configured to substantially cover the second side of the shin 84, including at least a portion of the joint coupling portions. Similar to the coil shield, it may include one or more shielding layers. For example, a first shin shield layer may be configured to shield against electromagnetic interference (EMI) and a second shin shield layer may be configured to insulate or protect the first layer. The first shin shield layer may be a nanocrystalline material, and the second shin shield layer may include polymer or plastic, such as polyethylene terephthalate (PET). Further, the shin shield includes first and second shield openings configured to allow passage of the first and second end leads of the receiving coil.

b. Charging Controllers

The charging controllers 888a, 888b are electrically coupled to respective receiver coil assemblies 936a, 936b in each leg 6. The charging controllers 888a, 888b each include receiver electronics configured to convert the alternating current (AC) induced in the receiver coil assembly 936 by the magnetic field to direct current (DC) to charge the battery pack 202 of the robot 1. Each of the right and left receiver charging controllers 888a, 888b may include (i) a receiver rectifier 888.2a, 888.2b, (ii) a DC to DC converter 888.4a, 888.4b, (iii) a receiver matching network 888.6a, 888.6b, and (iv) a microcontroller unit 888.8a, 888.8b, as shown in FIG. 22. For example, the matching network 888.6a, 888.6b, the rectifier 888.2a, 888.2b, and the DC/DC converter 888.4a, 888.4b may be configured to regulate voltage or current to appropriate levels for the robot's power loads, and a controller 888.8a, 888.8b may be configured to manage power flow. In certain embodiments, said rectifier 888.2a, 888.2b may be realized as a diode full-bridge rectifier or an active synchronous rectifier. This rectified DC voltage may then be supplied to the DC/DC converter 888.4a, 888.4b. In the illustrative embodiment, the DC converter 888.4a, 888.4b coupled to the battery pack 202 to provide power to charge the battery pack 202 arranged in the robot's torso 16. In certain embodiments, a single charging controller 888 may include one set of receiver electronics for both the receiver coils 936a, 936b.

Additionally, the microcontroller unit 888.8a, 888.8b of each charging controller 888a, 888b is further connected to compute 1000 and configured to deliver information regarding the status and/or operation of the receiving coils 936 in foot 92. The individual microcontroller units 888.8a, 888.8 may be configured to collect and communicate information regarding the operation of the wireless power receiver 212.6.2, including voltage and/or current received by respective receiver coils 936a, 936b while charging, temperature and/or other sensor readings, and fault information.

### 2. Data Communication

The wireless power receiver system 212.6 is configured to communicatively couple the wireless power receiver 212.6.2 to compute 1000 and at least one communication interface 1.2.12 of the robot 1 to establish a data connection with docking station 3000. When communication is established, the robot 1 and docking station 3000 may communicate information, including: (i) when the robot 1 is at or on the base 3100, (ii) when the robot 1 needs to reposition itself on the base 3100 and/or docking station 3000, (iii) when to begin charging, (iv) how fast to charge, (v) how much power to supply to the battery or how much to charge the battery, and (vi) when charging of the battery pack 202 is complete.

The wireless power transfer system 4000 is configured to establish a data communication link between the communication interface 3400 in the docking station 3000 and the communication interface 1.2.12 in the robot 1 to assist in charging of the battery pack 202. For example, when communication is established, the robot 1 and the wireless power transmitter device 4020 may communicate information, including: (i) when the robot 1 is at or on the base 3100, (ii) when the robot 1 needs to reposition itself on the base 3100 and/or docking station 3000, (iii) when to begin charging, (iv) how fast to charge, (v) how much power to supply to the battery or how much to charge the battery, and (vi) when charging of the battery pack 202 is complete.

The data link communication systems disclosed can be configured to facilitate real-time information exchange between the docking station 3000 and the robot 1, optimizing power transfer efficiency and system performance. This allows real-time feedback to be continuously transmitted between the robot 1 and the docking station 3000, enabling dynamic adjustments to charging parameters such as voltage, current, and frequency for optimal power transfer efficiency.

Furthermore, communication between the docking station 3000 and the robot 1 allows for real-time detection and mitigation of abnormal power levels. For example, if a sudden load change occurs while the wireless power transmitter device 4020 is delivering 1 kW of power, the wireless power transmitter device 4020 can immediately detect this anomaly and adjust the power output accordingly. This proactive adjustment reduces the need for complex hardware-based overcurrent protection mechanisms, improving system reliability and preventing potential damage to both the transmitter and receiver circuitry. Additionally, data communication can address misalignment issues in inductive or resonant wireless power transfer systems. Misalignment between the transmitting and receiving coils can lead to a decrease in power transfer efficiency due to a reduction in mutual inductance. By leveraging real-time data exchange, the system can detect variations in coupling efficiency and compensate by dynamically increasing the power output of the transmitter. This feature is particularly beneficial in robotic applications where precise positioning may not always be guaranteed due to movement, vibrations, or external disturbances.

c. Compute

As illustrated in FIG. 2, the compute 1000 may comprise any combination of hardware, software, and circuitry to perform various computing functions that enable the humanoid robot 1 to operate semi- or fully-autonomously. Specifically, the compute 1000 includes: (i) compute hardware 1010, and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) 1100 (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

ii. Architecture

The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650.

### 1. Movement Controller

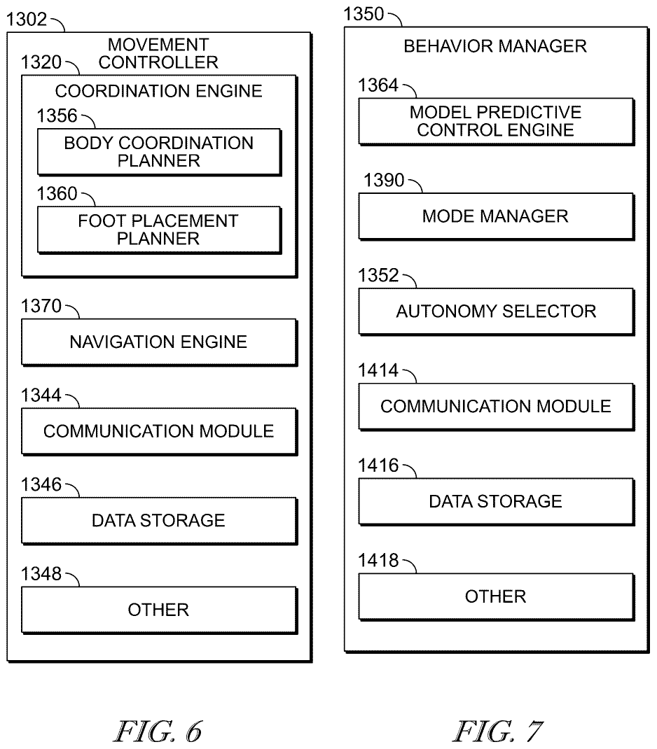

Referring to FIG. 6, the movement controller 1302 is configured to determine a sequence of actions or a path for the humanoid robot 1 to achieve a specified goal or complete a specified task. The movement controller 1302 makes such determinations based on a current state of the humanoid robot 1, a set of constraints (e.g., the mechanical and computational capabilities of the robot 1, environmental conditions, and surrounding obstacles), and instructions received from one or more sub-components of the architecture 1100. The movement controller 1302 includes one or more of: (i) a coordination engine 1320, (ii) a navigation engine 1370, (iii) a communication module 1344, (iv) a data storage 1346, and/or (v) other components 1348.

The movement controller 1302 is configured to enable the robot 1 to: (i) coordinate body movement using the body coordination planner 1356 and a foot placement planner 1360 in response to instructions from the local AI system 1470 and/or a remote AI system 2780; (ii) navigate its environment by constructing maps thereof (e.g., via simultaneous localization and mapping (SLAM)) and predicting movement of objects within the environment; and (iii) communicate with entities in the environment, including other robots and external systems. The movement controller 1302 further adapts in real-time to dynamic environments by continuously comparing expected outcomes of executed plans against actual results, and modifying subsequent actions accordingly. The movement controller 1302 also optimizes allocation of computational and physical resources by evaluating the current state of the robot 1, available energy, time constraints, and relative priority of competing goals. Additionally, the movement controller 1302 incorporates models of human behavior and preferences into its planning process, thereby generating motion plans that are both mechanically efficient and ergonomically compatible with human collaborators.

The coordination engine 1320 is configured to receive task inputs from the one or more AI systems 1470, 2780 and to provide supplemental information regarding the state, configuration, and position of the robot 1 to the whole body controller 1550. The coordination engine 1320 utilizes the body coordination planner 1356 and the foot placement planner 1360 to determine body placement and foot placement of the humanoid robot 1 based on the received task inputs. In operation, the coordination engine 1320 may decompose or selectively override task inputs from the AI systems 1470, 2780 to maintain balance, stability, and efficient locomotion during movement gaits including walking, running, and jumping. In alternative embodiments, the coordination engine 1320 and/or a substantial portion of the movement controller 1302 may be subsumed within the one or more AI systems 1470, 2780.

The navigation engine 1370 is configured to construct a map of the environment based on sensor data obtained from the sensors 1.2.8, supplemented by data from external sources including other humanoid robots 2700A-X, mapping services, weather services, and GPS modules. Based on the constructed map, the navigation engine 1370 generates one or more candidate paths, which are provided to the AI systems 1470, 2780 for subsequent task and motion planning.

The data storage 1346 is configured to store navigational data generated by the navigation engine 1370 and positional data generated by the planners 1356, 1360. This stored data is fed back to the AI systems 1470, 2780 for subsequent planning cycles. The data storage 1346 categorizes stored data as short-term memory data or long-term memory data. Short-term memory data may include positional data comprising positions of the robot 1 over a predefined recent time window (e.g., between 5 seconds and 1 minute). Long-term memory data may include navigational data comprising persistent maps of locations previously visited by any robot 1, 2700A-X in a fleet. By selectively feeding variable quantities of short-term and long-term memory data to the AI systems 1470, 2780, the movement controller 1302 reduces computational overhead while preserving sufficient context for effective planning on a resource-constrained mobile platform. In certain embodiments, the movement controller 1302 may be omitted entirely and its functions consumed by one or more trained models (e.g., reinforcement-learning-trained models) executing within the local AI system 1470.

### 2. Behavior Manager

Referring to FIG. 7, the behavior manager 1350 is configured to manage behaviors and actions of the humanoid robot 1 based on specified goals, sensor data, and environmental conditions. The behavior manager 1350 includes: (i) at least one model predictive control (MPC) engine 1364, (ii) a mode manager 1390, (iii) an autonomy selector 1352, (iv) a communications module 1414, (v) a data storage 1416, and (vi) other components 1418. The behavior manager 1350 coordinates multiple functional modules within the robotic system and enforces execution ordering constraints among behaviors, ensuring that prerequisite behaviors complete before dependent behaviors are initiated. For example, the behavior manager 1350 may enforce that a “stand up” behavior completes before a “walk” behavior begins, or that an “object recognition” behavior executes before an “object grasp” behavior is attempted.

The MPC engine 1364 is configured to predict future states of the humanoid robot 1 based on its current state and to select actions that optimize behavior and performance over a defined prediction horizon. The MPC engine 1364 selects from predefined or learned action primitives in response to stimuli detected by the sensors 1.2.8 and in accordance with assigned tasks. The action primitives may address path planning, obstacle avoidance, object grasping and manipulation, human-robot interaction, task planning and execution, decision-making, multi-robot coordination with other robots 2700A-X and machines 2710A-X, and safety and regulatory compliance. The MPC engine 1364 communicates with the local AI system 1470 to refine its action selections over time based on learning algorithms that correlate observed outcomes with selected actions under given tasks, scenarios, and constraints.

The mode manager 1390 is configured to select one or more operational modes appropriate to a given task, scenario, or constraint. Available modes include, without limitation: a power mode, a standby mode, a standing mode, a sitting mode, one or more movement modes (e.g., running, walking, jumping, hovering), a falling mode, a learning mode, a diagnostic mode, and an emergency mode. The mode manager 1390 refines mode selection over time through collaboration with learning algorithms of the local AI system 1470.

The autonomy selector 1352 is configured to manage the autonomous capabilities of the behavior manager 1350. Through the autonomy selector 1352, an operator may configure a level of autonomy for the humanoid robot 1, including: (i) manual mode, in which the operator remotely controls operations; (ii) semi-autonomous mode; or (iii) fully autonomous mode. The operator may further designate specific functions to operate autonomously while reserving others for manual input, or configure the robot 1 to perform repetitive tasks without AI/ML-based behavioral adaptation.

The communication module 1414 is configured to enable inter-component communication within the behavior manager 1350 and between the behavior manager 1350 and other components of the compute 1000. The data storage 1416 provides short-term and long-term storage of behavior-related data, including event logs, movement data, training data, navigation logs, and mapped area and path data. Other components 1418 may include data caching modules, data aggregation and augmentation modules, body-part health management systems, and calibration data management systems. In certain embodiments, the behavior manager 1350 may be omitted entirely and its functions consumed by one or more trained models (e.g., reinforcement-learning-trained models) executing within the local AI system 1470.

### 3. Perception System

The perception system 1420 is configured to obtain audiovisual data from the sensors 1.2.8 and to provide the obtained data to the local AI system 1470 for processing. The local AI system 1470 applies one or more AI-based vision techniques to the obtained data-including object detection, image classification, semantic segmentation, object tracking, facial recognition, scene understanding, depth estimation, anomaly detection, and reinforcement-learning-based perception—to generate one or more three-dimensional (3D) representations of the environment. The generated representations may be annotated with contextual metadata, including foreground and background classification, object category labels, and semantic tags, for subsequent processing by the local AI system 1470 and the behavior manager 1350. In certain embodiments, the perception system 1420 may be omitted entirely and its functions folded into the local AI system 1470.

### 4. Local AI System

The local AI system 1470 is configured to drive semi-autonomous to fully-autonomous perception, learning, and behavior by the humanoid robot 1. The local AI system 1470 supports multiple execution configurations: (i) models and architectures executing entirely on the local AI system 1470; (ii) models and architectures partitioned between the local AI system 1470 and the remote AI system 2780; and (iii) models and architectures executing entirely on the remote AI system 2780.

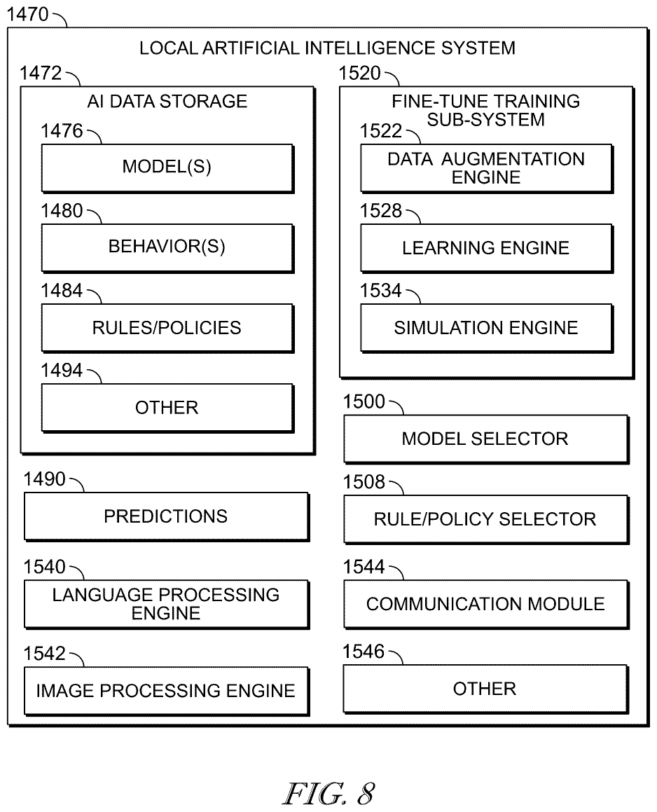

Referring to FIG. 8, the local AI system 1470 includes an AI data storage 1472, a predictions module 1490, a model selector 1500, a rule and policy selector 1508, a training sub-system 1520, a language processing engine 1540, an image processing engine 1542, and a communication module 1544. The local AI system 1470 is architecturally integrated with each of the other components of the compute 1000, including the movement controller 1302, behavior manager 1350, perception system 1420, whole body controller 1550, and controllers 1600. In certain embodiments, the compute 1000 may consist primarily or entirely of the local AI system 1470, with the other components implemented as functional modules therein rather than as separate subsystems. The local AI system 1470 addresses the technical challenge of real-time, context-aware decision-making by enabling rapid, localized processing of multi-modal sensory inputs and immediate generation of responsive actions, thereby eliminating latencies associated with remote processing or pre-programmed response systems.

The local AI system 1470 fuses multi-modal sensory data—including visual, auditory, tactile, and proprioceptive inputs—in real-time to construct a coherent representation of the state of the robot 1 and its environment. This integrated perception enables nuanced interaction with both the physical world and human collaborators. The local AI system 1470 further implements adaptive learning through deep reinforcement learning and online learning techniques, enabling continuous refinement of decision-making processes, acquisition of new task capabilities with minimal explicit programming, and adaptation to changes in the operational environment or in the physical capabilities of the robot 1. The local AI system 1470 additionally implements dynamic task prioritization and resource allocation algorithms to manage the constrained computational resources of the robot 1, ensuring that critical processes receive adequate computational capacity across operational scenarios ranging from simple repetitive tasks to complex problem-solving.

The AI data storage 1472 stores one or more models 1476, behaviors 1480, rules and policies 1484, and other data 1494. The model selector 1500 is configured to select an appropriate model or combination of models 1476 based on one or more of: the specified task, an estimated cost to perform the task, performance efficiency requirements, environmental conditions, resource availability, and a current health status of the humanoid robot 1 or its constituent components. The model selector 1500 refines its selection criteria over time based on learning algorithms that map models 1476 to tasks, scenarios, and constraints. In an alternative embodiment, model selection may be performed in response to operator input, which may be useful during initialization of the humanoid robot 1.

The rule and policy selector 1508 is configured to select one or more rules and policies 1484 from the AI data storage 1472 for enforcement during operation of the humanoid robot 1, based on operator input, operational context, environmental conditions, applicable compliance and regulatory requirements, and safety considerations. The rule and policy selector 1508 may further learn efficient methods for adapting to selected rules and policies over time through automated learning.

The language processing engine 1540 is configured to obtain, parse, interpret, and understand natural language directives and to generate natural language speech, including bidirectional speech-to-text and text-to-speech conversion. The image processing engine 1542 is configured to perform object detection, image classification, semantic segmentation, object tracking, facial recognition, scene understanding, depth estimation, anomaly detection, and reinforcement-learning-based analysis on visual data obtained from the sensors 1.2.8 or from preloaded training datasets.

The training sub-system 1520 is configured to refine the models 1476 and behaviors 1480 based on observed operational data and training data. The training sub-system 1520 includes: a data augmentation engine 1522 configured to increase the size and diversity of training datasets (analogous to the data augmentation engine 2782 of the remote AI system 2780); a learning engine 1528 configured to train the AI models 1476 given the rules and policies 1484, behaviors 1480, and training data (analogous to the training engine 2790 of the remote AI system 2780); and a simulation engine 1534 configured to execute one or more of the AI models 1476 within a virtualized simulation environment to simulate and analyze kinematics, sensor behavior, robot behavior, and anomalies (analogous to the simulation engine 2800 of the remote AI system 2780). Compared to training performed by the remote AI system 2780, fine-tuning conducted by the local training sub-system 1520 is localized to the specific humanoid robot 1, which is advantageous for task-specific or environment-specific model adaptation.

Other components 1546 may include a communications module configured to enable inter-component communication within the local AI system 1470 and between the local AI system 1470 and other components of the compute 1000. In certain embodiments, one or more of the controllers 1600 may be omitted and their functions consumed by trained models (e.g., reinforcement-learning-trained models) executing within the local AI system 1470.

a. Helix Bipedal Action Model and Control System

Disclosed herein are systems, methods, and techniques for determining and executing tasks among communicating humanoid robots, which may be controlled by a generalist bipedal action model (BAM), referred to herein as the Helix model 1476.2. The Helix model 1476.2 provides a unified integration of perception, language understanding, and learned motor control for coordinating robot fleets operating in facilities, distribution centers, warehouses, factories, or other operational environments.

A single BAM instance, which may execute in a cloud computing environment or at the edge on the robot 1, is configured to receive natural language or speech input from a human operator, identify sub-tasks or procedural steps associated with the received input, and output robot actions comprising positions and rotations necessary to perform the identified sub-tasks. The BAM may be trained from scratch using task-specific training data, or may be generated by retraining or fine-tuning a pre-trained model such as a visual language model (VLM), a multimodal large language model (MLLM), or another AI model. The output actions may be provided to each robot at varying levels of granularity, ranging from per-actuator commands at high frequency (e.g., 100 Hz-5 kHz) to higher-level commands at lower frequency (e.g., 0.1-100 Hz) that are interpreted and refined by onboard models prior to transmission to the whole body controller 1550. The control system leverages cost function algorithms that are uniquely generated for and dynamically updated to reflect costs specific to a fleet of robots, an operating environment, or individual robots, thereby enabling determination and assignment of optimally efficient sub-tasks.

The Helix architecture 1476.2 decouples a cognitive subsystem (System 2, or S2) from a reactive motor subsystem (System 1, or S1). This architectural separation permits independent development, improvement, and validation of the reasoning and planning capabilities of S2 and the control policy of S1, thereby enhancing engineering flexibility and system resilience. The dual-system approach resolves a fundamental tension between large vision-language models, which provide broad semantic understanding at the cost of inference speed, and traditional visuomotor policies, which provide fast execution but limited generalization. By operating each subsystem at its optimal timescale, S2 performs deliberative reasoning over high-level goals while S1 executes and adjusts actions in real-time.

S2 is the high-level cognitive subsystem, configured to generate long-horizon goals and/or to decompose a long-horizon goal into sub-steps for a specified task. S2 may be implemented as an internet-pretrained VLM or any other model disclosed herein or known in the art, and may be based on open-source or open-weight architectures including, without limitation, LLaVA, Flamingo, BLIP-2, OFA, and MiniGPT-4, with model selection based on task requirements and computational constraints. S2 may comprise between 10 million and 100 billion parameters, and preferably between 1 billion and 20 billion parameters, which may be generated or adapted using Low-Rank Adaptation (LoRA), Quantized LoRA (QLoRA), or model distillation. S2 operates at a frequency of between 1 Hz and 25 Hz, and preferably between 5 Hz and 10 Hz, reflecting its role in abstract reasoning, scene understanding, and language comprehension. S2 processes robot images and robot state information (comprising wrist pose and finger positions) by projecting them into a vision-language token space. The projected representations are combined with natural language command tokens, and S2 distills the combined task-relevant semantic information into a single continuous latent vector, which is passed to S1 to condition its low-level action generation.

S1 is the low-level reactive subsystem, configured to translate the latent semantic representations from S2 into precise, continuous robot actions at a frequency of between 50 Hz and 750 Hz, and preferably between 150 Hz and 250 Hz. S1 may be implemented as one or more of: a cross-attention encoder-decoder transformer, a decoder-only transformer, an encoder-only transformer, a multimodal transformer, a vision transformer (ViT), an efficient transformer, a sparse attention transformer, a linearized attention transformer, a mixture-of-experts (MoE) transformer, a state space model (SSM), a retrieval-augmented generation (RAG) model, a hybrid CNN-transformer model, a diffusion transformer (DiT), a perceiver model, an adapter-based transformer, any other model disclosed herein, or any other model known in the art. S1 may comprise between 10 thousand and 1 billion parameters, and preferably between 20 million and 200 million parameters, which may be generated or adapted using LoRA, QLoRA, or model distillation. S1 receives the same image and state inputs as S2 but processes them at a substantially higher frequency to enable responsive closed-loop motor control.

To ensure coherent coordination between S2 and S1, both subsystems are co-trained end-to-end using the latent vector as a shared interface. The latent vector projects the outputs of S2 into the token space of S1 and is concatenated with visual features extracted by S1, thereby providing the necessary task conditioning for low-level action generation. The Helix model 1476.2 provides several key advantages over existing approaches, including: zero-shot generalization to novel objects and environments, direct continuous control over high-dimensional action spaces, native support for multi-robot collaboration, and commercial deployment readiness.

### 5. Whole Body Controller

The whole body controller 1550 is configured to receive control information from the behavior manager 1350 or the local AI system 1470 and to transmit processed control signals to other components of the compute 1000. For example, the whole body controller 1550 transmits joint torque data, comprising data specifying rotational forces to be exerted at joints of the humanoid robot 1, to the controllers 1600. In certain embodiments, the whole body controller 1550 may be omitted and its functions consumed by trained models (e.g., reinforcement-learning-trained models) executing within the local AI system 1470.

The controllers 1600 are configured to transmit joint torque commands to the actuators 1.2.4 to effect extension and retraction of body parts including arms, hands, and fingers of the humanoid robot 1. The controllers 1600 further receive and process joint torque and angle data from sensors 1.2.8, such as inertial measurement units (IMUs) mounted on body segments, with measurements obtained via rotary position sensors, optical reflection sensors, or other measurement modalities. The whole body controller 1550 may additionally incorporate advanced control strategies, such as passivity-based control or adaptive control, to ensure stability and robustness in the presence of model uncertainties or external disturbances. In certain embodiments, the controllers 1600 may be omitted and their functions consumed by trained models (e.g., reinforcement-learning-trained models) executing within the local AI system 1470.

### 6. Other Components

Other components 1650 of the compute 1000 may include power management modules configured to manage battery pack health and power usage profiles, and calibration modules configured to ensure that actual kinetic movements of the humanoid robot 1 align with expected kinetic movements determined from computational models. The humanoid robot 1 may further include other components 1.2.18 that do not fall within the mechanical and electrical architecture 1.2 or the compute 1000, such as safety systems, emergency override systems, and ports for connecting peripheral devices.

### E. DOCKING STATION

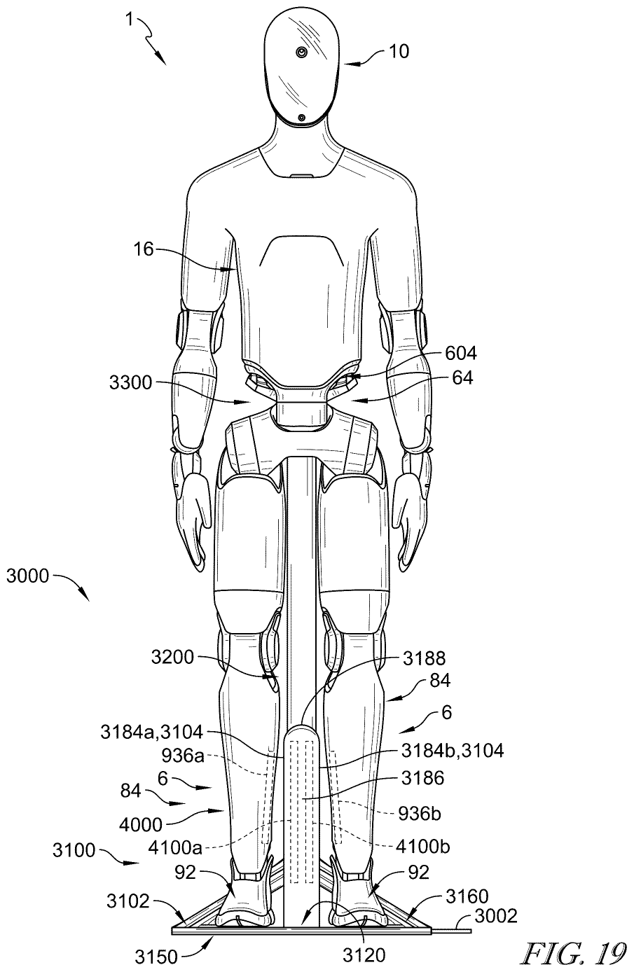

As illustrated in FIG. 18-19, the robot 1 is shown in a fully docked state, in which the robot 1 is positioned with its feet 92 on the base 3100 of the docking station 3000 on either side of a charging tower 3180 and supported at the waist 604 from the rear by a support cradle 3300. The rear engagement between the docking station 3000 and the robot 1 represents a departure from the design of conventional docks. In particular, conventional docks that facilitate forward engagement between a robot and a dock may be sufficient for mechanically stable wheeled platforms that possess a low center of gravity and a broad, stable base, but these conventional docks are inadequate for humanoid embodiments that pose a higher center of gravity, feature sensors, manipulators, and communication arrays on their anterior side, and need to occupy a minimal floor-based footprint while allowing for autonomous docking. This configuration also unconventionally leaves the forward-facing operational systems of the robot 1 entirely unobstructed, permitting the robot to continue monitoring its environment and/or communicating while securely docked. Other benefits of utilizing a rearward supporting design may be obvious to one of ordinary skill in the art based on the present disclosure and the accompanying figures. For example, the rearward supporting design may permit the robot 1 to respond to external stimuli, such as voice commands or visual alerts, even while in a docked and charging state, and may further permit the robot 1 to use its forward-facing manipulators (e.g., arms and hands) to perform light manipulation tasks without undocking.

This successfully docked configuration also represents the culmination of a fully autonomous process, wherein the robot 1 has, without human intervention, navigated to, approached, and securely engaged with the docking station 3000. Once the robot 1 is in this docked state, it can safely transition into an off, a deep low-power, or a standby mode. This transition is not merely limited to powering down its primary processors, but may also extend to the complete de-energization of its most energy-intensive subsystems, such as its powerful leg, torso, and arm actuators. This deep power-down mode, which would be exceedingly difficult or functionally impossible to achieve safely without the stable external physical support provided by the docking station 3000, serves to minimize parasitic energy consumption while the internal batteries of the robot 1 are being replenished. This unique capability for stable, deep-power recharging enables entire fleets of such robots to function continuously in demanding industrial environments with only minimal human oversight, thereby maximizing their operational uptime and utility. The physical support provided by the docking station 3000 also ensures the stability of the robot 1 against accidental bumps, seismic activity, or environmental vibrations, thereby preventing falls that might otherwise occur if the robot 1 were attempting to recharge in a free-standing configuration without its actuators being fully energized for balance. In some embodiments, the robot 1 may transition through a graduated sequence of power states, such as from a standby mode to a low-power mode and then to a deep sleep mode, based on the estimated time to reach a full charge. In some embodiments, the graduated sequence of power states may be further based on external conditions, such as the ambient noise level or the proximity of detected human workers, such that the robot 1 remains in a lighter sleep mode when the environment suggests a higher likelihood of receiving a wake command.

The docking station 3000 is designed to extend upwards from its base to engage with the posterior and lateral aspects of the robot 1, specifically engaging the robot at its waist 604 with the support cradle 3300. In this engaged position, where the robot 1 maintains a natural, upright posture, the docking station 3000 provides robust, multi-axis mechanical support, which effectively offloads the static gravitational load from the robot's own actuators and transfers that load onto the sturdy structure of the docking station 3000. Said upright posture may be particularly conducive to long-term autonomous operation by allowing the robot 1 to be physically supported by an external structure while being simultaneously and optimally positioned for receiving wireless charging power to its shins 84. Additionally, this upright posture may be advantageous for operations in human-centric environments where available floor space may be limited, and where the robot 1 should maintain a minimal physical footprint to avoid causing an obstruction to human workers or other equipment. In some embodiments, the docking station 3000 may be configured to engage the robot 1 at other body portions, such as the torso or the hip joint assembly, depending on the specific morphology of the humanoid robot. In some embodiments, the support cradle 3300 may be equipped with interchangeable cradle inserts, each insert having an inner surface profile that is contoured to match a different robot model or a different engagement region of the same robot, thereby allowing a single docking station 3000 to service a heterogeneous fleet of humanoid robots.

A power cord 3002 may extend from the rear of the docking station 3000. The power cord 3002 is strategically placed at the rear of the unit to minimize its profile and to prevent it from becoming a trip hazard in a busy workspace. In some embodiments, the power cord 3002 can include a standard plug (not shown) to enable the docking station 3000 to receive power from a standard wall outlet (e.g., NEMA 5-15, NEMA 5-20, NEMA 14-50, CEE 7/2, GB 1002, GB 2099.1). In some alternative embodiments, the power cord 3002 can be configured to be wired directly into a permanent electrical junction box, which may be desirable for a more permanent and robust installation. In further embodiments, the power cord 3002 may include integrated strain relief and/or a locking connector mechanism to prevent accidental disconnection during robot docking and undocking events. In yet further embodiments, the power cord 3002 may include a quick-disconnect coupler positioned at the rear of the docking station 3000, such that the docking station 3000 can be detached from the power cord 3002 for transport or relocation without disturbing the permanent wiring.

In general, these figures collectively depict the robot 1 in a stable, upright, and safely supported position, which is the successful and intended result of a robust, fully autonomous docking procedure. This advanced capability allows for safe, efficient, and frequent recharging cycles to occur without the need for any human intervention, which is a key enabler for the continuous and long-term deployment of humanoid robots in a wide range of industrial, commercial, and logistical applications. In addition, the robot 1 and the docking station 3000 may include electrical parts and systems that meet, exceed, satisfy, and/or are in full compliance with IEC 60204-1:2016, including its 2021 amendment (AMD1:2021), wherein the latest revisions of both of these standards are hereby incorporated by reference. Further, the robot 1 and/or the docking station 3000 may include safety features (e.g., communications protocols between the robot 1 and docking station 3000) that will prevent the docking station 3000 from emitting wireless electrical current in response to the belief or detection of an erroneous or unsafe connection. In some embodiments, the safety features may include a multi-stage handshake protocol between the robot 1 and the docking station 3000, wherein the docking station 3000 verifies the identity, model, and charge state of the robot 1 prior to energizing the transmitter coil assemblies. In some embodiments, the multi-stage handshake protocol may further include a verification of the firmware version and the operational health status of the robot's battery management system, such that the docking station 3000 refuses to initiate power transfer if the robot 1 reports an anomalous battery condition, such as an over-temperature event or a cell-imbalance fault.

The docking station 3000 includes: (i) a base 3100, (ii) a support stand 3200 (also referred to as a support frame assembly), (iii) a wireless power transfer (WPT) system 4000, (iv) a station electronics assembly 3500, and (v) an active cooling system 5000 as shown in FIGS. 9-16. The base 3100 includes a charging tower 3180 and a wireless power transmitter device 4020 (also referred to as wireless power transmitter, transmitter device, or wireless power transfer (WPT) device) arranged in the charging tower 3180. The support stand 3200 is coupled to the base 3100 and includes: (i) a flared base 3110, (ii) a vertical support portion 3204, and (iii) a support cradle 3300, where the support cradle 3300 is positioned above the base 3100 and configured to mechanically couple with the robot 1. The station electronics assembly 3500 includes: (i) a sensor assembly 3111, (ii) a communication transceiver 3400, and (iii) a station computing device 4350. The WPT system 4000 includes the wireless power transmitter device 4020 in the base 3100 configured to transfer power to the robot 1, the station computing device 4350, and the communication transceiver 3400 configured to form a data communication link with the robot 1. The active cooling system 5000 is configured to facilitate the removal of thermal energy generated by the wireless power transmitter device 4020 in the base 3100.

The WPT system 4000 includes the wireless power transmitter device 4020 in the base 3100 configured to transfer power to the robot 1, where the robot 1 is configured to receive power by induction. In the illustrative embodiment, the robot 1 includes a wireless power receiver system 212.6, wherein the left shin 84 and the right shin 84 each include a receiver coil assembly 936a, 936b. The WPT system 4000 is configured to interface with the wireless power receiver system 212.6 contained in the robot 1. The WPT system 4000 also includes the station computing device 4350 coupled to the sensor assembly 3111 and the communication transceiver 3400. The station computing device 4350 is configured to establish a data communication link with the robot 1 via the communication transceiver 3400 to facilitate positioning of the robot 1 for charging. The computing device 4350 may also communicate information from the sensor assembly 3111 to facilitate positioning of the robot 1. In some embodiments, the data communication link established by the station computing device 4350 may carry real-time telemetry data, including the received power level at the robot's receiver coil assemblies 936a, 936b, enabling the station computing device 4350 to cooperate with the robot 1 in an iterative alignment refinement loop that maximizes power transfer efficiency.

a. Base

The base 3100, which serves as the foundational element of the docking station 3000, is a composite assembly that includes several integrated subsystems. The base 3100 includes: (i) a wireless power transmitter 4020 configured to inductively couple with the robot 1 for charging of its battery pack 202, (ii) a base housing 3150 and (iii) a charging tower 3180 that extends from the base housing 3150. The wireless power transmitter 4020 is configured to generate a high-frequency alternating magnetic field 4150 to inductively couple with a corresponding receiver 936 in the robot 1 for the purpose of charging of its internal battery pack 202, which may be a high-capacity lithium-ion or lithium-iron-phosphate battery pack. The base housing 3150 provides a stable and precisely located surface for the robot 1 to stand upon during docking. The charging tower 3180 is a structural housing that extends upward from the platform 3102 and is configured to substantially enclose and protect the components of the WPT device 4020 from the external environment. In some embodiments, the base 3100 may further include a weight distribution element, such as a dense ballast plate integrated within the base housing 3150, configured to lower the center of gravity of the docking station 3000 and to increase resistance to tipping moments generated during the docking procedure.

i. Base Housing

The base housing 3150 includes: (i) a base frame 3152 and (ii) a platform cover 3160 coupled to an upper surface of the base frame 3152. The base frame 3152 is dimensioned to couple with the support stand 3200 and features a low-profile design dimensioned to facilitate the safe and repeatable positioning of the robot 1 as it couples with the docking station 3000, including features that guide the spacing and placement of the robot's feet 92. These features may include recessed areas or tactile markers that provide feedback to the robot 1. The base frame 3152 may also include a gentle ramp with a shallow approach angle, configured to make the overall docking process more robust by reducing the likelihood of a trip or a stumble, while also allowing the docking station 3000 to meet various safety and accessibility standards. In some embodiments, the tactile markers may be raised ridges or textured zones that are detectable by pressure sensors or force-torque sensors 1.2.8.2 in the robot's feet 92, thereby providing confirmation of correct foot placement even in the absence of visual data.

The base frame 3152 includes: (i) a front ramp portion 3154, (ii) a main support portion 3156, and (iii) a rear interface portion 3158 as shown in FIGS. 9-13. At least the main support portion 3156 and the rear interface portion 3158 may have a substantially C-shaped profile (in other embodiments, said profile may be U-shaped, V-shaped, or any other conventional shape) providing an internal shelf configured to receive and couple to the wireless power transmitter 4020, a bottom surface configured to receive a base layer 3148 configured to be in contact with the floor or support surface, and a top surface configured to receive the platform cover 3160. The left and right sides are substantially similar with mirrored features that include a gentle incline defining the front ramp portion 3154 configured to minimize the required lift height of a foot 92 of the robot 1. The rear portion 3158 is configured to couple with the support stand 3200. In some embodiments, the base layer 3148 may include a non-slip material, such as a high-friction elastomeric compound or an array of rubber feet, to prevent the docking station 3000 from sliding on the floor surface during docking and undocking maneuvers.

The platform cover 3160 provides a durable, protective covering for the internal components, engineered to withstand the static and dynamic loads exerted by the robot 1 during docking, charging, and undocking maneuvers. The platform cover 3160 can be composed of two different layers, wherein a first lower layer is designed as a support layer and the second upper layer is designed as a robot interface layer. For example, the first, lower layer may be made from a thicker (in comparison to the upper layer), durable material, and the second, upper layer is made from a thinner (in comparison to the lower layer), high-friction material. Specifically, the lower layer can be made from plastic, and the upper layer can be made from PPE foam or another flame-resistant compound. In some embodiments, the upper layer may include embedded conductive traces or fiducial patterns that are detectable by proximity sensors in the robot's feet 92, further aiding in the verification of correct foot placement during the docking procedure.

The platform cover 3160 includes: (i) a substantially planar or flat portion 3102 and (ii) a ramped or angled portion 3106 as shown in FIGS. 9-13. The ramped or angled portion 3106 extends rearward from a frontal extent of the docking station and terminates at the start of the planar portion 3102. Said ramped or angled portion 3106 is coupled to the front ramp portion 3154 of the base frame 3152 and is not textured. In alternative embodiments, the beveled edge 3106 may be extended along the entire side, or a portion of the sides, of the docking station 3000. This alternative design may help ensure that the docking station 3000 complies with ADA section 303 and/or OSHA regulations (e.g., 29 CFR 1926.501, which is incorporated herein by reference), wherein the slope of the beveled edge 3106 is less than a specific ratio, such as 1:48, 1:10, or 1:8. Further, the beveled edges 3106 that are located in the front or on the sides of the base 3100 may be removable or may be made from a material that is different from that of the main body of the docking station 3000. The planar portion 3102 may be textured with a high-friction material and/or may include clear visual markings to provide a distinct target for the foot 92 placement of the robot 1 in some embodiments.

ii. Charging Tower

The charging tower 3180 extends vertically upward from a center 3120 of the base housing 3150. The charging tower 3180 has a substantially rectangular or cuboid shape, having two substantially planar and parallel sidewalls 3184a, 3184b, a rounded front edge 3186, and a rounded top edge 3188. Each sidewall 3184a, 3184b forms a wireless charging surface 3104 that may occupy less than the entire respective sidewall 3184a, 3184b and preferably more than a majority of the respective sidewall 3184a, 3184b. These rounded edges 3186, 3188 serve to minimize potential impact damage and prevent snagging during the robot's docking maneuver. The combination of the base housing 3150, sidewalls 3184a, 3184b, and rounded top edge 3188 form a compartment 3170 that is dimensioned to substantially contain the WPT device 4020 and associated thermal management components.

In some embodiments, the charging tower 3180 may be made of separate components assembled together to form the charging tower 3180. For example, the charging tower 3180 may include left and right sections 3180a, 3180b assembled around the WPT device 4020 and coupled together to enclose the WPT device 4020 therein. In various embodiments, the charging tower 3180 may be further subdivided into more sections or less sections. In some embodiments, the charging tower 3180 may have an internal support structure that supports the WPT device 4020 and the charging tower 3180 is a single piece component assembled over the internal support structure with the WPT device 4020 coupled thereto. The sidewalls 3184a, 3184b of the charging tower 3180 may be formed from a non-metallic, magnetically transparent material, such as a glass-fiber reinforced polymer composite, so as not to attenuate or distort the magnetic field 4150 generated by the transmitter coil assemblies 4100a, 4100b housed within the compartment 3170.

iii. Wireless Power Transmitter

The wireless power transmitter 4020, which may also be referred to as the WPT device 4020, includes: (i) two transmitter coil assemblies 4100a, 4100b, (ii) a power supply unit 4102, and (iii) a charging controller 4104. In the illustrative embodiment, the two coil assemblies 4100a, 4100b, the transmitter power electronics 4310a, 4310b, the transmitter controller 4312, and the power supply unit 4102 are positioned within the charging tower 3180. In other embodiments, the power supply unit 4102 and/or the charging controller 4104 may be housed separately, for example, in the base housing 3150, the support frame assembly 3200, or an external enclosure, and electrically coupled to the coil assemblies 4100a and 4100b arranged in the charging tower 3180. The charging controller 4104 includes left and right transmitter power electronics 4310a, 4310b coupled to respective coil assemblies 4100a, 4100b and a transmitter controller 4312, for example, a microcontroller unit (MCU) or a digital signal processor (DSP) configured for high-speed control loops. In various embodiments, the transmitter controller 4312 may be also be coupled to or integrated with the station computing device 4350.

The wireless power transmitter 4020 includes the pair of transmitter coil assemblies 4100a and 4100b, which are positioned adjacent to or near the wireless charging surface 3104 of the respective sidewall 3184a, 3184b of the charging tower 3180. In addition to being positioned beneath and adjacent/near the wireless charging surface 3104 of the respective sidewall 3184a, 3184b, the transmitter coil assemblies 4100a and 4100b are positioned adjacent to or directly inward of the wireless charging surface 3104 in a substantially vertical parallel configuration that corresponds to the neutral stance of the left and right legs 6 of the humanoid robot 1. More specifically, the transmitter coil assemblies 4100a and 4100b are arranged in the substantially vertical parallel configuration that corresponds to the neutral stance of the left and right shins 84 of the humanoid robot 1. This vertical parallel arrangement ensures that when the robot 1 is standing on the base 3100 in its neutral stance, the transmitter coil assemblies 4100a and 4100b are in close proximity to the receiver coil assemblies 936a, 936b within the corresponding shins 84, thereby establishing an efficient magnetic coupling path across a minimal air gap.

### 1. Coil Assemblies

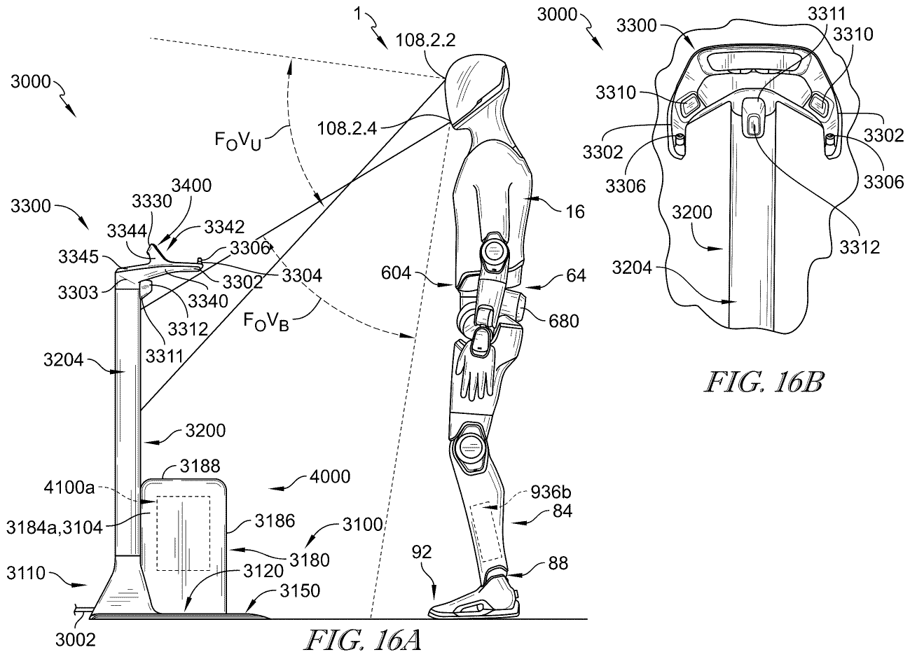

The wireless power transmitter 4020 includes two transmitter coil assemblies 4100a, 4100b, each coupled to the charging controller 4104. Each coil assembly 4100 may include (i) a coil module 4106, (ii) a shield 4111, (iii) a support plate 4162, (iv) a heat spreader 4166, and (v) a thermal interface material (TIM) layer 4164 as shown in FIG. 16. Each coil module 4106 includes a coil 4109 arranged within a carrier 4116 and covered by a protective cap 4160. In some embodiments, the TIM layer 4164 may be made of a thermally conductive silicon and may be used to facilitate thermal transfer. It should be understood that in other embodiments, the transmitter coil assemblies 4100a and 4100b may include fewer, additional, or different layers arranged to facilitate power transfer, minimization of EMI radiation, and thermal management. This layered design facilitates the transfer of heat away from the current-carrying coils 4109.

The transmitter coil modules 4106a, 4106b each include a collection of windings arranged as a coil 4109 having a predetermined pattern on a substrate or carrier 4116. In this embodiment, the coil 4109 is shown as a planar, racetrack-shaped, or ovular coil, which is a geometry that can be engineered to create an elongated and uniform charging area, thereby providing tolerance for vertical misalignment of the robot's shins 84. The windings themselves are formed from an electrical conductor or wire 4117. In some embodiments, the wire 4117 may be Litz wire, which is made up of many fine, individually insulated strands that are woven or twisted together in a specific pattern, such as a braided or rope-lay configuration. This construction is chosen to mitigate the detrimental effects of AC resistance at high frequencies, such as the skin effect, where current tends to flow only on the conductor's surface, and the proximity effect, where currents in adjacent conductors interact and further constrict the current flow. By using Litz wire, these AC losses are reduced, which can increase the quality factor (Q-factor) of the coil 4109 and, consequently, its overall energy transfer efficiency.

The geometry of the coil 4109 can be selected and sized to accommodate the shape of the receiver coil assembly 936 that is arranged within the shin 84 of the robot 1, and to provide a significant degree of tolerance to minor misalignments in position and orientation. As such, the coil 4109 may be configured in a variety of shapes, including square, triangular, curvilinear (e.g., circular, oval, or elliptical), three-dimensional (e.g., helical or solenoidal coil), irregular, or amorphous, to optimize performance for a specific receiver coil design. Further, instead of being a winding of wire, the coil may be replaced with a solid bar, a flat planar piece of metal, printed circuit board (PCB) traces, conductive inks, polymers, or pastes printed onto a substrate, or any other known material configuration suitable for generating a magnetic field. In other embodiments, the transmitter coil assembly 4100 may also be part of a more complex array of coils. For instance, in some embodiments, the wireless charging surface 3104 may house multiple, concentric, or overlapping coils that are designed to create an even larger and more uniform effective charging area. Such advanced configurations may be selected to further enhance the robustness of the autonomous docking process by making the final placement of the robot's shins 84 even less precise. Further, the coils may be arranged in a phased array, could be actuated to allow for their physical repositioning to achieve optimal alignment, and/or may contain more than two coils that are arranged in a honeycomb or hexagonal pattern to create a contiguous charging surface.

The carrier 4116 includes a spiral groove or a collection of concentric grooves 4119 that are configured to retain the wire 4117 in a predetermined geometry and spacing. This mechanical control over the coil's geometry can be a factor in its performance, as the shape, turn-to-turn spacing, and overall dimensions of the coil 4109 influence the shape, strength, and uniformity of the generated magnetic field. In some embodiments, the predetermined geometry and spacing can be selected to improve or enhance the power-transfer efficiency of the transmitter coil assembly 4100. In some embodiments, the wire 4117 can rest within the grooves 4119 to increase the amount of surface area contact between the wire 4117 and the carrier 4116 to enhance thermal transfer, such that the carrier 4116 can act as a thermal transfer device to help dissipate thermal energy generated by the coil 4109 during charging. The carrier 4116 may be fabricated from a thermally conductive ceramic or a filled polymer composite so as to combine structural support, thermal conductivity, and magnetic transparency in a single element.

The carrier 4116 further defines a solid, raised oval central area 4115, which is circumscribed by the grooves 4119 and the windings of the coil 4109. The transmitter coil assembly 4100 may further include a shield layer 4111 (e.g., a ferrite sheet), which functions as a magnetic shield. The shield layer 4111 is disposed on or integrated with the carrier 4116, on the side that is opposite the coil 4109 windings. The primary function of the shield layer 4111 is to effectively manage the magnetic flux generated by the coil 4109. Ferrite materials, such as Manganese-Zinc (Mn—Zn) ferrite (e.g., TDK PC95 or DMR95), may be used for this purpose due to their high magnetic permeability and low core loss characteristics at the system's intended operating frequency (e.g., a frequency between 20 MHz and 200 kHz, and preferably between 70 and 100 kHz). In other embodiments, the shield layer 4111 may include or be made from nickel-Zinc (Ni—Zn) ferrite, amorphous magnetic materials, nanocrystalline materials, aluminum, copper, and/or magnetic composites. Furthermore, the shield layer 4111 may partially surround the coil, and/or the system may include a secondary, actively driven coil that generates a magnetic field to cancel out stray flux.

The high magnetic permeability of the shield layer 4111 provides a low-reluctance path for the magnetic field lines. This has the effect of guiding and concentrating the magnetic flux, directing it efficiently upwards toward the intended receiver coil assembly 936 on the robot 1, while simultaneously reducing its undesirable radiation downwards into the base 3100. This flux guidance can improve the magnetic coupling between the transmitter and receiver coils, which can in turn enhance the overall power transfer efficiency of the system. Concurrently, the shield layer 4111 serves to shield the underlying components of the charging system, such as sensitive power and control electronics, from the strong, oscillating magnetic field. This shielding reduces the induction of eddy currents in underlying conductive structures, which would otherwise result in parasitic power losses, excessive heating, and the potential for electromagnetic interference (EMI) with the control circuitry. This also helps the system meet regulatory standards for electromagnetic emissions, such as FCC Part 15 and CISPR 25, the latest versions of both of which are incorporated herein by reference. In some embodiments, the shield layer 4111 may not be a single monolithic piece but can instead be constructed from a collection of individual ferrite bars or strips that are arranged in a parallel array. This segmented construction allows for a degree of flexibility and can help to mitigate the risk of fracture in the otherwise brittle ferrite material. In some embodiments, the individual ferrite bars or strips may be bonded to a flexible backing material, such as a polyimide film or a woven fiberglass sheet, to maintain their spatial relationship while permitting the shield layer 4111 to conform to a curved mounting surface.

In some embodiments, the transmitter coil assembly 4100 may be implemented as a “balanced coil,” such as a bipolar coil that includes two identical circuits wound in a reverse orientation relative to each other. In such a configuration, when no foreign object is present, the magnetic fields generated by the two circuits will substantially cancel each other out, resulting in a substantially net-zero induced voltage at a designated sensing terminal. The introduction of a conductive foreign object can disrupt this magnetic symmetry, producing a non-zero voltage that reliably signals the presence of the object. This balanced coil configuration may serve as a passive foreign object detection (FOD) mechanism that operates without the need for additional sensor hardware.

### 2. Transmitter Electronics

The wireless power transmitter device 4020 may include the power supply unit 4102, charging controllers 4104a, 4104b, and a temperature sensor 4118. The charging controllers 4104a, 4104b may be communicatively coupled with a station computing device 4350 that may interface with other components (e.g., sensors, transceivers, controllers) housed in the docking station 3000. The wireless power transmitter device 4020 includes charging controllers 4104a, 4104b coupled to respective transmitter coil assemblies 4100a, 4100b, where the charging controllers 4104a, 4104b receive power from a power supply unit 4102. In the illustrative embodiment, the charging controllers 4104a, 4104b and power supply unit 4102 are housed in the charging tower 3180 of the base 3100. The power supply unit 4102 supplies power to the charging controllers 4104a, 4104b which regulate the power delivery to the coils.

The charging controller 4104 includes left and right transmitter power electronics 4310a, 4310b and a transmitter controller 4312. In the illustrative embodiment, the left and right transmitter power electronics 4310a, 4310b of the charging controller 4104 may be embodied as printed circuit board assemblies (PCBAs) configured to be coupled to a base support plate 4010. Similarly, the power supply unit 4102 may be configured on a main PCBA 4314. The main PCBA 4314 may further include or be coupled with a station computing device 4350 that includes a processor and memory. The transmitter controller 4312 may be a microprocessor (e.g., MCU) coupled to both transmitter power electronics 4310a, 4310b, individual microprocessors coupled to respective transmitter power electronics 4310a, 4310b, or the station computing device 4350 electrically coupled to both transmitter power electronics 4310a, 4310b, where the station computing device 4350 may also execute other functions.

In the illustrative embodiment, the power supply unit 4102 and the charging controller 4104 are configured to be coupled to the base support plate 4010. These electronics are configured to be protected from electromagnetic interference by a PCBA shield 3140 and from electrical shorts by insulating films 4320. In other embodiments, the power supply unit 4102 and charging controllers 4104a, 4104b may be arranged in a different manner. In other embodiments, the power supply unit 4102 and charging controllers 4104a, 4104b may reside in a separate housing, where they are electrically coupled to the transmitter coil assemblies 4100a, 4100b in the base 3100. The PCBA shield 3140 may be fabricated from a conductive material such as aluminum or mu-metal, and may be configured with ventilation apertures that permit limited convective airflow while maintaining electromagnetic shielding integrity.

The transmitter power electronics 4310a, 4310b may incorporate a resonant circuit design to enhance power transfer efficiency. This design could include strategically placed capacitors in series or parallel with the primary coils to form a resonant tank circuit that is precisely tuned to the operating frequency. By achieving resonance, the system minimizes reactive power losses and maximizes the efficiency of energy transfer. The resonance frequency may be dynamically adjusted to accommodate variations in load impedance or environmental factors. For example, the transmitter power electronics 4310a, 4310b may include DC-to-AC inverters, such as H-bridge inverters, which are shown as DC converters 4316a, 4316b, and matching networks 4318a, 4318b that optimize power transfer efficiency by matching the impedance of the inverter to the coil.

The transmitter power electronics 4310a, 4310b may include a variable frequency drive (VFD) or a phase-locked loop (PLL) control system to dynamically adjust the operating frequency in response to real-time coupling conditions. As the robot 1 moves or shifts its position slightly during charging, the optimal coupling frequency may change due to variations in alignment and load impedance. A feedback loop incorporating impedance sensing and frequency tuning algorithms can continuously optimize the operating frequency, ensuring maximum power transfer efficiency while preventing detuning effects that could reduce charging performance. In some embodiments, the impedance sensing may be performed by monitoring the reflected impedance at the transmitter coil assembly 4100, wherein changes in the reflected impedance indicate a deviation from the optimal coupling condition, thereby triggering the PLL control system to adjust the switching frequency of the inverter.

To achieve higher efficiency and reduced power losses, the power electronics could leverage wide-bandgap semiconductor devices such as gallium nitride (GaN) or silicon carbide (SiC) transistors. These materials enable operation at significantly higher switching frequencies with lower on-state resistance and switching losses compared to traditional silicon-based components. This advancement allows for more compact, lightweight power converters with improved thermal performance and reduced heat dissipation, making them ideal for high-power wireless charging applications. Additionally, the base 3100 could incorporate a matrix of individually addressable coils, controlled through an intelligent coil selection algorithm. By selectively activating only the coils directly beneath the robot's shins 84, the system optimizes energy distribution, minimizing electromagnetic interference and improving overall system efficiency.

### 3. Heat Dissipation Features

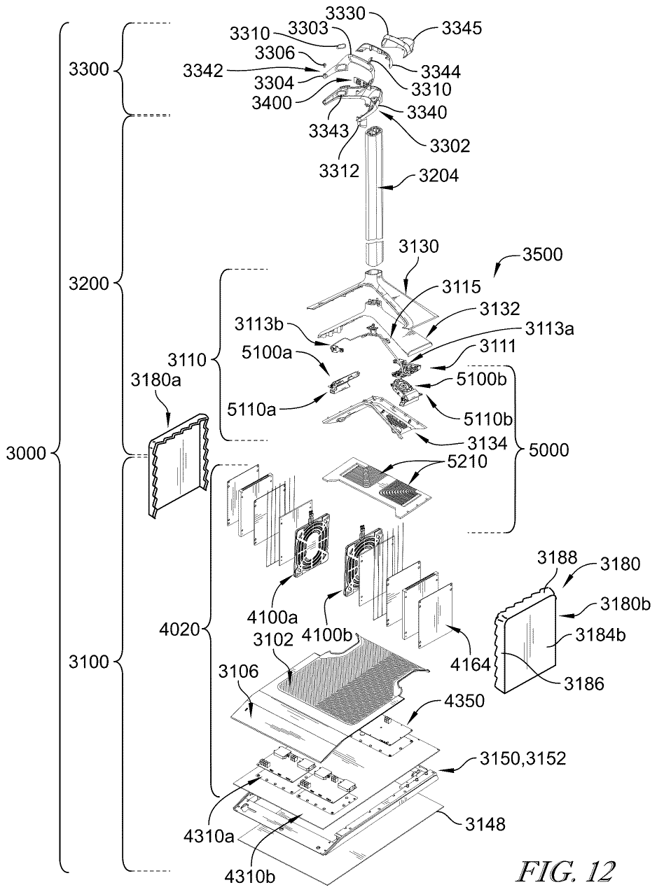

The base 3100 includes (i) heat spreaders 4166, (ii) thermal conductors 4170, and/or (iii) the thermal transfer device 5200 as shown in FIGS. 12-13. These heat dissipation features may be fabricated from a variety of metallic or other heat-conducting materials. For example, aluminum alloys, such as 6063 and 6061, are frequently employed in thermal transfer devices due to their favorable balance of good thermal conductivity, ease of formability, and cost-effectiveness. For applications demanding higher thermal performance, copper or copper alloys may be utilized, offering significantly enhanced thermal conductivity compared to aluminum. Furthermore, for scenarios that call for even higher thermal management capabilities, advanced materials such as pyrolytic graphite or graphite composites could be considered. These materials are renowned for their anisotropic thermal conductivity, exhibiting high conductivity along specific planes. In highly specialized implementations, liquids (e.g., water, glycol, liquid metal alloys) within sealed channels could be explored for their remarkably efficient heat transfer properties. The final selection of materials for the heat spreaders 4166, the thermal conductors 4170, and the thermal transfer devices 5200 can be based on factors such as the anticipated thermal load, spatial constraints, weight considerations, and the target manufacturing cost.

Each heat spreader 4166 may be further coupled to the thermal transfer device 5200 by thermal conductors 4170 which extend from the heat spreader 4166 to the thermal transfer device 5200. The thermal conductor 4170a, 4170b extend through the channels of the heat spreaders 4166 and are in contact with the interior surfaces of the channels to absorb and conduct the heat energy away from the WPT system 4000 and toward the thermal transfer device 5200. In some embodiments, the thermal conductors 4170 may be a solid piece of copper or other thermally-conductive material, and can implement conduction as a mechanism for allowing heat energy to flow from an area of high heat (e.g., near the transmitter coil assemblies 4100a, 4100b) to a relatively cooler area (e.g., the thermal transfer device 5200). In some embodiments, the thermal conductors 4170 may be configured as heat pipes. For example, the thermal conductors 4170 may be configured as cylindrical tubes incorporating a wick structure inside of the tube. A working fluid (e.g., water) absorbs heat at one end (the evaporator), turns into vapor, and travels to the cooler end (the condenser) where it releases heat and condenses. The wick then transports the liquid back to the evaporator via capillary action. In some embodiments, heat pipes may be highly effective at transferring heat over distances with little temperature drop and may be integrated into larger heat spreader and heat sink assemblies such as the thermal transfer device 5200 and/or the heat spreaders 4166.

The heat spreaders 4166 and/or thermal conductors 4170 may be fabricated from a variety of metallic or other heat-conducting materials. For example, aluminum alloys, such as 6063 and 6061, are frequently employed in thermal transfer devices due to their favorable balance of good thermal conductivity, ease of formability, and cost-effectiveness. For applications demanding higher thermal performance, copper or copper alloys may be utilized, offering significantly enhanced thermal conductivity compared to aluminum. Furthermore, for scenarios that call for even higher thermal management capabilities, advanced materials such as pyrolytic graphite or graphite composites may be considered. These materials are renowned for their anisotropic thermal conductivity, exhibiting high conductivity along specific planes. In highly specialized implementations, liquids (e.g., water, glycol, liquid metal alloys) within sealed channels may be explored for their remarkably efficient heat transfer properties. The final selection of materials for the heat spreaders 4166 and the thermal transfer devices 5200 may be based on factors such as the anticipated thermal load, spatial constraints, weight considerations, and the target manufacturing cost.

In some embodiments, the thermal conductors 4170 may implement a circulating liquid coolant (e.g., water, glycol, or a specialized dielectric fluid) through a cold plate attached to the heat-generating component. The heat transfers from the component to the liquid, which is then pumped to a radiator the where the heat is dissipated into the ambient air. In some embodiments, the thermal transfer device 5200 and/or the heat spreaders 4166 may be thermoelectric coolers (e.g., Peltier devices). These solid-state devices utilize the Peltier effect to create a temperature difference when an electric current is passed through them. One side of the device becomes hot while the other becomes cold. The cold side may be attached to a component to actively pump heat away to the hot side, which may be cooled by a conventional heat sink and fan. In some embodiments, a combination of passive heat pipes and active thermoelectric coolers may be used in tandem, such that the heat pipes handle baseline thermal loads and the thermoelectric coolers engage during peak-power charging events.

a. Temperature Sensor

Each transmitter coil assembly 4100 may include at least one temperature sensor 4118, where the temperature sensor 4118 is coupled to the transmitter controller 4312 or the station computing device 4350. The temperature sensor 4118 may be physically coupled to or integrated within the transmitter coil module 4106, and positioned in close thermal contact with the wire 4117 or the carrier 4116 to facilitate accurate real-time temperature measurements. The primary function of the temperature sensor 4118 is to provide continuous thermal monitoring of the transmitter coil assembly 4100 during its operation. This is relevant as the flow of high-frequency alternating current through the wire 4117 can generate a significant amount of heat due to resistive losses (I²R losses). In one exemplary embodiment, the temperature sensor 4118 may be a Negative Temperature Coefficient (NTC) thermistor, whose resistance decreases in a predictable, non-linear fashion as its temperature increases. The temperature data acquired by the sensor 4118 can be transmitted as an analog or digital signal to the charging controller 4104 or another control unit within the docking station 3000. This data serves as a feedback input for a closed-loop thermal management system. The thermal management system can be configured to take protective action if the temperature measured by the sensor 4118 exceeds a predetermined operational threshold. For instance, if the coil temperature approaches a limit that could risk damage to the wire's insulation, the carrier 4116, or adjacent components of the docking station 3000, the charging controller 4104 can respond by reducing the transmitted power, thereby lowering the current in the wire 4117 and decreasing the rate of heat generation to reduce the risk of thermal runaway or damage. In some embodiments, where the temperature exceeds a maximum safety limit, the controller 4104 can terminate the power transmission entirely.

Examples of sensors that could be used as part of the temperature sensor 4118 can include the Amphenol Advanced Sensors (Thermometrics) type C100 and 95 series, the Vishay NTCLE100E3 series, the TDK (EPCOS) B57861S series, the Murata NXRT Series, for example, NXRT15XH103FA1B040, the TE Connectivity GA series (e.g., GA10K3A1A), the Semitec AP-2 series, the Littelfuse DO-34 series, the Ametherm PANR series (e.g., PANR 103395), and the Honeywell 192-103LET-A01. It has been determined through testing that the design of the temperature sensor 4118 itself can be a factor; for instance, using an un-shielded wire for the thermistor can avoid having the sensor's own shielding be inductively heated by the magnetic field, which could otherwise lead to erroneous temperature readings. In some embodiments, each transmitter coil assembly 4100 may include a plurality of temperature sensors 4118 distributed at different positions along the coil 4109, such as at the center, at the periphery, and at a midpoint between the center and the periphery, to provide a thermal gradient map of the coil 4109 and to enable the charging controller 4104 to detect localized hotspots.

b. Support Frame Assembly

The support frame assembly 3200 includes (i) a flared base 3110 that is integrated with or coupled to the rear interface portion 3158 of the platform 3102 (or charging tower 3180), (ii) a vertical support portion 3204 that extends generally upward from the flared base 3110, and (iii) a support cradle 3300 configured to extend over the base 3100 to couple with and support the robot 1. The materials for each component may be selected to optimize its particular performance characteristics. In some embodiments, the platform 3102 may be constructed from a high-density, weighted polymer composite to provide a low center of gravity and improved stability against tipping, while the support frame assembly 3200 may be formed from polymers, plastics, aluminum, or steel. In some embodiments, the support frame assembly 3200 may be formed from a carbon-fiber reinforced polymer to provide a high strength-to-weight ratio, which may facilitate the manual or robotic transport of the docking station 3000.

The support cradle 3300 is positioned in a forward-projecting, cantilevered manner relative to the vertical support portion 3204. This configuration allows the robot 1 to reverse backward into the support cradle 3300 for docking. This cantilevered design also ensures that the robot 1, when coupled with the docking station 3000, is inherently stable by keeping the robot's center of mass positioned directly over the most stable part of the base 3100, for example, the center 3120 of the platform 3102. The wide stance of the base 3100 relative to the overall height of the support frame assembly 3200 also increases the stability of the docking station 3000. This enables the robot 1 to be positioned in a forward-facing direction, wherein the support frame assembly 3200 and support cradle 3300 are positioned a predetermined distance that places the center of gravity of the robot 1 proximal to the center 3120 of the base 3100, and/or places the robot's 1 feet 92 proximal to the center 3120 (e.g., in a target “sweet spot” of the charging coils).

The support frame assembly 3200 is designed to extend upwards from the base 3100 to engage with the posterior and lateral aspects of the robot 1. Specifically, the support cradle 3300 is configured to engage with the robot 1 at its waist 604. In this engaged position, the robot 1 maintains a natural, upright posture, and the cradle provides robust, multi-axis mechanical support, which effectively offloads the static gravitational load from the robot's own actuators onto the structure of the docking station 3000. Said upright posture may be conducive to long-term autonomous operation by allowing the robot 1 to be physically supported by the support frame assembly 3200 while simultaneously being positioned for receiving wireless charging power via the base 3100. Additionally, this upright posture may be advantageous for operations in human-centric environments where available floor space may be limited, and where the robot 1 should maintain a minimal physical footprint to avoid causing an obstruction.

In various embodiments, the support frame assembly 3200 may be removably attached to the base 3100. In some embodiments, the support frame assembly 3200 may be removably attached using quick-release mechanical and electrical attachments or connectors, allowing for a modular system. In other embodiments, the support frame assembly 3200 may be permanently attached, adjustable, wall or floor mountable, wherein the base 3100 may be omitted, or omitted entirely to provide just the base 3100 for opportunity charging scenarios. In some embodiments, the quick-release mechanical and electrical attachments may include a tongue-and-groove mechanical interlock combined with a blind-mate electrical connector, such that a single insertion motion establishes both the structural coupling and the electrical connection between the support frame assembly 3200 and the base 3100.

i. Flared Base

The flared base portion 3110 is configured to couple to the rear interface portion 3158 of the platform 3102. The flared base portion 3110 includes an internal support structure 3132, an upper support shell 3130, and a lower support shell 3134. The upper and lower support shells 3130, 3134 form a flare cavity 3208 configured to house components of the active cooling system 5000 and the sensor assembly 3111, and to route wiring. An airflow channel 3112, formed between the flared base 3110 and the base 3100, serves as an inlet for a thermal management system.

The flared base portion 3110 provides the mechanical interface at the rear interface portion 3158 of the base 3100. It serves as the structural transition between the vertical support portion 3204 and the base 3100 and provides a rigid connection between them. The various surfaces of the flared base portion 3110 may be formed with rounded inside corners 3114, which substantially reduce the occurrence of concentrated point stresses and increase the overall strength and fatigue life of the support frame assembly 3200. The rounded inside corners 3114 may have a radius that is selected to be above a minimum threshold determined by finite element analysis of the expected loading conditions during docking.

The internal support structure 3132 is configured to provide rigidity to the flared base 3110 and includes various mounting points, bosses, and features for positioning and securing internal components, such as fan assemblies and sensor modules. In various embodiments, the internal support structure 3132 may be fabricated from a range of materials selected for their structural properties, including metals such as aluminum or stainless steel, composite materials like carbon fiber, or high-strength engineering plastics. The internal support structure 3132 may also include vibration-damping features, such as elastomeric grommets or isolator pads, to prevent mechanical vibrations from the fan assemblies 5100a, 5100b from propagating to the sensor assembly 3111 and affecting sensor accuracy.

A flare cavity 3208 is defined between the shells and is open to the interior cavity 3202 of the vertical support portion 3204. Power and/or data buses may pass through the flare cavity 3208 and/or the interior cavity 3202 to deliver power and/or communications between the base 3100 and electronic components housed within the support cradle 3300. Further, the lower support shell 3134 may include a collection of air inlets (e.g., through apertures) configured to permit ambient air to enter the flare cavity 3208 for the active cooling system 5000. In some embodiments, the air inlets may include mesh filters or screens configured to prevent the ingress of particulate matter, dust, or debris into the flare cavity 3208, where such contaminants could degrade the performance of the fan assemblies 5100a, 5100b or the electronic components housed therein.

By transitioning from the narrow profile of the vertical support portion 3204 to a much wider footprint at its base, the flare shape increases the stability of the docking station 3000 against tipping. This flared shape also serves to distribute the stress from any load applied to the support frame assembly 3200 over a much larger area of the base 3100. The angled surfaces of the flare also act as integrated gussets, creating a naturally rigid triangulated structure that efficiently translates any lateral and bending forces into tension and compression, thereby providing substantial reinforcement to the overall structure. This method of construction, which in some embodiments can be achieved through a process like injection molding, casting, machining, or additive manufacturing, can result in a part that is both stronger and more rigid than a comparable bolted assembly.

ii. Vertical Support Portion

The vertical support portion 3204 of the support frame assembly 3200 is configured to provide a structural support and a load path between the support cradle 3300 and the base 3100, via the flared base 3110. Further, the vertical support portion 3204 defines an interior cavity 3202 that provides a protected conduit through which one or more power and/or data busses may pass to deliver power and/or communications between the base 3100 and electronic components housed within the support cradle 3300. In the illustrative embodiment, the vertical support portion 3204 has a substantially ovoid profile, but in some embodiments the profile may be any geometric shape in cross-section, including circular, square, triangular, polygonal, or oval. The cross-sectional shape and wall thickness of the vertical support portion 3204 may be selected to provide a second moment of area that is sufficient to resist the bending moments generated by the cantilevered support cradle 3300 and the weight of the robot 1 when docked.

iii. Support Cradle

The support cradle 3300 is coupled to and projects forward from the vertical support portion 3204 of the support frame assembly 3200. The support cradle 3300 has a main cradle body 3301 that supports two outwardly extending cradle arms 3302. The support cradle 3300 includes a lower shell 3340, a cradle shell 3342, a rear shell 3344, and a tail shell 3345. The inner surface 3303 of the cradle 3300 is contoured to substantially match the complex three-dimensional geometry of the robot's waist 604. This contouring serves to distribute contact forces over a wide surface area, which prevents the creation of pressure points and ensures a snug, stable fit. In alternative embodiments, only a portion of the inner surface 3303 of the cradle 3300 may be contoured to substantially match the robot's exterior surface, or the inner surface of the cradle 3300 may not be contoured to substantially match the robot's exterior surface.

The cradle arms 3302 are defined by the lower shell 3340 and the cradle shell 3342. The cradle arms 3302 have a cantilevered configuration relative to the vertical support portion 3204 that helps define a retaining aperture 3305 that provides vertical support as well as horizontal bracing for the rear and lateral sides of the robot 1. The cradle arms 3302 extend symmetrically from the main cradle body 3301 and are formed with a curved shape to reduce point loads between the cradle arms 3302 and the vertical support portion 3204, thereby increasing the strength of the cradle arms 3302. Each cradle arm 3302 terminates in a respective alignment post base 3304, from which a vertical alignment post 3306 extends upward. The curved shape of the cradle arms 3302 may follow a constant-stress or a uniform-strength beam profile, in which the cross-sectional geometry varies along the length of the arm such that the bending stress is distributed, thereby maximizing the load-bearing capacity of the cradle arms 3302 for a given weight of material.

Side gripper pads 3310, which may be made from a durable elastomer such as polyurethane with a specified durometer measurement, are positioned on the inner surface of the cradle arms 3302. These pads are supported by support posts 3311 that extend through apertures 3343 defined in the cradle shell 3342, in order to provide a soft, high-friction contact point, thereby helping to prevent any slippage without marring the exterior surface finish of the robot 1. A rear support pad 3312 is positioned centrally on the cradle in order to provide stable, anti-rotational support to the back of the robot's waist 604. In some embodiments, the side gripper pads 3310 and the rear support pad 3312 may be replaceable wear items that can be removed from their respective support posts 3311 and replaced with new pads when worn, thereby extending the service life of the docking station 3000.

An access opening 3320 is formed through a rear extent of the main cradle body 3301, allowing for the formation of a cradle handle 3330. The upper rim of the support cradle 3300 is integrated into an ergonomic cradle handle 3330, which allows for easy manual transportation and repositioning of the docking station 3000. The placement of the cradle handle 3330 at the top of the structure leverages the stand's center of mass, making it feel balanced and lighter to lift than its actual weight might suggest, which may improve usability for human co-workers. In some embodiments, the cradle handle 3330 can also permit the robot 1 to pick up and transport its own docking station 3000 to a new (e.g., possibly more optimal) recharging location.

The cradle arms 3302 are shaped to form a guiding, funnel-like U-shaped geometry. This shape provides a form of passive mechanical guidance, creating a wide entry point that naturally corrects for any minor lateral misalignments as the robot 1 reverses into the docking station 3000. Each cradle arm 3302 terminates in a respective alignment post base 3304, from which a vertical alignment post 3306 extends upward. This symmetry helps to simplify the docking process, as a symmetrical target is significantly easier for the robot's perception system to identify and model. The vertical alignment posts 3306 of the cradle arms 3302 are designed to function as part of a high-precision kinematic coupling and are designed to engage with corresponding concave recesses that are located on the waist 604 of the robot 1. This physical engagement provides definitive tactile feedback to the internal sensors of the robot 1 and ensures a highly repeatable final docked position. This high degree of precision is useful for optimizing the coupling efficiency for wireless power transfer, as even minor misalignments in the positioning of the coils can degrade the overall rate of charging.

A rear support pad 3312 is coupled to the main cradle body 3301, where the support cradle 3300 is coupled to the vertical support portion 3204. The rear support pad 3312 is positioned centrally to provide stable, anti-rotational support to the back of the robot's waist 604, as well as a soft, high friction contact point, preventing slippage without marring the robot's exterior finish. A communication transceiver 3400 is arranged within the structure of the cradle handle 3330 in order to facilitate high-bandwidth data communication with a corresponding transceiver on the robot 1 when it is docked. In some embodiments, the communication transceiver 3400 may be positioned within a radio-frequency (RF) transparent window formed in the cradle handle 3330, such that the structural material of the cradle handle 3330 does not attenuate the wireless communication signal.

The profile of the vertical alignment post 3306 may have a tapered or chamfered top surface. This geometry acts as a mechanical lead-in, effectively capturing the corresponding recess on the robot 1 and actively guiding it into final alignment, making the system more tolerant of small initial positional errors during the docking maneuver. While the primary function of the vertical alignment post 3306 is mechanical, its precise and highly repeatable engagement could make it a desirable location for incorporating additional functionalities. In some embodiments, the vertical alignment post 3306 can be configured to serve as a multi-function interface. For example, the vertical alignment post 3306 can be equipped with robust, spring-loaded electrical contacts that are designed to mate with corresponding conductive pads located within the recess of the robot's waist, thereby establishing a direct, high-amperage wired charging connection. This connection can be used to supplement the primary wireless charging system, thereby offering redundancy or enabling even higher-power rapid charging modes. In some embodiments, the vertical alignment posts 3306 can be configured to include various sensors that can be used to verify a nominal docking. For example, the vertical alignment posts 3306 can be configured to include integrated load cells, such as strain gauges, that can be used to measure the amount of weight that is being placed upon each vertical alignment post 3306, in order to determine whether the robot 1 is fully docked and/or to determine that the robot 1 is evenly balanced upon the support cradle 3300. An uneven pressure distribution detected by the load cells would signal a misalignment, thereby prompting the behavior controller 1560 of the robot 1 to make subtle micro-adjustments to its posture.

As the robot 1 lowers itself onto the cradle 3300, it can be configured to use force and torque sensors that are located in its spine 60 and hip 64, and optionally also in the support cradle 3300 itself, to feel for simultaneous, balanced contact with both of the cradle arms 3302 and the rear support pad 3312. An unevenly distributed pressure reading would signal a misalignment, prompting the behavior controller 1560 of the robot 1 to make micro-adjustments. A definitive tactile cue can be the distinct haptic feedback that is generated as the vertical alignment posts 3306 fully seat themselves into their corresponding recesses on the robot 1. This provides an unambiguous, non-visual confirmation that the robot 1 is nominally positioned. In some embodiments, the robot 1 may further confirm seating by comparing the measured force profile at the vertical alignment posts 3306 against a stored reference force profile that corresponds to a known, nominal docking event, and may reject any docking event in which the measured force profile deviates from the reference force profile by more than a predetermined tolerance.

c. Station Electronics Assembly

The station electronics assembly 3500 of the docking station 3000 may include a station computing device 4350, a sensor assembly 3111, and a communications transceiver 3400. The station electronics assembly 3500 may be coupled to the wireless power transmitter device 4020 and the active cooling system 5000 for integrated control of various systems. The station electronics assembly 3500 may further include a non-volatile memory configured to store operational logs, charging event histories, error codes, and firmware update images, thereby enabling the docking station 3000 to retain diagnostic data across power cycles and to support field-based maintenance procedures.

i. Station Computing Device

The station computing device 4350 may operate as one or more general purpose processors or special purpose processors, for example, digital signal processors, application specific integrated circuits (ASICs), or field programmable gate arrays (FPGAs), that can be configured to execute computer-readable program instructions. Such instructions can be executed to provide controller operations for the docking station 3000. Specifically, the docking station 3000 may be configured with a variety of processors such as one or more central processing units (CPUs) (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

The station computing device 4350 may incorporate machine learning algorithms to analyze historical charging data, adapt power delivery parameters, and optimize charging performance over time. By monitoring factors such as the robot's movement patterns during docking, battery charge-discharge cycles, and environmental influences like ambient temperature, the system can fine-tune parameters such as duty cycle, operating voltage, and resonance tuning. Predictive analytics could be employed to preemptively adjust charging characteristics, thereby enhancing performance and potentially extending battery longevity. In some embodiments, the machine learning algorithms may be implemented as an on-device neural network model that is trained on aggregated fleet-wide charging data received from a central command center 2750A-X and updated via over-the-air firmware updates.

ii. Communication Interface

The station electronics assembly 3500 may include the communication transceiver 3400 or other means of data communication configured to communicate with the robot 1. In the illustrative embodiment, the communication transceiver 3400 is positioned in the support cradle 3300 and configured to couple with a corresponding wireless transceiver 604.34 positioned within the waist portion 604 of the robot 1. When docked, the two transceiver assemblies are brought into a face-to-face arrangement, separated by a small or minimal air gap (e.g., 5 mm, 1 cm, 2 cm, 5 cm). This close-proximity, high-bandwidth link allows the robot 1 to offload large volumes of sensor data or receive major firmware updates while docked. The external support provided by the cradle 3300 allows the robot 1 to maintain stable alignment between the transceivers to maintain wireless high-bandwidth communications with the docking station 3000. In other embodiments, the docking station 3000 may be configured with other means of data communication, such as a direct optical data link or an ultra-wideband (UWB) radio link.

The communication transceiver 3400 may be communicatively coupled to other electronic components of the docking station 3000 and/or to external systems by means of a communication bus. For example, the communication bus can be a 10GBase-T ethernet cable (e.g., a CAT-6, CAT-6a, or CAT-7 cable) routed to extend down through the interior cavity 3202 of the vertical support portion 3204 to connect to compatible transceivers that are located in the vertical support portion 3204, in the base 3100, and/or to exit the docking station 3000 for connection to other external equipment (e.g., to plug into a wall-mounted ethernet jack that is connected to a local area network (LAN)). In operation, the communication transceiver 3400 acts as a wired-to-wireless communication bridge in order to provide high bandwidth, bidirectional communication between the robot 1 and the docking station 3000 and/or other external systems and servers. In some embodiments, the communication transceiver 3400 may support a plurality of wireless protocols, including Wi-Fi 6E, Bluetooth 5.x, and a proprietary near-field communication protocol, and may select the appropriate protocol based on the data type and the latency tolerance of the communication session.

d. Active Cooling System

As discussed previously, the WPT system 4000 can generate a great deal of heat during operation. The overall arrangement of the WPT system 4000 and the active cooling system 5000 is configured to facilitate the removal of thermal energy. The active cooling system 5000 generates air flow paths through portions of the base 3100 and the support stand 3200 to cool components of the WPT system 4000 in the docking station 3000. This integrated thermal management infrastructure is configured to mitigate heat generated during high-power wireless charging operations, thereby supporting desired performance, longevity, and operational safety of the charging stand 3000 and the robot 1.

The active cooling system 5000 includes: (i) a pair of fan assemblies 5100a, 5100b, (ii) a pair of air ducts 5110a, 5110b, and (iii) a thermal transfer device 5200. The fan assemblies 5100a, 5100b (also referred to as air moving devices), are arranged within the support stand 3200 and configured to generate the air flow path F. The air ducts 5110a, 5110b are coupled to an outlet of a respective fan assembly 5100a, 5100b to receive air drawn in through inlet apertures formed in the support stand 3200 by the fan assemblies 5100a, 5100b and direct the air toward the thermal transfer device 5200. The thermal transfer device 5200 is configured to receive thermal energy or heat generated by the WPT system 4000. The thermal transfer device 5200 is positioned within the air flow path F so that air exhausted by the fan assemblies 5100a, 5100b flows along the thermal transfer device 5200 (e.g., plurality of heat transfer features 5210). In this way, heat is transferred to the air flow path from the components of the WPT system 4000 in thermal communication with the thermal transfer device 5200.

The active cooling system 5000 is configured as a modular and readily replaceable or interchangeable component, offering significant advantages in terms of manufacturing, maintenance, and potential future upgrades. This thermal management strategy can contribute to maintaining operating temperatures within the docking station 3000, mitigating component degradation, and supporting consistent power transfer. The illustrated examples provided in the figures show the integrated nature of these components, demonstrating how the wireless charging elements may be cooled to reduce overheating and support the operation of the docking station 3000 while charging the robot 1. In some embodiments, the modularity of the active cooling system 5000 may permit the replacement of the fan assemblies 5100a, 5100b with higher-capacity fan assemblies, or the replacement of the thermal transfer device 5200 with a larger or more efficient variant, to accommodate future increases in the power output of the WPT system 4000 without redesigning the base 3100 or the support stand 3200.

The thermal transfer device 5200 is configured to receive thermal energy or heat generated by the WPT system 4000 and transfer the heat from the WPT system 4000 to the air flowing through the air flow path. In the illustrative embodiment, the thermal transfer device 5200 is positioned towards a rear extent of the base 3100, rearward of the transmitter coil assemblies 4100a, 4100b (e.g., from the perspective of a docked robot). Each heat spreader 4166 is coupled to the thermal transfer device 5200 by thermal conductors 4170 which extend from the heat spreader 4166 to the thermal transfer device 5200 to transfer heat thereto. The thermal conductors 4170a, 4170b extend through the heat spreaders 4166 and are in contact with the interior surfaces of the channels to absorb and conduct the heat energy away from the WPT device 4020 and toward the thermal transfer device 5200. In other embodiments, the thermal transfer device 5200 may be integrated into the charging tower 3180 instead of the base housing 3150. Instead of active cooling, the thermal transfer device 5200 may be a passive heat exchange element configured to help dissipate thermal energy generated by the WPT device 4020 to the surrounding environment.

The thermal transfer device 5200 is designed with heat transfer features 5210 (e.g., a network of channels). The network of channels 5210 are arranged to run from inlet ends to outlet ends and configured to guide a forced airflow from the fan assemblies 5100a, 5100b across the surface of the thermal transfer device 5200, thereby dissipating thermal energy conducted from the WPT system 4000. The geometry of the internal channels 5210 within the thermal transfer device 5200 may be configured in arrangements to enhance the efficacy of the heat transfer process. For instance, rather than being substantially straight, the channels 5210 may be formed into a serpentine or wavy pattern. Such a configuration would increase the overall length of the airflow path, thereby increasing the residence time of the air within the thermal transfer device 5200 and allowing for more complete thermal absorption.

The channels 5210 may also vary in thickness, height, orientation, and spacing to optimize airflow and heat transfer depending on the specific cooling requirements and design constraints. For example, the channels 5210 may: (i) have a rectangular cross-sectional shape, (ii) a curved cross-sectional shape, or (iii) have any other suitable cross-sectional shape that is known to one of skill in the art. Furthermore, the channels 5210 may be configured to induce turbulence in the airflow, which disrupts the laminar boundary layer adjacent to the channel walls and significantly improves the convective heat transfer coefficient. In another embodiment, the walls of the channels 5210 may be augmented with features such as fins, ribs, or other forms of turbulators. These features may serve a dual purpose of substantially increasing the total surface area available for heat exchange while also inducing turbulence into the airflow, further enhancing the rate of heat dissipation. In some embodiments, the turbulators may be arranged in a staggered pattern on opposing walls of the channels 5210 to promote chaotic fluid mixing and to prevent the formation of stagnation zones where heat transfer is diminished.

### F. OPERATION OF WIRELESS POWER TRANSFER SYSTEM

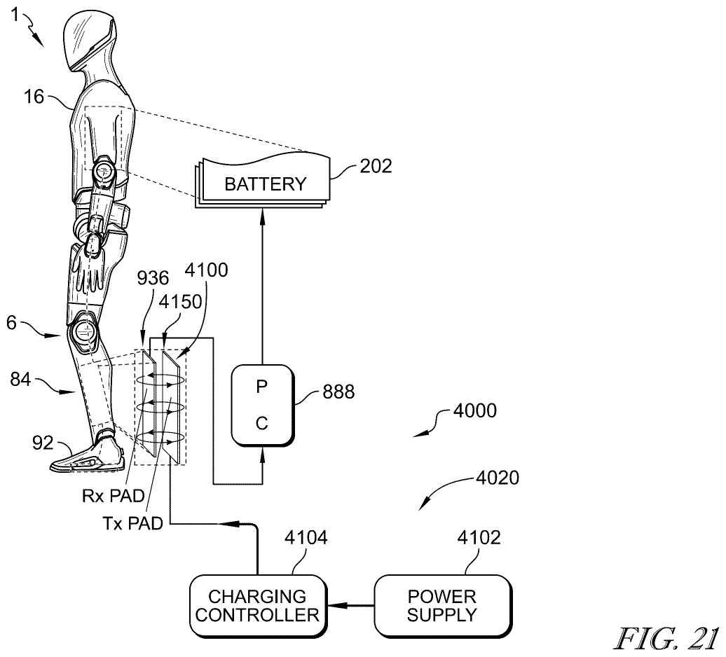

FIGS. 21-22 illustrate a high-level functional block diagram of an exemplary wireless power transfer (WPT) system 4000, which illustrates the principal subsystems thereof and the flow of power and information therethrough. The system 4000 broadly includes a transmitter coil assembly 4100, which may be situated within the base 3100 of the docking station 3000, and a corresponding receiver coil assembly 936, which is configured for integration within the humanoid robot 1, for instance, in one or both of the shins 84. The block diagram serves to illustrate the principal power conversion stages and the bidirectional communication architecture that enable coordinated, closed-loop wireless charging. Each subsystem block depicted in FIGS. 21-22 may be embodied as a discrete circuit board, an integrated module, or a combination of hardware and firmware, depending on the design constraints and packaging considerations for the particular implementation.

The transmitter coil assembly 4100 is configured to receive utility power and convert it into a controlled, high-frequency magnetic field. The process is initiated by a power supply block 4102, which is configured to receive electrical power from a conventional alternating current (AC) source, such as a standard wall outlet providing, for example, 90-264 volts AC at a frequency of 20-90 Hz. The input power may first be subjected to an electromagnetic compatibility (EMC) filter stage, which can be constituted by components including, but not limited to, X/Y capacitors, common-mode chokes, and a Metal Oxide Varistor (MOV), for the purpose of suppressing conducted and radiated electromagnetic noise and protecting the system against transient voltage surges. Subsequent to filtration, the alternating current may be converted to direct current (DC) by means of a bridge rectifier. In certain instantiations of the design, a Power Factor Correction (PFC) circuit may be disposed downstream of the rectifier to ensure an efficient power draw from the mains supply, thereby establishing a stable, high-voltage DC bus, which may be on the order of 400 volts DC. Furthermore, it is contemplated that in some embodiments, the power supply block 4102 may incorporate an auxiliary power supply, such as a flyback converter, for the generation of various low-voltage DC rails (e.g., 12V, 5V, 3.3V) for the energization of the control electronics, microcontrollers (MCUs), and any associated cooling fans of the docking station 3000.

A charging controller block 4104, which includes the primary power electronics of the transmitter side, is configured to effect the conversion of the high-voltage DC, provided by the power supply block 4102, into a precisely controlled, high-frequency AC waveform. The aforementioned high-voltage DC energizes one or more full-bridge inverters, said inverters being sophisticated switching circuits constructed from high-performance components such as silicon carbide (SiC) metal-oxide-semiconductor field-effect transistors (MOSFETs) or insulated-gate bipolar transistors (IGBTs). Under the governance of a transmitter microcontroller unit (MCU), these inverters transform the DC power into a high-frequency AC waveform, operating, for example, at a nominal frequency between 20 to 200 kHz, and preferably at 85 kHz. The regulation of the power output may be achieved through the application of advanced modulation techniques, which may include a combination of phase-shifting and duty-cycle control. The resultant high-frequency AC output from the inverter may be subsequently conditioned by an LC filter to produce a substantially sinusoidal waveform, whereupon it is supplied to an impedance matching network (IMN). The IMN, which may be embodied as a dynamically adjustable matrix or array of capacitors, tunes the circuit to a specific resonant topology, such as LCC-S or LCC-P, for the purpose of maximizing the efficiency of power transfer across the air gap between the transmitter and receiver. Ultimately, the conditioned, high-frequency current energizes the transmitter coil assembly (TX PAD) 4100, thereby generating the powerful, oscillating magnetic field suitable for wireless power transmission.

The receiver coil assembly 936, represented by the designation Rx PAD and configured for integration within the robot 1 (e.g., within the shin 84), is operative to capture the transmitted magnetic energy and convert said energy into a usable form of electrical power for the robot 1. For the transfer of power to be effected, the receiver coil assembly (Rx PAD) 936 is positioned within the magnetic field generated by the transmitter coil assembly 4100. The oscillating magnetic field induces a high-frequency alternating current in the receiver coil. This induced AC signal may be subsequently passed through an impedance matching network (IMN) of the receiver coil assembly 936, which may likewise employ a capacitor array to ensure that the receiver circuit is precisely tuned to the resonant frequency of the transmitter coil assembly 4100. The IMN of the receiver coil assembly 936 may be tuned to the same resonant frequency as the IMN of the transmitter coil assembly 4100, or it may be tuned to a slightly offset frequency to accommodate manufacturing tolerances and variations in the air gap distance.

The tuned, high-frequency alternating current may be thereafter converted to direct current by a rectification stage. In certain embodiments, said rectification stage may be realized as a standard diode full-bridge rectifier or, for higher efficiency, an active synchronous rectifier. This stage is capable of producing a rectified DC voltage (Vrec) at a predetermined value that is between 10V and 400V, and preferably between 48 and 60 volts. This rectified DC voltage may then be supplied to a final DC/DC converter, which is tasked with the precise regulation of the voltage and current to satisfy the specific charging needs of the onboard battery 202 of the robot 1 and its main power bus. The DC/DC converter may be embodied as a buck converter, a boost converter, or a buck-boost converter, depending on the voltage relationship between the rectified output and the battery 202 charging voltage profile. In some embodiments, the DC/DC converter may further include a current-limiting protection circuit configured to prevent a transient overcurrent condition from damaging the battery cells in the event of a sudden change in load impedance.

The flow of energy and data within the system is represented by the charging controllers 888a, 888b in each leg 6, which are disposed within the robot 1, for example, in one or both of the leg assemblies 6. The primary power pathway, designated “P” in the diagram, originates at the power supply block 4102, proceeds through the charging controller 4104 and the transmitter coil assembly 4100, traverses the magnetic link across the air gap to the receiver coil assembly 936, and ultimately culminates at the robot's battery 202. The control and communication pathway, designated “C”, is configured to be bidirectional. The receiver's MCU is arranged to continuously monitor its operational status, including but not limited to received voltage, battery charge state, and temperature, and to transmit this vital information back to the transmitter's MCU as part of a robust, closed-loop control architecture. This feedback mechanism permits the charging controller 4104 to effect real-time adjustments to the transmitted power level, and further enables the cooperative monitoring by both systems for fault conditions or Foreign Object Detection (FOD) events, thereby facilitating the immediate termination of power transfer should a hazardous condition be detected. It is to be understood that in various embodiments, said communication may be achieved through a plurality of standard industrial protocols, including, for example, a Controller Area Network (CAN), the RS422 standard, RS485, RS232, I2C, Ethernet, or a dedicated wireless communication link.

The robot 1 may be configured to continuously monitor the operational status of the battery pack 202, including but not limited to received voltage, battery charge state, and temperature, and to transmit this information back to the station computing device 4350 of the docking station 3000 as part of a closed-loop control architecture. This feedback mechanism permits the charging controller 4104 to effect real-time adjustments to the transmitted power, and further enables the cooperative monitoring by both systems for fault conditions and/or foreign object detection (FOD) events, thereby facilitating the immediate termination of power transfer should a hazardous condition be detected. In various embodiments, said communication link may be achieved through alternative protocols using a shared or dedicated wireless communication link, when high-speed data offload is not needed. In some embodiments, the closed-loop control architecture may implement a multi-tiered fault response, wherein a first tier reduces the transmitted power by a predetermined percentage, a second tier de-energizes the transmitter coils while maintaining the communication link, and a third tier de-energizes the transmitter coils and issues an audible or visual alarm to alert nearby personnel.

a. Operational Environment

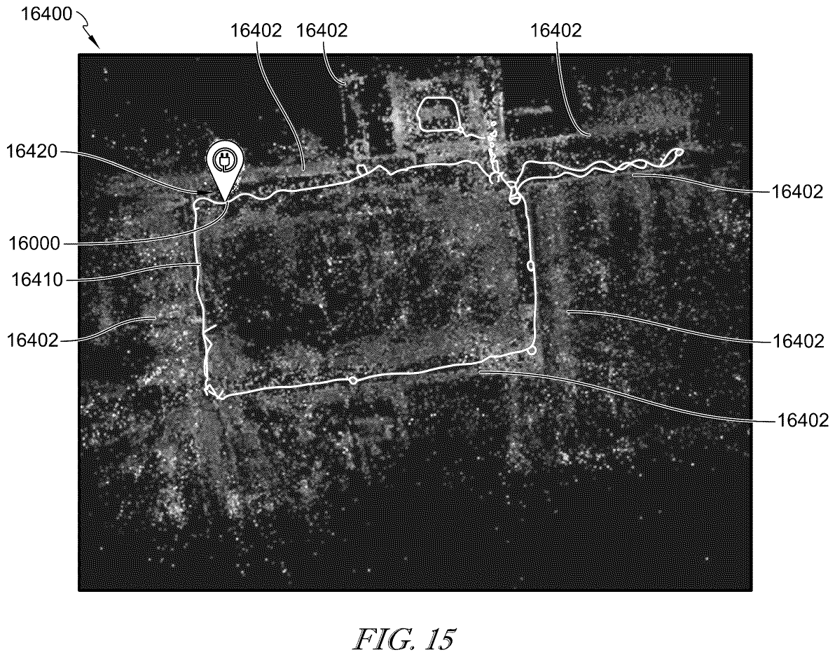

Referring now to FIG. 15, an exemplary operational environment map 16400, which has been generated by the robot 1, is shown. This map 16400 is a digital representation of the robot's physical surroundings, and it can be used by the robot 1 for the purposes of autonomous navigation and task execution. The map 16400 is constructed using a sophisticated algorithm known as Simultaneous Localization and Mapping (SLAM). This algorithm processes data from the robot's various onboard sensors (e.g., LiDAR, depth cameras, IMUs) to simultaneously build the map of the environment and to track the robot's own position within that map. The varying textures and shades that are visible in the map 16400 represent different surfaces, structures, and objects 16402 that the robot 1 has perceived and identified, such as walls, furniture, machinery, or other potential obstacles. The robot's navigation system 1370 can recalculate its path for one or more of the following reasons: (i) to maneuver around obstructions by altering its speed or direction based on new environmental data; (ii) to synchronize the movements of its legs with its manipulators or other attachments; or (iii) to prevent impacts with other objects. Further, the robot's foot placement controller 1360 is designed to avoid tripping over objects. However, if the robot 1 detects that unrecoverable loss of stability, the robot 1 shall perform an activity, motion, or maneuver that will reduce or attempt to reduce the harm to a person, object, and/or the robot 1.

A robot path or trajectory 16410 is shown overlaid on the map 16400. This path 16410 may represent the historical track of the robot's movement through the environment as it performed its assigned tasks, or it could represent a prospective path that has been planned by the robot's navigation engine 1370 for the purpose of reaching a specific goal location. The path 16410 illustrates the robot's ability to plan and execute complex movements, avoiding the mapped obstacles 16402 in order to travel from a starting point to a destination. The ability to generate and to follow such paths is a cornerstone of the robot's autonomy. In some embodiments, the path 16410 may be annotated with metadata, such as the estimated energy cost per path segment, the estimated traversal time, and the surface type (e.g., smooth concrete, carpeted floor, or ramp), which the navigation engine 1370 may use to select the most suitable trajectory based on the current operational priorities.

A key feature of the map 16400 is the charging station map icon 16420, which pinpoints the precise location of the docking station 3000. This icon 16420 serves as a persistent waypoint in the robot's memory. When the robot's internal systems detect a low battery state, or at the conclusion of a work cycle, the robot 1 can access this map 16400, identify the location of the charging station map icon 16420, and then autonomously plan and execute a path 16410 to navigate back to the docking station 3000.

In some embodiments, the path planning algorithm can calculate not just the shortest path, but the most energy-optimal trajectory. By minimizing the energy that is expended on the return trip to the charger, the robot 1 can maximize the use of its available power budget for performing its primary assigned tasks. This allows the robot 1 to continue working safely for as long as possible, which reduces the risk of a mission-interrupting power depletion before it can successfully dock and recharge. In some embodiments, the energy-optimal trajectory may account for the terrain gradient, such that the path planning algorithm prefers downhill routes over uphill routes when both routes lead to the docking station 3000, because downhill locomotion consumes less energy than uphill locomotion.

The icon 16420 itself may be initially placed on the map 16400 during a setup or commissioning procedure, or it may be automatically identified and placed by the robot 1 through object recognition of the docking station 3000. Furthermore, in some advanced implementations, the robot 1 can provide feedback to optimize the physical placement of the docking station 3000 within the environment. For example, after operating in the environment for a period of time, the robot 1 can analyze its own historical path data 16410 and its energy consumption patterns. Based on this detailed analysis, the robot 1 could identify a more optimal location for the docking station 3000, for example, a location that is more centrally located to its most frequent work areas or a location that minimizes the average return-to-charge travel time and energy expenditure. The robot 1 could then communicate this data-driven suggestion to a human operator or to a central command system, thereby enabling a more efficient and intelligent workflow for the entire robotic system.

In some embodiments, the robot 1 can act on its own analysis with an even greater degree of autonomy. For example, a robot 1 could be programmed to physically relocate the docking station 3000 itself. In such a scenario, The robot 1 could execute a complex sequence of actions wherein it can first unplug the stand's power cord from a wall outlet, grasp the docking station 3000 by its integrated handle 3330, and carefully carry the docking station 3000 to the newly identified optimal location. It would then place the docking station 3000, orient it correctly for future docking maneuvers, and use its manipulation skills to plug the power cord back into a different, more conveniently located outlet. This level of self-management and environmental configuration represents a leap forward in operational intelligence, creating a truly dynamic and self-optimizing robotic infrastructure. In some embodiments, prior to relocating the docking station 3000, the robot 1 may verify that its own battery charge level is above a predetermined relocation threshold, such that the robot 1 retains sufficient energy to complete the relocation sequence and to dock with the docking station 3000 at its new location.

In some embodiments, the docking station 3000 can be located at the robot's 1 primary work location. For example, the robot 1 may be given a task that does not involve a significant amount of walking, such as an assembly task that involves an occasional trip to another location to deliver completed assemblies and/or to retrieve more component parts. In such examples, the docking station 3000 can be located such that the robot 1 can rest upon the support cradle 3300, power down some of its motors to conserve energy, and receive charging power, all while the robot 1 is actively performing some or all of its assigned tasks. This co-located configuration may permit the robot 1 to operate in a trickle-charge mode, in which the rate of energy received from the WPT system 4000 is sufficient to offset or exceed the energy consumed by the robot's upper-body actuators during the performance of the stationary task, thereby extending the robot's operational runtime without a dedicated charging session.

### G. OPERATION OF SELF-CHARGING

A docking procedure 6200 for the robot 1 is shown in FIG. 16A-20. The docking procedure 6200 is autonomous in the illustrative embodiment such that the robot 1 is configured to (i) detect a low power state of the battery 202, (ii) navigate to the docking station 3000, (iii) dock on the docking station 3000, (iv) initiate charging of the battery 202, (v) detect when charging is complete, and (vi) undock from the docking station 3000 without human intervention. FIGS. 22A-24 serve to illustrate the specific sequence of motions and the mechanical interactions that are involved as the robot 1 autonomously docks with the docking station 3000.

The docking procedure 6200 includes: (i) a low power detection step 6202, (ii) a navigation step 6204, (iii) an initial approach step 6206, (iv) a reverse docking step 6208, (v) a cradle engagement step 6210, (vi) an alignment and seat step 6212, (vii) a confirm connection and initiate charging step 6214, (viii) a complete charge detection step 6216, and (ix) an undocking step 6218 as shown in FIG. 16A. The docking procedure begins with the low power detection step 6202, in which the robot 1 detects the battery 202 is in a low power state and needs charging. The onboard power management system of the robot 1, which may be realized as a sub-component of the main computing architecture 1000, may perform continuous monitoring of the state of charge of the internal battery 202. When the said charge level diminishes to a level that is below a predefined safety threshold, this step 6202 is triggered. This threshold is not necessarily a static value; rather, it may be a dynamically computed variable, which is calculated by the power management system based on a plurality of factors. These factors may include, but are not limited to, the robot's current distance from the docking station 3000, the calculated energy cost associated with traversing the terrain between its current location and the stand, and the anticipated power usage of its assigned task. The threshold is established to ensure that the robot 1 is in possession of sufficient energy reserves to permit the orderly cessation of its current task, the traversal of the maximum probable distance from its operational area within the environment back to the docking station 3000, and the successful completion of the entire multi-stage docking procedure without any risk of power exhaustion. In some embodiments, the robot 1 may be instructed to begin the docking procedure 6200 before the robot 1 detects the low power state of the battery 202.

Once the low power state is detected, the docking procedure 6200 moves to the navigation step 6204, in which the robot 1 navigates to the docking station 3000. Through the utilization of the stored operational environment map 16400, the current position of the robot 1 is ascertained, as is the stored location of the charging station map icon 16420. An optimal trajectory 16410 to the docking station 3000 is then computed by the navigation engine 1370. The definition of “optimal” may be context-dependent; under normal circumstances, it may signify the most energy-efficient path, whereas under a time-sensitive directive from a user or a central system, it could signify the fastest possible path. The path is calculated to be both safe, by avoiding all known static and dynamic obstacles 16402, and efficient, by minimizing any superfluous movements. The robot 1 then commences autonomous locomotion along this planned trajectory. In some embodiments, the navigation engine 1370 may re-plan the trajectory at a predetermined interval (e.g., every 0.5 seconds, every 1 second, every 2 seconds) to account for newly detected dynamic obstacles, such as moving human workers or other robots operating in the same environment.

Once the robot 1 navigates to the docking station 3000, the docking procedure 6200 begins the initial approach step 6206, in which the terminal phase of navigation to the docking station 3000 is executed. During the initial approach step 6206, the robot begins in a forward approaching state as shown in FIG. 16A. In the forward approaching state, the robot 1 faces the docking station 3000 and walks in a forward direction toward the docking station 3000. As the docking station 3000 is approached, a transition to a precision movement mode is made, which relies upon forward-facing vision sensors, e.g., the cameras 108.2.2, 108.2.4, for fine-grained visual servoing. During this phase, the robot 1 may use the distinct geometry of the docking station 3000 or a dedicated fiducial marker located thereon to achieve a sub-centimeter level of alignment. The respective fields of view, designated as FoV_{U} for the upper camera 108.2.2 and FoV_{L} for the lower camera 108.2.4, are shown encompassing the docking station 3000. A portion of the view of the docking station 3000 using the sensors 108.2.2, 108.2.4 is shown in FIG. 16B. The data that is gathered from these cameras 108.2.2, 108.2.4 allows the robot's perception system 1420 to identify the docking station 3000, to calculate its distance and orientation relative to the robot's own position, and to perform the gross-level alignment that is needed to approach it. This initial phase is about establishing the correct initial position and orientation of the robot 1 relative to the target docking station 3000.

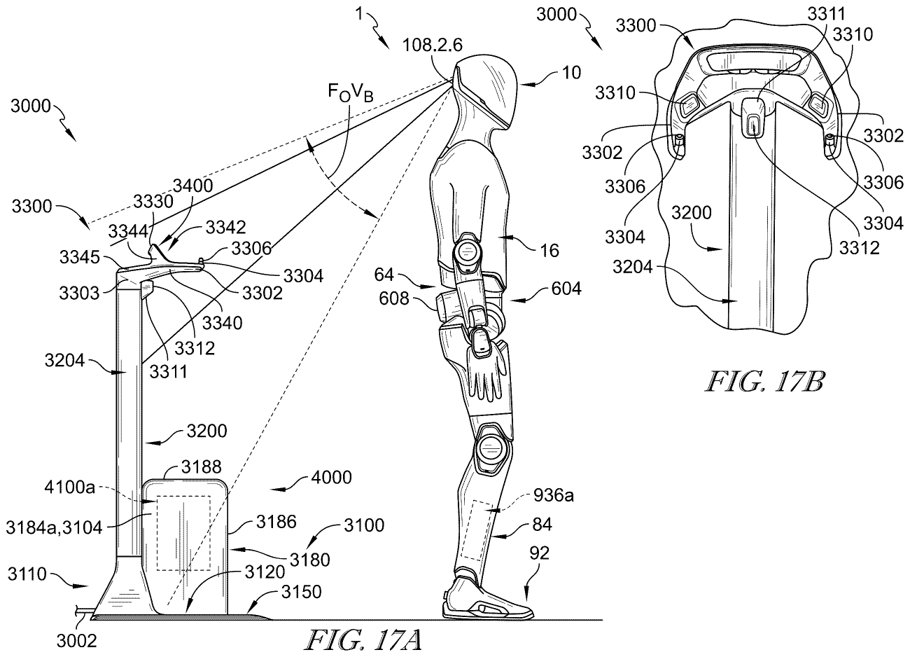

Upon reaching a predetermined close-range position relative to the docking station 3000, the robot 1 executes a controlled, 180-degree pivot turn so that the robot 1 is in a rearward approaching state as shown in FIG. 17A facing away from the docking station 3000. This maneuver positions the robot 1 for a reverse docking approach, a strategy that optimizes the use of its extensive sensor suite by dedicating the forward-facing sensors for the long-range approach and the rear-facing sensors, such as rear camera 108.2.6, for the high-precision terminal guidance phase, while positioning the robot's waist 604 for direct posterior engagement with the support cradle 3300. The respective field of view, designated as FoV_{B} for the rear camera 108.2.6, is shown encompassing the docking station 3000. A portion of the view of the docking station 3000 using the sensor 108.2.6 is shown in FIG. 17B.

Once the robot 1 is in the rearward approaching state, the docking procedure 6200 begins the reverse docking step 6208. In the reverse docking step 6208, the robot 1 walks backwards toward the docking station 3000. This delicate maneuver is guided by a fusion of data from the rear-facing camera 108.2.6 and other proximity sensors 1.2.8.12, which are used to maintain proper alignment with the support cradle 3300. The foot placement controller 1360 of the robot 1, which is informed by this stream of sensor data, precisely directs the placement of its shins 84 adjacent to the designated wireless charging surface 3104 of the charging tower 3180. This step is performed to ensure that the power receiver coils that are located within the shins 84 of the robot 1 are correctly positioned adjacent to the transmitter coils 4100a, 4100b of the docking station 3000, to maximize the inductive coupling between them.

Once the shins 84 and feet 92 of the robot 1 are securely positioned upon the base 3100, the process 6200 advances to the cradle engagement step 6210. In this step 6210, a controlled declination, or squatting motion, is executed by the coordinated actuation of the hip and knee joints of the robot 1. This action smoothly lowers the entire upper body of the robot 1 along a vertical vector, thereby bringing its waist 604 into physical contact with the inner surfaces of the support cradle 3300. This is the juncture at which the docking station 3000 commences to bear a substantial portion of the weight of the robot 1, and the control system of the robot 1 begins to receive the initial tactile feedback that confirms physical contact has been made. In some embodiments, the squatting motion may be executed at a controlled velocity that decreases as the robot 1 approaches the support cradle 3300, such that the final contact between the waist 604 and the inner surface 3303 of the support cradle 3300 occurs at a low velocity to minimize impact forces.

After engaging the support cradle 3300, the process 6200 includes the alignment and seating step 6212, in which the final seating maneuver is performed. Small, precise adjustments to the position and posture of the robot 1 are made. This is a closed-loop control process, which is guided by continuous tactile feedback from the force-torque sensor arrays located in its waist and hip joints as the alignment posts 3306 on the cradle 3300 translate into the corresponding concave recesses on its waist 604. The behavior controller 1350 seeks to nullify any detected shear forces, an action which would indicate a sufficient vertical seating of the components. This final mechanical interlocking provides a positive, unambiguous confirmation of correct positioning, ensuring that the robot 1 is both stably seated and that the receiver coil assemblies 936a, 936b in the shins 84 are in close proximity to the transmitter coil assemblies 4100a, 4100b in the charging tower 3180.

FIG. 18-19 shows a side view of the robot 1 in the final, fully docked state. In this state, the robot's feet 92 are positioned squarely on the base 3100 of the docking station 3000, the robot's shins 84 flank the charging tower 3180, and its waist 604 is securely seated in and supported by the support cradle 3300. Notably, the robot's legs 6 are shown in a slightly bent or “squatted” posture, which is indicated by the articulation of the knee actuator housing 820. This is not merely a passive slumping motion but is rather a controlled maneuver where the robot 1 actively settles its weight onto the cradle 3300, an action which simultaneously lowers its overall center of gravity to further enhance its already stable docked state. This relaxed posture is made possible because the robot's weight is being partially, if not mostly, supported by the docking station 3000. This support effectively offloads the energetically demanding task of active balancing from the robot's own systems.

Upon engagement of the robot's waist 604 with the support cradle 3300, the humanoid robot 1 may reduce power consumption by de-energizing or reducing power to one or more leg actuators in the knee 820, hip 70, or ankle regions without any risk of losing stability. For a bipedal robot such as the robot 1, maintaining balance while standing still demands constant, subtle actuations and corrections from its motors. This represents a continuous parasitic power drain even when the robot is not performing any other task. By mechanically supporting the robot 1, the docking station 3000 reduces or effectively eliminates this significant power drain. This reduction in power consumption has a direct and highly beneficial impact on the recharging efficiency and speed. Since the incoming power that is supplied by the wireless charger is not being diverted to power the balancing actuators, nearly the full power stream can be dedicated to replenishing the battery cells. This significantly shortens the time that is needed for the robot 1 to reach a full charge, which in turn increases its operational availability and overall productivity. Furthermore, by allowing the actuators to rest in a de-energized state during the charging periods, the docking station 3000 also reduces the cumulative mechanical stress and wear on these components. This can lead to a longer operational lifespan and lower maintenance requirements for the robot 1 over time.

In some embodiments, the robot 1 can include clutches or brakes that can controllably lock various actuators to allow the robot 1 to maintain a predetermined posture without the active use and subsequent power consumption of the locked actuators once in the docked state. For example, the robot 1 can be configured to maneuver into the docked state and then lock actuators in the knees, ankles, and pelvis. Such a configuration would allow the robot 1 to power down the knees, pelvis, and ankle actuators during recharging at the docking station 3000. In some embodiments, the clutches may be electro-mechanical clutches that engage upon loss of power, such that if the robot 1 experiences an unexpected power loss while docked, the clutches engage and lock the actuators in their current position, providing an additional measure of stability.

After the robot is in the docked state, the robot 1 may begin the confirm connection and initiate charging step 6214. The confirm connection and initiate charging step 6214 may include a multi-step detection and verification process before enabling power flow, ensuring a safe and precise physical connection between the wireless power transmitter 4020 in the docking station 3000 and the wireless power receiver system 212.6 in the shins 84 of the robot 1. A digital communication signal, often referred to as a “handshake,” is transmitted from the robot 1 to the docking station 3000 to confirm its state of readiness to receive power. This signal may be transmitted via a low-power wireless protocol such as NFC or Bluetooth LE. In response thereto, the docking station 3000 energizes its wireless power transmitter coils, which are located in the base 3100. The power management system of the robot 1 then verifies the receipt of an incoming charge and subsequently transitions the robot 1 into a low-power or standby state in order to conserve energy and to expedite the recharging process by de-energizing non-essential systems, most notably the power-intensive actuators used for active balancing.

Contemporaneously with the initiation of the power transfer, the thermal management systems (e.g., heat spreaders 4166, thermal conductors 4170, etc.) of the docking station 3000 may be activated. Simultaneously, the access opening 3320 in the support cradle 3300 may be aligned with the perforated vent panels on the waist 604 of the robot 1, providing an unobstructed conduit for air to be drawn into its own internal torso cooling system. This synergistic thermal management methodology, which leverages features of both the docking station 3000 and the robot 1, is useful for the efficient dissipation of waste heat. This cooperative cooling approach enables the system to support higher charging rates without exceeding the thermal operational limits of the battery 202 or its associated sensitive electronic components.

In some embodiments, the initiation of charging can also activate the active cooling system 5000 within the docking station 3000, such as internal fans 5100a, 5100b, in an intelligently controlled process. The activation of the active cooling system 5000 may be triggered by the digital handshake protocol that is initiated in step 6214, wherein the robot 1 can communicate its current thermal state and can request a specific charging profile, such as a standard charge or a rapid charge. The control system of the docking station 3000 can then activate the cooling systems in a manner that is proportional to the requested power draw. Alternatively, the activation of the cooling systems can be predicated on data from thermal sensors that are integrated within the docking station 3000 itself, which constantly monitor the temperature of the charging coils and power electronics. Upon detecting a temperature that exceeds a predetermined operational threshold, the active cooling systems would be engaged to maintain a safe operating temperature for all components.

The enhancement to the recharging process that is afforded by such active cooling is substantial. A primary limiting factor in the speed of battery recharging is the generation of waste heat. excessive temperatures can cause irreversible damage to battery cells and will prompt the robot's battery management system to thermally throttle, or reduce, the charging current to prevent such damage from occurring. By removing this waste heat at its source, the active cooling systems of the docking station 3000 ensure that the battery 202 remains within its optimal thermal operating window for a longer duration. This prevents thermal throttling and permits the system to sustain a maximal charging current for a longer period of time, which in turn can significantly reduce the total time that is required to achieve a full charge. This ultimately maximizes the operational availability and the overall productivity of the robot 1. Furthermore, by mitigating thermal stress on the components, the system can contribute to the increased longevity of the battery 202 and its associated electronic components.

The charging process persists until the complete charge detection step 6216 is met. The battery management system of the robot 1 continuously monitors the state of charge, voltage, and temperature of the battery cells. When the battery 202 has reached its full capacity, a signal is transmitted from the management system to the docking station 3000, instructing it to terminate the power transfer. The docking station 3000 then de-energizes its transmitter coils, and the charging cycle is thereby concluded. Finally, the docking procedure 6200 then begins the undocking step 6218 in which the robot 1 is prepared for its return to service. Upon the receipt of a command from a central command center 2750A-X, an instruction from a human user, or in accordance with a pre-programmed operational schedule, the robot 1 exits its low-power state and performs a full power-on self-test to energize and verify all of its operational systems. In some embodiments, the undocking step 6218 may be triggered by an event-based condition rather than a full charge condition, such as the receipt of a high-priority task from the central command center 2750A-X, even if the battery 202 has not yet reached full capacity, provided that the state of charge is above a minimum dispatch threshold.

The disengagement process is executed as a substantive and precise reversal of the docking motions, comprising a plurality of coordinated sub-routines. The initial sub-routine involves a pure vertical translation to disengage the robot 1 from the mechanical interlock of the docking station 3000. To achieve this, the robot 1 actuates its hip and knee joints in a coordinated manner to smoothly transition from the rested, squatting posture to a fully erect stance. This motion is controlled by the whole body controller 1550 to generate a smooth, substantially vertical trajectory, so as to prevent any binding or jamming of the alignment posts 3306 within the corresponding concave recesses 604.6.2. As this vertical motion proceeds, the whole body controller 1550 monitors the progressive transfer of the apparatus's full weight from the support cradle 3300 back onto its own leg assemblies 6, using continuous feedback from force-torque sensors 1.2.8.2 to ensure a controlled and stable load transfer. The motion is considered complete when the waist 604 is lifted fully clear of the support cradle 3300 and the alignment posts 3306 are fully disengaged.

A second sub-routine is then executed to verify the robot's postural stability before any locomotion is attempted. With the full weight of the robot 1 now being supported exclusively by its own leg assemblies 6, a stability confirmation sequence is initiated by the whole body controller 1550. This sequence is a safety interlock. The controller analyzes a high-frequency stream of data from multiple sensor systems, including the inertial measurement units (IMUs) 1.2.8.4 to ascertain the robot's angular velocity and orientation, and the force-torque sensors 1.2.8.2 located in the feet 92 to determine the precise center of pressure of the ground reaction forces. The controller's balance algorithm compares this real-time data against a dynamic stability model, and it will not permit any forward motion until all metrics, such as body sway and center of mass deviation, are within predefined, safe tolerances. This ensures that the robot 1 will not attempt to walk while it is in an unstable condition.

Upon confirmation of a stable posture, a third sub-routine for egress is executed. The robot 1 subsequently commences forward ambulation, with the foot placement controller 1360 executing the initial, carefully planned steps to move its feet 92 off the base 3100 and clear of the immediate area of the docking station 3000. The planner 1302 ensures this initial egress path is free of any obstacles, utilizing data from the forward-facing vision sensors 1.2.8.6. Once the robot 1 is physically clear of the docking station 3000, it transitions to a fully operational state, with all its perceptual, planning, and actuation systems active, thereby rendering it prepared to receive and execute its next assigned task. In some embodiments, the third sub-routine may include a post-undocking diagnostic step in which the robot 1 verifies the responsiveness and calibration of its joint actuators and sensors before committing to a full-speed gait, so as to detect any anomalies that may have arisen during the idle charging period.

### H. ALTERNATIVE EMBODIMENTS

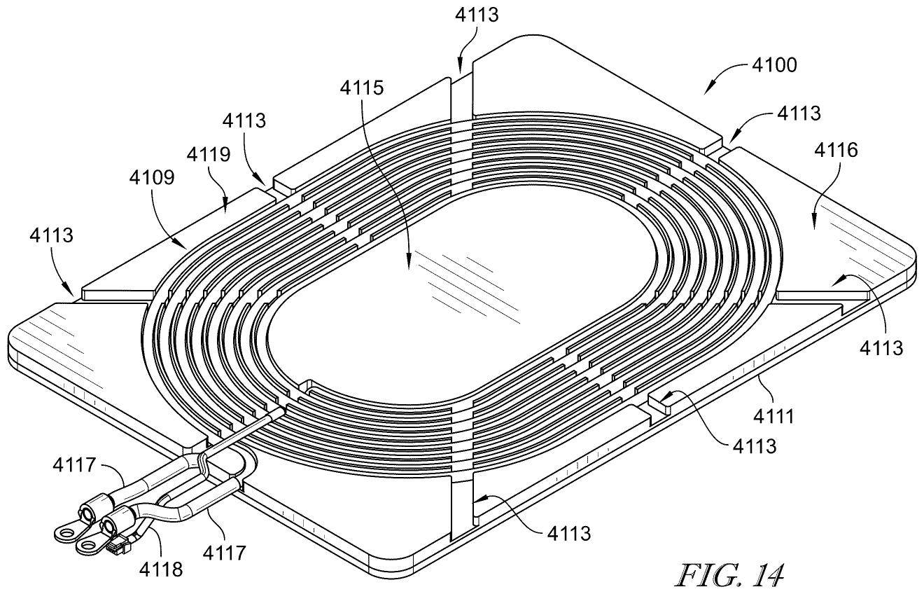

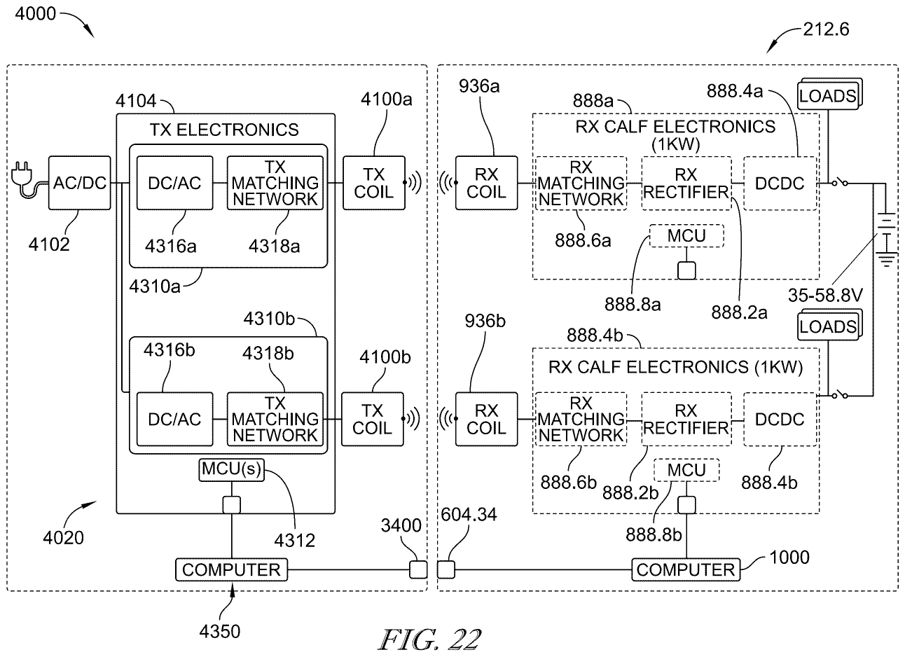

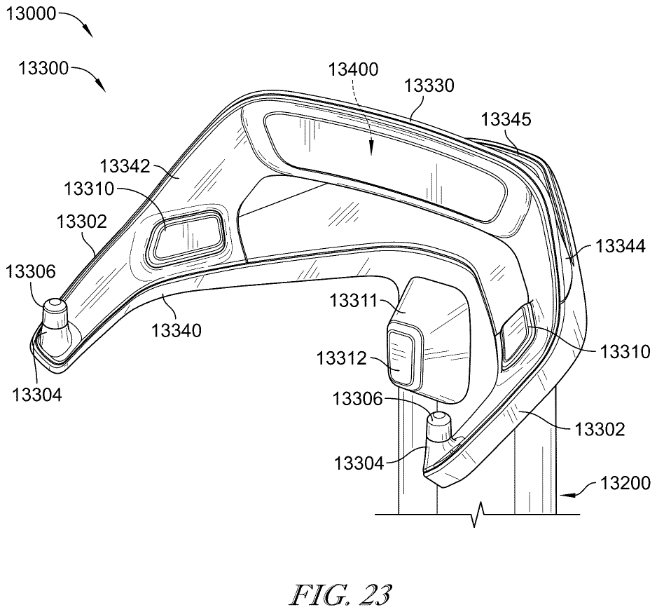

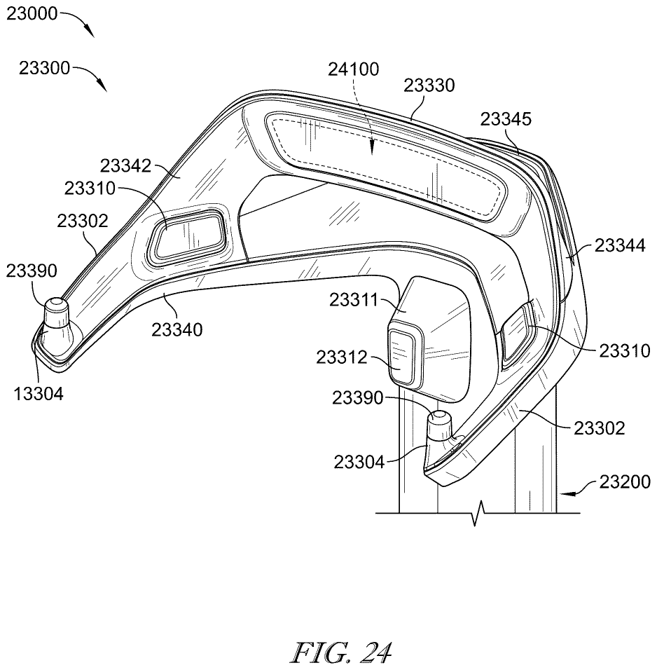

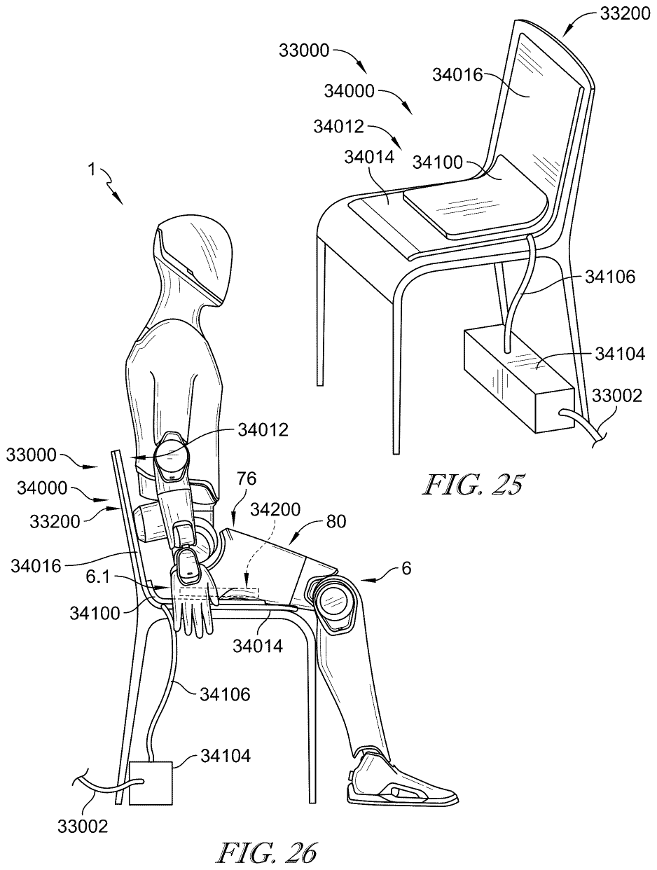

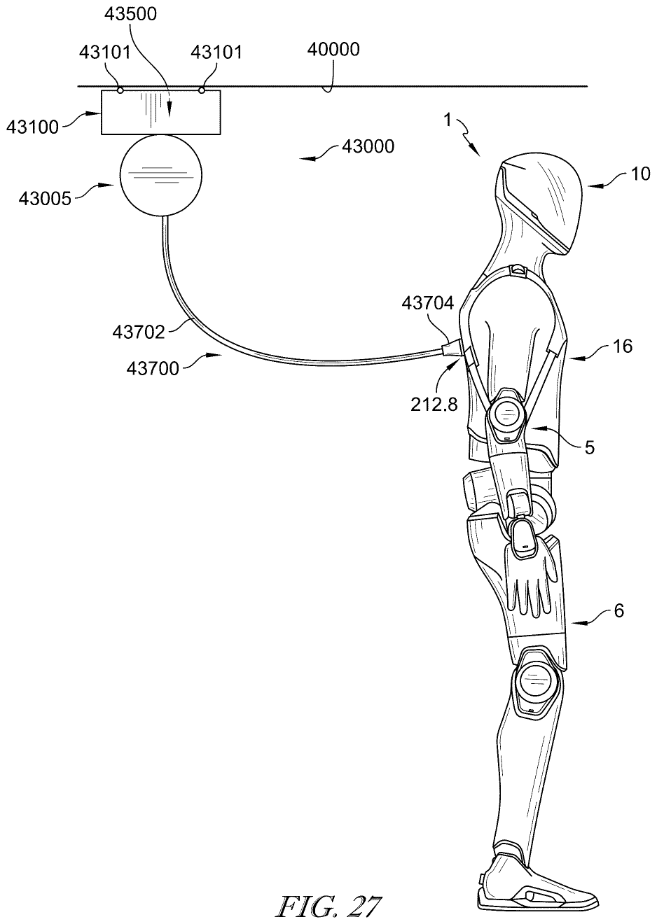

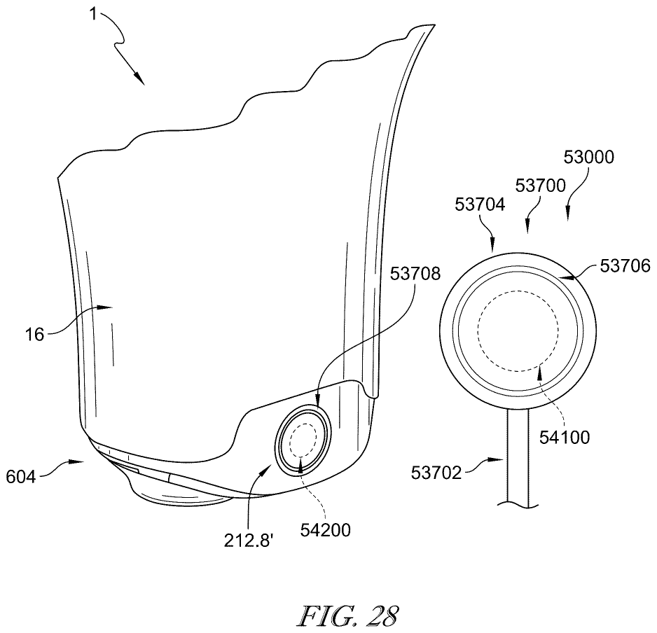

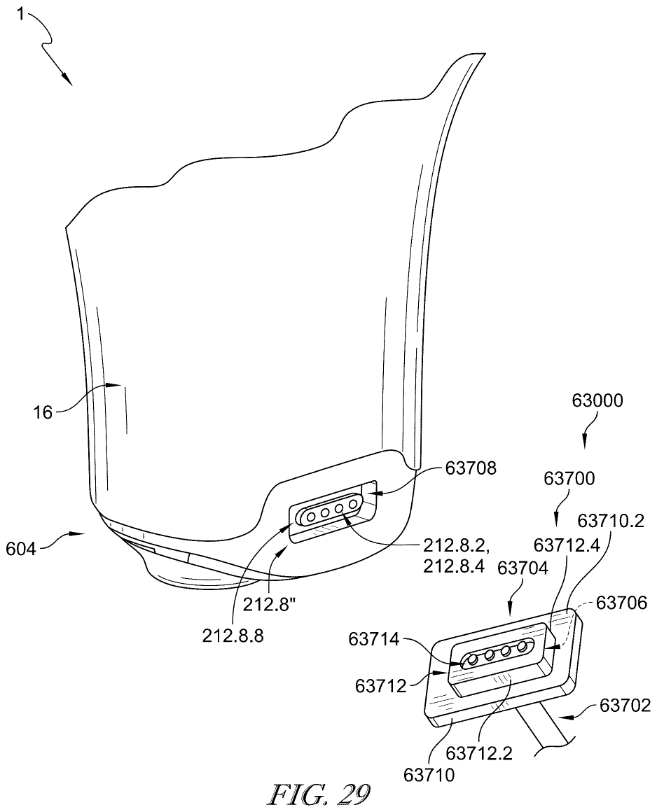

FIGS. 14-20 show a first embodiment of the docking station 3000 as discussed above. FIG. 23 shows a second embodiment of a docking station 13000. FIG. 24 shows a third embodiment of a docking station 23000. FIGS. 25 and 26 show a fourth embodiment of a docking station 33000. FIG. 27 shows a fifth embodiment of a docking station 43000. FIG. 28 shows a sixth embodiment of a docking station 53000. FIG. 29 shows a seventh embodiment of a docking station 63000. It should be understood that any aspect of any docking station or robot described herein can be included and/or omitted from any other docking station or robot.

a. Second Embodiment of a Docking Station

Similar to the docking station 3000 as described above, FIG. 23 illustrates an alternative embodiment of a docking station 13000 configured to provide direct-contact charging for the robot 1. The docking station 13000 includes a support stand 13200 with a charging cradle 13300. For the sake of brevity, the detailed disclosure regarding the shared structural elements and operational modes of the docking station 3000 will not be repeated below, but it should be understood that across these embodiments, like numbers represent like structures. For example, the disclosure relating to the form and function of the support cradle 3300 applies with equal force to the charging cradle 13300. Furthermore, it is to be understood that any one or more features of the docking station 3000 can be used in conjunction with those disclosed regarding the conductive docking station 13000, and vice-versa, creating hybrid implementations.

The charging cradle 13300 of this embodiment differs from the support cradle 3300 in its method of power delivery. Each cradle arm 13302 terminates in a charging post base 13304, from which a vertical charging post 13306 extends upward. Whereas the docking station 3000 is configured to provide charging power wirelessly through the WPT system 4000 located in the base 3100, the docking station 13000 is configured to provide high-current AC or DC charging power directly to the robot 1 through these charging posts 13306 of the charging cradle 13300. The charging posts 13306 are connected to a power supply unit and a charging controller that may be housed within the support stand 13200 or within the base of the docking station 13000.

The charging posts 13306 are engineered for high durability and electrical efficiency. They may be fabricated from a core of hardened steel alloy to ensure maximal durability and resistance to mechanical wear and deformation from repeated docking impacts. This core can then be clad or plated with highly conductive and corrosion-resistant materials such as copper, silver, or gold to ensure maximal, low-resistance current flow capability. The charging posts 13306 are precisely shaped to engage with corresponding concave recesses in the waist 604 of the robot 1. These recesses on the robot 1 are configured with corresponding electrical contacts, which may be designed as an array of spring-loaded, self-wiping pins. This design ensures a reliable, low-impedance connection upon engagement, as the sliding action of the pins against the post contacts serves to clear away minor debris or surface oxidation, which facilitates maintaining safety and efficiency in high-power DC transfer. These contacts are electrically connected to a power and control/communication (P_{C}) module 888 to facilitate the direct charging of the battery 202.

In some embodiments, the charging posts 13306 can be used as the primary or sole method of charging, replacing the charging tower 3180. This configuration is particularly advantageous when the robot 1 is assigned to work in an environment that is hostile to having high-power electrical systems arranged close to the ground, such as food processing facilities requiring frequent high-pressure washdowns or outdoor sites with wet and muddy conditions. In such situations, providing the charging interface at an elevated position on the cradle, far from ground-level contaminants, provides more reliable, safer, and higher throughput charging than a ground-based wireless system might provide. In some embodiments, the charging posts 13306 may further include integrated sealing gaskets, such as elastomeric O-rings, around the base of each post to prevent the ingress of moisture or particulate matter into the electrical contact surfaces when the robot 1 is docked.

In other embodiments, the charging posts 13306 can be used in conjunction with the wireless charging tower 3180 to create a redundant or parallel charging system. For example, the robot's battery management system can be configured to draw power from the charging tower 3180 wirelessly while simultaneously receiving power from the charging posts 13306. Such a parallel configuration, managed by a sophisticated power-sharing controller, can substantially increase the total rate of power transfer to the robot 1. This dual-input method can significantly decrease the amount of time needed to recharge the battery 202, thereby increasing the robot's operational uptime and overall productivity. This redundancy also enhances system robustness; if one charging method is unavailable or compromised, the other can still provide power.

In some embodiments, the charging posts 13306 can be configured to provide both power and high-bandwidth data communications to the robot. For example, the posts and their corresponding contacts can be designed with separate, dedicated pins to provide parallel power and communication busses, such as multi-gigabit Ethernet, between the docking station 13000 and the robot 1. This allows for the rapid offloading of large sensor data logs or the uploading of new AI models while the robot is charging. In another example, the charging posts 13306 can be configured to provide powerline communications (PLC) between the docking station 13000 and the robot, in which a high-frequency communication signal is modulated on top of the DC charging power signal, reducing the complexity of the physical connector.

Furthermore, in some embodiments, the charging posts 13306 can be leveraged to enhance data security. For example, by using hardwired communications (e.g., Ethernet or PLC) in cooperation with the wireless data transceiver 3400, a hybrid communication protocol can be implemented. In this protocol, a data stream is algorithmically split, with sensitive command-and-control packets transmitted through the secure wired connection and less sensitive telemetry data transmitted wirelessly. As such, any wireless data that might be intercepted would be incomplete and substantially immune to eavesdropping. In highly secure environments, such as defense or sensitive research facilities where all RF emissions are prohibited, the charging posts 13306 can be used in place of wireless communications entirely, creating a secure, “air-gapped” data interface.

As shown in FIG. 23, the support cradle 13300 has a main cradle body 13301 that supports the two outwardly extending cradle arms 13302. The support cradle 13300 includes a lower shell 13340, a cradle shell 13342, a rear shell 13344, and a tail shell 13345. The inner surface 13303 of the cradle 13300 is contoured to substantially match the complex three-dimensional geometry of the robot's waist 604. The cradle arms 13302 are defined by the lower shell 13340 and the cradle shell 13342. The cradle arms 13302 extend symmetrically from the main cradle body 13301 and are formed with a curved shape to reduce point loads between the cradle arms 13302 and the vertical support portion 13204, thereby increasing the strength of the cradle arms 13302. Each cradle arm 13302 terminates in a respective alignment post base 13304, from which a vertical alignment post 13306 extends upward. Side gripper pads 13310, which may be made from a durable elastomer such as polyurethane with a specified durometer measurement, are positioned on the inner surface of the cradle arms 13302 on support posts 13311, in order to provide a soft, high-friction contact point, thereby helping to prevent any slippage without marring the exterior surface finish of the robot 1. A rear support pad 13312 is positioned centrally on the cradle in order to provide stable, anti-rotational support to the back of the robot's waist 604.

b. Third Embodiment of a Docking Station

Similar to the docking station 3000 as described above, FIG. 24 illustrates an alternative embodiment of a docking station 23000 configured to provide charging for the robot 1. The docking station 23000 of this embodiment re-envisions the power and data interface by relocating the primary wireless power transfer system 4000 to the waist level, offering distinct operational advantages for specific use cases. The docking station 23000 separates the mechanical support function from the power delivery function, and further separates the power delivery function from the data communication function, enabling each function to be optimized for its specific operational parameters.

The docking station 23000 includes a support stand 23200 with a charging cradle 23300. For the sake of brevity, the detailed disclosure regarding the shared structural elements and operational modes of the docking station 3000 will not be repeated below, but it should be understood that across these embodiments, like numbers represent like structures. For example, the disclosure relating to the form and function of the support cradle 3300 applies with equal force to the charging cradle 23300. Furthermore, it is to be understood that any one or more features of the docking station 3000 can be used in conjunction with those disclosed regarding the docking station 23000, and vice-versa, creating hybrid implementations.

The charging cradle 23300 differs from the support cradle 3300 in its integrated functionalities, effectively separating the power and data transfer mechanisms. Each cradle arm 23302 terminates in a communication post base 23304, from which a vertical communication post 23390 extends upward. Concurrently, a large transmitter coil 24100 is arranged within the main body of the charging cradle 23300, for instance, in place of the high-bandwidth wireless data transceiver 3400. Whereas the primary docking station 3000 is configured to provide charging power through the WPT system 4000 in the base 3100, this docking station 23000 is configured to provide charging power to the robot 1 through the waist-level transmitter coil 24100, while dedicated, hardwired communications are provided to the robot 1 through the communication posts 23390. This decoupling allows each system to be optimized for its specific function. The charging controller 200 on the robot 1 receives the AC power induced in the corresponding receiver coil in the waist region 604, and the rectifier stage 200a converts the induced AC to rectified DC, which the DC-to-DC converter stage 200b then regulates to the appropriate voltage and current for charging the battery pack 202.

The communication posts 23390 are robust mechanical and electrical interfaces. They may be fabricated from a core of hardened steel alloy to ensure maximal durability and resistance to wear from repeated docking cycles, and then plated with highly conductive, low-corrosion materials like gold or a silver alloy to ensure maximal signal fidelity for high-speed data. The communication posts 23390 are precisely shaped to engage with corresponding concave recesses in the waist 604 of the robot 1. These recesses house corresponding electrical contacts that are electrically connected to the robot's wired communication interface, which is communicatively coupled to the compute 210. This physical link is engineered to facilitate hardwired, high-bandwidth communication, such as multi-gigabit Ethernet, between the robot 1 and the docking station 23000, enabling rapid data offloading or firmware updates. Upon establishing the hardwired link, the compute 210 may initiate a charging handshake protocol in which it transmits the state of charge of the battery pack 202, the temperature of the battery pack 202, and any pending fault information to the docking station 23000, and receives in return a negotiated charging power level and schedule.

In some embodiments, the waist-level transmitter coil 24100 can be used as the sole means of power transfer, completely replacing the charging tower 3180. This configuration is particularly advantageous when the robot 1 must operate in environments that are hostile to ground-level electrical systems. As such, an elevated charging interface mitigates risks of short-circuiting, corrosion, and electrical shock. In such situations, providing charging at an elevated position, integrated into the mechanical support cradle, provides a more reliable, safer, and potentially higher throughput charging solution than the ground-based charging tower 3180 might offer. In some embodiments, the waist-level transmitter coil 24100 may be a larger diameter coil than the transmitter coil assemblies 4100a, 4100b in the charging tower 3180, thereby providing a greater tolerance for positional misalignment and a more uniform magnetic field over the receiver coil surface area in the robot's waist region.

In other embodiments, the transmitter coil 24100 can be used in conjunction with the ground-level charging tower 3180 to create a powerful parallel charging system. For example, the robot 1 can be configured with receiver coils in both its shins and its lower back, allowing it to receive power from the charging tower 3180 wirelessly while simultaneously receiving power from the transmitter coil 24100 at its waist. Such a parallel configuration, managed by the robot's battery management system to balance the load from both sources, can dramatically increase the total rate of power transfer to the robot 1. This dual-source approach can significantly decrease the amount of time needed to fully recharge the battery 202, a factor in high-throughput applications where robot uptime is paramount.

In yet other embodiments, the transmitter coil 24100 can be configured to provide both power and communications to the robot, eliminating the need for the physical communication posts. For example, the transmitter coil 24100 can be configured to provide power and in-band communication signals, wherein data is modulated onto the power-carrying magnetic field using techniques like load modulation or frequency-shift keying. This would occur between the docking station 23000 and the robot 1, simplifying the mechanical interface while still providing a channel for the essential charging control handshake and status monitoring.

Furthermore, in some embodiments, the hardwired communication posts 23390 can be used specifically to enhance data security. By using a physical, hardwired connection, the potential for wireless eavesdropping on communications between the robot 1 and the docking station 23000 can be greatly reduced. This creates a physically secure, “air-gapped” data link when the robot is docked, which can be a requirement in environments where sensitive or proprietary data is being handled, such as in defense, finance, or corporate research facilities. This provides a level of security that even heavily encrypted wireless communication cannot guarantee.

As shown in FIG. 24, the support cradle 23300 has a main cradle body 23301 that supports the two outwardly extending cradle arms 23302. The support cradle 23300 includes a lower shell 23340, a cradle shell 23342, a rear shell 23344, and a tail shell 23345. The inner surface 23303 of the cradle 23300 is contoured to substantially match the complex three-dimensional geometry of the robot's waist 604. The cradle arms 23302 are defined by the lower shell 23340 and the cradle shell 23342. The cradle arms 23302 extend symmetrically from the main cradle body 23301 and are formed with a curved shape to reduce point loads between the cradle arms 23302 and the vertical support portion 23204, thereby increasing the strength of the cradle arms 23302. Each cradle arm 23302 terminates in a respective alignment post base 23304, from which a vertical alignment post 23306 extends upward. Side gripper pads 23310, which may be made from a durable elastomer such as polyurethane with a specified durometer measurement, are positioned on the inner surface of the cradle arms 23302 on support posts 23311, in order to provide a soft, high-friction contact point, thereby helping to prevent any slippage without marring the exterior surface finish of the robot 1. A rear support pad 23312 is positioned centrally on the cradle in order to provide stable, anti-rotational support to the back of the robot's waist 604.

c. Fourth Embodiment of a Docking Station

Similar to the docking station 3000 as described above, FIGS. 25 and 26 illustrate an alternative embodiment of a docking station 33000 configured to provide opportunistic charging while the robot 1 is seated. The docking station 33000 includes a support structure 33200 with a wireless power transfer system 34000. For sake of brevity, the above disclosure in connection with the docking station 3000 will not be repeated below, but it should be understood that across embodiments like numbers represent like structures. For example, the disclosure relating to the principles of the WPT system 4000 applies in equal force to WPT system 34000. Further, it should be understood that the operational modes of the docking station 33000 are similar to, or identical to, those disclosed regarding docking station 3000. Moreover, it is to be understood that any one or more features of the docking station 3000 can be used in conjunction with those disclosed regarding the docking station 33000, and that any one or more features of docking station 33000 can be used in conjunction with those disclosed regarding the docking station 3000.

In general, the WPT system 34000 includes a power transmitter 34020 that is configured as a versatile mat, pad, or slip cover that can be laid upon, stretched across, or otherwise assembled to the support structure 33200, which may be a chair, a bench, a seat (e.g., a vehicle driver's seat), a stool, or any other appropriate form of seating furniture. This adaptability allows for the easy deployment of charging infrastructure into existing human-centric environments without requiring extensive modification. In some embodiments, the support structure 33200 can be purpose-built, with the WPT system 34000 fully integrated into its structure for a seamless and robust implementation. In other embodiments, the support structure 33200 can be retrofitted, allowing for the rapid conversion of conventional furniture or vehicle seats into robotic charging points.

The WPT system 34000 includes a mat 34012 (e.g., base, backing) that includes a seat portion 34014 and a backrest portion 34016, and one or more transmitter coils 34100. The mat 34012, which may be constructed from a durable, non-slip, and flexible polymer composite, is configured to stabilize the position of the transmitter coils 34100 relative to the support structure 33200. This ensures the transmitter coils 34100 are arranged in a predetermined location on the support structure 33200, such as the seat or the backrest portion of the support structure 33200, that substantially aligns with a predetermined region of the robot 1, such as the lower back, posterior, or upper thighs. The mat 34012 may further incorporate an array of pressure sensors to detect the presence and orientation of the robot 1, enabling the docking station 33000 to activate only when the robot 1 is properly seated, thus conserving energy and enhancing safety. In some embodiments, either the seat portion 34014 or the backrest portion 34016 can be omitted from the mat 34012, depending on the specific application and the location of the receiver coils 34200 on the robot 1.

Power and/or control of the transmitter coils 34100 is provided by a charging controller 34104. The charging controller 34104 is tethered to the transmitter coils 34100 by a power and communications cable 44106. Power to the charging controller 34104 is provided through a power cord 43002. The charging controller 34104 is housed in a separate, and in some embodiments ventilated, enclosure that can be located away from the transmitter coils 34100 (e.g., mounted to an underside or backside of the support structure 33200, placed on the floor under the support structure 33200). This separation enhances thermal management, as it isolates the heat-generating charging controller 34104 from the transmitter coils 34100 and the robot 1, preventing thermal buildup. In some implementations, the charging controller 34104 can be networked and configured to control multiple sets of transmitter coils 34100, creating a smart charging grid. For example, a single controller could manage a row of charging seats in a factory, a collection of seats on a transport vehicle, or both the driver and passenger seats in an autonomous vehicle, optimizing power distribution across the fleet.

The robot 1 is configured with one or more receiver coils 34200 integrated into a rear extent of its body on one of the upper leg assembly 6.1, the pelvis 64 or waist 604, and/or a lower extent of the torso 16. In the illustrative embodiment, the one or more receiver coils 34200 are integrated into the upper leg assembly 6.1 (e.g., the upper thigh 76 or the lower thigh 80). The WPT system 34000 is configured such that when the robot 1 executes a sitting maneuver on the support structure 33200, the transmitter coils 34100 are brought into substantial alignment with the receiver coils 34200. With the robot 1 in this seated configuration, the proximity and alignment of the transmitter coils 34100 are sufficient to facilitate efficient wireless power transfer. The robot's charging controller 200 converts the induced AC in the receiver coils 34200 via the rectifier stage 200a and regulates the output via the DC-to-DC converter stage 200b for delivery to the battery pack 202.

The seated configuration of the robot 1 significantly enhances the recharging of the battery 202. For example, many of the robot's 1 tasks can be configured to be performed while seated, such as a partly or mostly stationary assembly process at a workbench. While seated, the robot 1 may not need to consume as much power through the operation of the actuators in the legs 6. By offloading the robot's entire weight onto the support structure 33200, the significant power consumed by the leg and core actuators for active balancing, which can be a substantial portion of the robot's idle power draw, is dramatically reduced. This decrease in the robot's own power consumption results in a much higher net charging rate, allowing the battery 202 to be replenished more quickly and efficiently.

This seated configuration also enables a powerful strategy of opportunistic charging, which can enhance and extend the operational runtime of the robot 1, often eliminating the need for dedicated, non-productive charging sessions at a central station like the docking station 3000. This capability transforms periods of relative inactivity, or even periods of active but stationary work, into productive charging opportunities, thereby maximizing the robot's operational availability and autonomy. For example, a significant part of the robot's 1 tasks may include driving an industrial vehicle like a forklift or an autonomous delivery truck. In such situations, the WPT system 34000, integrated into the vehicle's seat, can be used to charge the robot 1 while it is seated as a driver or passenger. Even short, intermittent periods of charging, while waiting for a load, during transit, or while supervising an automated process, can accumulate over a work shift, effectively “topping off” the battery and extending the mission duration. In some embodiments, the robot's power management system may maintain a log of opportunistic charging events and their cumulative energy contributions, and may use this log to refine the dynamic low-power threshold in step 6202 of the docking procedure 6200, thereby delaying the need for a full charging session at the primary docking station 3000.

d. Fifth Embodiment of a Docking Station

Similar to the docking station 3000 as described above, FIG. 27 illustrates an alternative embodiment of a docking station 43000 configured to provide opportunistic charging for the robot 1. In the illustrated example, the docking station 43000 includes: (i) a base 43100, (ii) a retractor assembly 43005, and (iii) a cable or cord assembly 43700. The base 43100 is configured to be mounted overhead of the robot 1, such as on a ceiling, a gantry, or any other appropriate overhead structure and houses a station electronics assembly 43500. The cable assembly 43700 is a flexible multiconductor electrical cable assembly configured to conduct charging power and provide an electrical ground from the base 43100 to the robot 1. The retractor assembly 43005 allows the cable assembly 43700 to be extended or retracted from the robot 1 to the base 43100. The cable assembly 43700 is terminated by a magnetic connector 43704. The magnetic connector 43704 is configured to removably (e.g., magnetically) attach to a corresponding magnetic receptacle 212.8 arranged on the robot 1.

i. Base

The base 43100 includes a base housing 43150 that houses the station electronics assembly 43500 (e.g., a station computing device, a communications transceiver, etc.) as shown in FIG. 27. The base 43100 may also house a power supply unit 44102 and/or a charging controller 44104. The power supply unit 44102 receives AC mains power and converts it to a regulated DC bus voltage suitable for driving the transmitter electronics or for direct conductive delivery through the cable assembly 43700. The charging controller 44104 communicates with the compute 210 on the robot 1 to negotiate charging parameters including target voltage, maximum current, and charging phase (constant-current or constant-voltage). As shown in FIG. 27, the base 43100 may be mounted on tracks or rails 40000 positioned above the robot 1 (e.g., on a ceiling, a gantry, or any other appropriate overhead structure). The tracks or rails 40000 are configured to allow the docking station 43000 to move along the ceiling, gantry, or other overhead structure. In this way, the docking station 43000 may move with the robot 1. The base 43100 may have wheels, rollers, or corresponding tracks that mate with the tracks 40000 to allow the docking station 43000 to move along the ceiling, gantry, or other overhead structure. The movement of the base 43100 along the tracks 40000 may be passive (e.g., pulled by the robot 1 via the cord assembly 43700) or active (e.g., driven by a motor in response to position signals from the robot 1).

ii. Retractor Assembly

The retractor assembly 43005 is coupled to the base 43100 as shown in FIG. 27. The retractor assembly 43005 is configured to extend and retract the cable 43702 as the robot 1 moves. In some embodiments, the retractor assembly 43005 can be configured to provide a length of the cable 43702 that is sufficient to allow the robot 1 to reach nearby destinations while remaining coupled to the docking station 43000, while also preventing the cable 43702 from accumulating excess slack that might cause the cable 43702 to droop and become a tripping or entanglement hazard for the robot 1 or humans. The retractor assembly 43005 may include a spring-loaded spool mechanism, or a motorized spool with a tension sensor, that maintains a predetermined tension on the cable 43702 to prevent the cable 43702 from sagging below a minimum clearance height above the floor surface. In some embodiments, the retractor assembly 43005 includes an encoder or rotational sensor on the spool to measure the deployed length of the cable 43702, and the base 43100 communicates this deployed length to the compute 210 on the robot 1, enabling the robot 1 to calculate the boundaries of the working area in which the robot 1 can remain tethered.

iii. Cable Assembly

The cable assembly 43700 includes: (i) a cable 43702 and (ii) a magnetic connector or coupler 43704 as shown in FIG. 27. The cable 43702 is a flexible multi-conductor assembly configured to conduct charging power and provide an electrical ground from the base 43100 to the robot 1. The cable 43702 also includes one or more electrical conductors configured to provide data communication between the base 43100 and the robot 1. In some embodiments, the base 43100 and the cable assembly 43700 can be configured to provide standardized data communications protocols and/or media (e.g., Ethernet, CAT5, CAT6, CAT7, USB). The compute 210 on the robot 1 establishes a data communication link with the station electronics assembly 43500 via the data conductors of the cable 43702, enabling the exchange of charging information including the state of charge of the battery pack 202, the temperature of the battery pack 202, voltages received at the robot's charging interface, and any fault information detected by the charging controller 200 or the battery management system. The magnetic connector 43704 is configured to removably (e.g., magnetically) attach to a corresponding magnetic receptacle 212.8 arranged on the robot 1.

When the magnetic connector 43704 is brought into proximity to the magnetic receptacle 212.8, the magnetic connector 43704 becomes attracted to the magnetic receptacle 212.8. In some embodiments, the magnetic connector 43704 and the magnetic receptacle 212.8 can provide electrical contacts that are non-directional, such as concentric pins and contact rings that are agnostic to the rotational position of the magnetic connector 43704 relative to the magnetic receptacle 212.8, such that circuits are properly connected regardless of how the magnetic connector 43704 may be rotated relative to the magnetic receptacle 212.8. In some embodiments, the magnetic connector 43704 and/or the magnetic receptacle 212.8 can include mechanical and/or magnetic features to cause the magnetic connector 43704 to rotate to a predetermined orientation relative to the magnetic receptacle 212.8 prior to making electrical contact. For example, magnets in the magnetic connector 43704 and the magnetic receptacle 212.8 can be arranged such that their poles will repel and attract each other in a way that repels the magnetic connector 43704 when alignment is incorrect and attracts the magnetic connector 43704 when alignment is correct. As such, the magnetic connector 43704 can passively self-attach to the magnetic receptacle 212.8 when the two are brought into close proximity, for example when the robot 1 maneuvers itself to bring the magnetic receptacle 212.8 within approximately 5 centimeters (cm) of the magnetic connector 43704, at which distance the attractive magnetic force becomes sufficient to draw the magnetic connector 43704 into engagement with the magnetic receptacle 212.8. In various embodiments, the self-attachment proximity threshold may range from approximately 2 cm to approximately 10 cm, depending on the strength of the magnets employed.

In operation, the docking station 43000 provides a solution for tasks that require the robot 1 to operate with continuous power within a defined work envelope, eliminating battery cycle limitations for prolonged or high-power operations. The robot 1 may start in a tethered configuration, with the magnetic receptacle 212.8 connected to the base 43100 by the cable assembly 43700 (e.g., the cable 43702 and the magnetic connector 43704). In such a configuration, the robot 1 can be partly or entirely powered by power provided by the base 43100 via the cable assembly 43700, such that the power received through the cable assembly 43700 supplements or entirely replaces the power drawn from the battery pack 202. As the robot moves around a work area generally defined by the length of the cable 43702, the retractor assembly 43005 can actively or passively play out and gather up the cable 43702.

The robot 1 may need to travel beyond the length of the cable 43702. The robot 1 is configured to determine the bounds of the working area in which the robot 1 can remain tethered to the docking station 43000. For instance, the robot 1 may determine the bounds of the working area based on a location of the docking station 43000 and a maximum length of the cable assembly 43700. As another possibility, the working area may be a predefined area within the map 16400 (FIG. 15) that is stored by the robot 1. Other examples for determining the bounds of the working area are also possible. If the robot 1 determines that a task will cause it to move out of the working area covered by the docking station 43000, the robot 1 may actively detach the magnetic connector 43704 from the magnetic receptacle 212.8 before walking beyond the cable's reach.

In situations where the robot 1 walks away from the docking station 43000 until it runs out of the cable 43702, the force of the robot's 1 movement can be sufficient to cause the magnetic connector 43704 to detach from the magnetic receptacle 212.8. Upon disconnection, the retractor assembly 43005 can gather up the detached cable 43702 to prevent the cable 43702 from becoming a tripping hazard. The breakaway force of the magnetic connection between the magnetic connector 43704 and the magnetic receptacle 212.8 may be calibrated to be above a threshold sufficient to prevent accidental disconnection during normal tethered operation, yet below a threshold that would cause the robot 1 to lose balance or stumble when the cable 43702 reaches its maximum deployed length.

In some embodiments, the robot 1 may be configured to actively detach the magnetic connector 43704 from the magnetic receptacle 212.8. For example, the magnetic receptacle 212.8 may include a controllable electromagnet that retains the magnetic connector 43704 or a mechanical assembly that actively detaches the magnetic connector, and the robot 1 may be configured to walk close to the base 43100 (e.g., to minimize the length of the cable 43702) before de-energizing the controllable electromagnet or otherwise releasing the magnetic connector 43704. Once untethered, the robot 1 can walk away under its own battery power.

The robot 1 can resume charging by walking to an area below the base 43100, where the cable 43702 and the magnetic connector 43704 may be passively suspended. The robot 1 can maneuver itself to bring the magnetic receptacle 212.8 into proximity (e.g., within approximately 5 cm) of the magnetic connector 43704, at which point the magnetic features of the magnetic connector 43704 can cause the magnetic connector 43704 to passively self-attach to the magnetic receptacle 212.8. In some embodiments, the robot 1 may use its own manipulators (e.g., a pair of arm assemblies coupled to the torso 16, each arm assembly terminating in a hand 56) to grasp the suspended magnetic connector 43704 and bring it into contact with the magnetic receptacle 212.8. For example, the robot 1 may grip the magnetic connector 43704 with a hand 56 of one of the arm assemblies and bring the magnetic connector 43704 within approximately 5 cm of the magnetic receptacle 212.8, at which distance the magnetic attraction causes the magnetic connector 43704 to self-align and attach to the magnetic receptacle 212.8, thereby providing an alternative re-attachment mechanism that does not depend on the robot 1 achieving precise positional alignment beneath the base 43100. The robot 1 may guide such hand-to-receptacle movements using proprioceptive feedback from joint encoders (i.e., the robot 1 knows the kinematic chain from the hand 56 to the magnetic receptacle 212.8 on its own torso 16), using visual feedback from vision sensors 108.2.6, or using a combination of both proprioceptive and visual feedback.

In some embodiments, the robot 1 can be dressed with an adapter vest that provides the magnetic receptacle 212.8 and connects the magnetic receptacle 212.8 to charging connectors located elsewhere on the robot 1. For example, the robot 1 may be configured with charging receptacles in the waist 604 (e.g., to be compatible with the charging posts 13306, 23390). In such examples, the robot 1 can be donned with a vest-like adapter that includes the magnetic receptacle 212.8 arranged in an upper portion of the vest (e.g., the upper back), and includes charging pins or posts (e.g., similar to charging posts 13306, 23390) and corresponding retainers arranged in a lower end to keep the charging pins in electrical contact with the charging receptacles in the waist 604. A collection of electrical conductors in the adapter vest can electrically connect the magnetic receptacle 212.8 to the charging pins and the robot's charging receptacles.

e. Sixth Embodiment of a Docking Station

Similar to the docking station 43000 as described above, FIG. 28 illustrates an alternative embodiment of a docking station 53000 with another magnetically coupled cable assembly 53700. In the illustrated example, the docking station 53000 includes a cable or cord assembly 53700 with a magnetic connector 53704 configured to removably (e.g., magnetically) attach to a corresponding magnetic receptacle 212.8′ arranged on the robot 1. For the sake of brevity, the detailed disclosure regarding the shared structural elements and operational modes of the docking station 43000 will not be repeated below, but it should be understood that across these embodiments, like numbers represent like structures. For example, the disclosure relating to the form and function of the magnetic connector 43704 applies with equal force to the magnetic connector 53704. Furthermore, it is to be understood that any one or more features of the docking stations described above can be used in conjunction with those disclosed regarding the docking station 53000, and vice-versa, creating hybrid implementations.

The cable assembly 53700 includes: (i) a cable 53702 and (ii) the magnetic connector or coupler 53704 as shown in FIG. 28. The cable 53702 is a flexible multi-conductor assembly configured to conduct charging power to the robot 1. The cable 53702 may further include data conductors (e.g., twisted-pair or shielded conductors) for establishing a data communication link between the compute 210 of the robot 1 and a station electronics assembly of the docking station 53000, enabling the exchange of charging information including state of charge, battery temperature, received voltage, and fault information. The magnetic connector 53704 is coupled to the end of the cable 53702 and is configured to removably (e.g., magnetically) attach to a corresponding magnetic receptacle 212.8′ arranged on the robot 1. As shown in FIG. 28, the magnetic connector 53704 houses a transmitter coil 54100 of a wireless power transmitter and at least one magnet 53706. When the magnetic connector 53704 is brought into proximity to the magnetic receptacle 212.8′, the magnet(s) 53706 in the magnetic connector 53704 become attracted to magnets 53708 of the magnetic receptacle 212.8′. The magnet(s) 53706 help align the transmitter coil assembly 54100 of the wireless power transmitter with the receiver coil assembly 54200 in the magnetic receptacle 212.8′ of the robot 1 when coupled for charging. This makes it easier to find the proper connection between the transmitter coil assembly 54100 and the receiver coil assembly 54200. The attractive force of the magnets 53706, 53708 also helps maintain the electrical connection between the transmitter coil assembly 54100 and the receiver coil assembly 54200 to ensure charging. The magnets 53706, 53708 may be arranged behind and/or around the respective coil 54100, 54200. In some embodiments, the at least one magnet 53708 of the magnetic receptacle 212.8′ is arranged behind the receiver coil assembly 54200, such that the magnet 53708 is positioned between the receiver coil assembly 54200 and the interior of the robot's torso 16. This arrangement positions the magnets out of the direct coupling path between the transmitter coil assembly 54100 and the receiver coil assembly 54200, thereby minimizing any interference with the wireless power transfer efficiency.

When wireless power is transferred from the transmitter coil assembly 54100 to the receiver coil assembly 54200, the alternating magnetic field induces an alternating current in the receiver coil assembly 54200. The charging controller 200 on the robot 1 receives this induced AC and the rectifier stage 200a converts it to a rectified DC voltage, which the DC-to-DC converter stage 200b then regulates to the appropriate charging voltage and current for the battery pack 202. The compute 210, communicatively coupled to the charging controller 200, monitors the received voltage at the receiver coil assembly 54200, the state of charge of the battery pack 202, the temperature of the battery pack 202, and any fault conditions, and communicates this charging information to the docking station 53000 via the data conductors in the cable 53702 or via in-band communication modulated onto the wireless power signal. The magnetic connector 53704, when brought within approximately 5 cm of the magnetic receptacle 212.8′, is attracted to the magnetic receptacle 212.8′ with sufficient force to self-attach and self-align the transmitter coil assembly 54100 with the receiver coil assembly 54200. The robot 1 may use its own manipulators to grip the magnetic connector 53704 with a hand 56 of one of its arm assemblies and bring the magnetic connector 53704 within 5 cm of the magnetic receptacle 212.8′ to initiate magnetic self-attachment, thereby connecting the robot 1 to the cable assembly 53700 for charging.

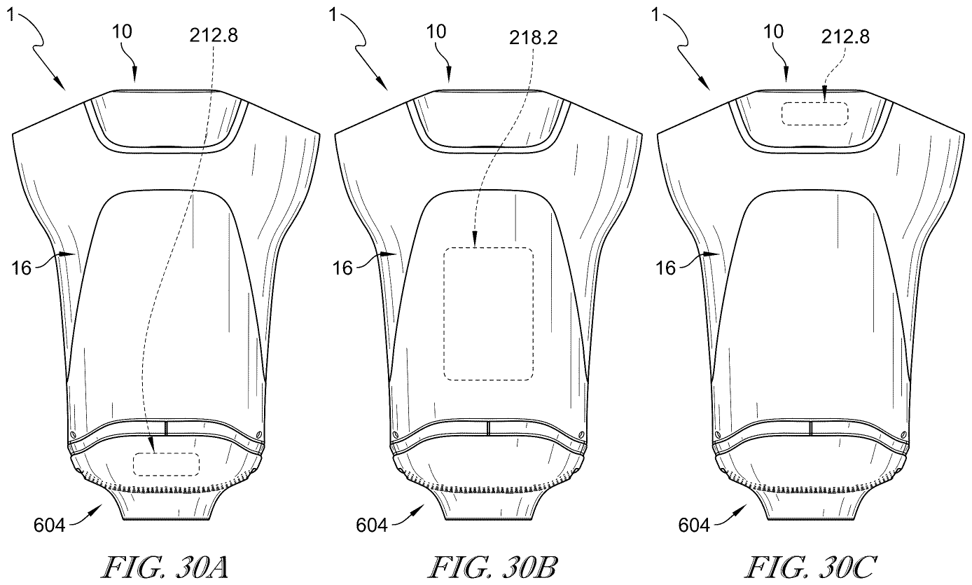

As shown in FIGS. 30A-C, the magnetic receptacle 212.8′ may be located on different extents of the robot's torso 16. As shown in FIG. 30A, the magnetic receptacle 212.8′ may be located in a lower extent of the robot's torso 16 near the robot's waist 604, such as on a rear surface of the waist 604. As shown in FIG. 30B, the magnetic receptacle 212.8′ may be located in a central extent of the robot's torso 16 between an upper extent (e.g., between the head and upper torso of the robot 1 or near the robot's cervical-thoracic junction) and the lower extent (e.g., above the robot's waist 604). As shown in FIG. 30C, the magnetic receptacle 212.8′ may be located in the upper extent of the robot's torso 16 at or above the robot's cervical-thoracic junction (e.g., between the head and upper torso of the robot 1 or near the robot's cervical-thoracic junction). The selection of the location of the magnetic receptacle 212.8′ on the robot's torso 16 may be based on the intended use case, the desired cable routing path, and the need to avoid interference with the robot's range of motion during tethered operation.

f. Seventh Embodiment of a Docking Station

Similar to the docking station 43000 as described above, FIG. 29 illustrates an alternative embodiment of a docking station 63000 with another magnetically coupled cable assembly 63700. In the illustrated example, the docking station 63000 includes a cable or cord assembly 63003 with a magnetic connector 63704 configured to removably (e.g., magnetically) attach to a corresponding magnetic receptacle 212.8″ arranged on the robot 1. The docking station 63000 employs conductive (direct-contact) power transfer rather than the wireless inductive power transfer of the sixth embodiment. For the sake of brevity, the detailed disclosure regarding the shared structural elements and operational modes of the docking station 43000 will not be repeated below, but it should be understood that across these embodiments, like numbers represent like structures. For example, the disclosure relating to the form and function of the magnetic connector 43704 applies with equal force to the magnetic connector 63704. Furthermore, it is to be understood that any one or more features of the docking stations described above can be used in conjunction with those disclosed regarding the conductive docking station 63000, and vice-versa, creating hybrid implementations.

The cable assembly 63003 includes: (i) a cable 63702 and (ii) the magnetic connector or coupler 63704 as shown in FIG. 29. The cable 63702 is a flexible multi-conductor assembly configured to conduct charging power to the robot 1. The cable 63702 includes power conductors for delivering direct current (DC) charging power and may further include data conductors for establishing a data communication link between the compute 210 of the robot 1 and the docking station 63000. The magnetic connector 63704 is coupled to the end of the cable 63702 and is configured to removably (e.g., magnetically) attach to a corresponding magnetic receptacle 212.8″ arranged on the robot 1. As shown in FIG. 29, the magnetic connector 63704 includes: (i) a connector base 63710, (ii) a magnetic shield 63712, and (iii) a collection of conductive contacts 63714 configured to couple to the contacts 212.8.2, 212.8.4 of the magnetic receptacle 212.8″.

The conductive contacts 63714 of the magnetic connector 63704 and the corresponding contacts 212.8.2, 212.8.4 of the magnetic receptacle 212.8″ together form a conductive charging interface that delivers DC power directly to the robot's charging controller 200. In this conductive embodiment, the charging controller 200 receives the direct current via the plurality of conductive contacts 212.8.2, 212.8.4, and the DC-to-DC converter stage 200b regulates the received DC voltage to the appropriate charging voltage and current for the battery pack 202, while the rectifier stage 200a may be bypassed. The compute 210, communicatively coupled to the charging controller 200, establishes a data communication link with the docking station 63000 via data conductors within the cable 63702 or via dedicated data contacts among the contacts 212.8.2, 212.8.4. Through this data communication link, the compute 210 exchanges charging information with the docking station 63000, including the state of charge of the battery pack 202, the temperature of the battery pack 202, the voltage received at the conductive contacts, and fault information such as overcurrent or overtemperature conditions.

The conductive contacts 63714 and the corresponding contacts 212.8.2, 212.8.4 may be implemented in several configurations. In some embodiments, the plurality of conductive contacts 212.8.2, 212.8.4 of the magnetic receptacle 212.8″ comprises an array of spring-loaded pogo pins configured to engage with corresponding flat or recessed contact surfaces of the magnetic connector 63704. The spring-loaded pogo pins each include a plunger, a spring, and a barrel, and are configured to provide a compliant electrical contact that accommodates manufacturing tolerances and minor misalignment during mating. The spring force of each pogo pin is selected to ensure reliable electrical contact while remaining within a range that does not impede the magnetic attachment or detachment of the magnetic connector 63704 from the magnetic receptacle 212.8″. Alternatively, the spring-loaded pogo pins may be arranged in the magnetic connector 63704 and configured to engage with corresponding contact pads on the magnetic receptacle 212.8″.

In some embodiments, the plurality of conductive contacts 212.8.2, 212.8.4 are arranged in a non-directional configuration such that circuits are properly connected regardless of a rotational position of the magnetic connector 63704 relative to the magnetic receptacle 212.8″. For example, the contacts 212.8.2, 212.8.4 may be arranged as concentric annular rings centered on the mating axis A, wherein each ring corresponds to a different electrical circuit (e.g., positive power, negative power/return, data signal, ground/shield). Corresponding concentric contact rings on the magnetic connector 63704 align with the rings on the magnetic receptacle 212.8″ regardless of the rotational orientation of the magnetic connector 63704, such that the power and data circuits are properly connected in any rotational position. In other embodiments, the contacts may be arranged as a central circular pad surrounded by one or more concentric rings, achieving the same rotational agnosticism.

i. Base

The connector base 63710 is configured to protect the conductors of the cable 63702 as they transition from a bundled arrangement in the cable 63702 to a distributed (e.g., flared out) arrangement in which the conductors each extend to a corresponding one of the conductive contacts 63714. In the illustrative embodiment, the connector base 63710 has a substantially rectangular shape. In other embodiments, the connector base 63710 may have a different shape to protect the conductors of the cable 63702, such as a cylindrical shape, a tetrahedron or triangular pyramid shape, a square pyramid shape, a cone shape, a rectangular prism shape, or a cube shape. The connector base 63710 may also have an ovoid shape, a hexagonal prism shape, or an asymmetric shape designed to facilitate single-orientation insertion.

The shape of the connector base 63710 is also configured so that the connector base 63710 is easily grippable by a human or robotic hand to facilitate single-handed plugging and unplugging operations. The exterior surface of the connector base 63710 may include textured regions, contoured grip zones, or rubberized overmolding to enhance grip security during manipulation. In the illustrated examples, the robot 1 can grip the cord assembly 63003 at the magnetic connector 63704 with a hand 56 of one of its arm assemblies, reach around its own back, and insert the magnetic connector 63704 into its own magnetic receptacle 212.8″ to connect the robot 1 to external power and/or data sources. The robot 1 may bring the magnetic connector 63704 within approximately 5 cm of the magnetic receptacle 212.8″, at which distance the magnets 63706, 63708 provide sufficient attractive force to draw the magnetic connector 63704 into final alignment and engagement with the magnetic receptacle 212.8″. In some implementations, the robot 1 can guide such movements based on actuator and joint positional information alone (e.g., the robot knows the position of the magnetic receptacle 212.8″ and its hand 56, therefore the robot 1 can determine the position of the magnetic connector 63704 in its hand 56 relative to the magnetic receptacle 212.8″). In some implementations, the robot 1 can use vision sensors 108.2.6 located in the back of the torso 16 or head 10 to observe the position of its hand 56 and the magnetic connector 63704 relative to the magnetic receptacle 212.8″ as the robot 1 plugs and unplugs itself from the cord assembly 63003.

As shown in FIG. 29, the connector base 63710 has substantially flat end 63710.2. In use, the flat end 63710.2 acts as a mechanical hard stop that prevents over-insertion of the magnetic connector 63704 into the magnetic receptacle 212.8″. The flat end 63710.2 is configured to engage the torso 16 of the robot 1 around the magnetic receptacle 212.8″ to prevent over-insertion of the magnetic connector 63704 into the magnetic receptacle 212.8″ in the illustrative embodiment. In other embodiments, the connector base 63710 may have a separate mechanical hard stop that extends from an extent thereof that is configured to engage with the torso 16 of the robot 1. For example, the mechanical hard stop may be one of a tab, a protrusion, a flange, a rib, a lip, or combination thereof that extends from an extent of the connector base 63710 and engages the torso 16 of the robot 1 when the magnetic connector 63704 is connected to the magnetic receptacle 212.8″.

ii. Magnetic Shield

As shown in FIG. 29, the magnetic shield 63712 extends from the flat end 63710.2 of the connector base 63710 and surrounds the conductive contacts 63714. The magnetic shield 63712 is formed of an electrically conductive material (e.g., metallic material such as copper, copper alloys, brass, aluminum alloys, etc.) and is electrically grounded to a corresponding ground or shield conductor in the cable 63702. In some embodiments, the magnetic shield 63712 may be non-conductive. The magnetic shield 63712 may include at least one magnet 63706 that is attracted to magnet(s) 63708 in the magnetic receptacle 212.8″. The magnetic shield 63712 serves to contain and redirect stray electromagnetic fields generated during conductive power transfer, thereby reducing EMI emissions in the vicinity of the connector and protecting nearby sensitive electronic systems within the robot's torso 16.

The magnetic shield 63712 has a shape that is complementary to the port housing 212.8.8 of the magnetic receptacle 212.8″ as shown in FIG. 29. In the illustrative embodiment, the magnetic shield 63712 has a substantially rectangular shape when viewed axially relative to the axis A. The magnetic shield 63712 includes: (i) four substantially rectangular walls 63712.2 and (ii) four rounded corners 63712.4 at the intersections of the walls 63712.2 as shown in FIG. 29. Alternatively, the walls 63712.2 of the magnetic shield 63712 may have different shaped walls 63712.2 to form another unique three-dimensional shape, e.g., two trapezoidal walls and two rectangular walls that extend between the trapezoidal walls. In other embodiments, the magnetic shield 63712 and the port housing 212.8.8 of the magnetic receptacle 212.8″ may have an asymmetrical shape. The port housing 212.8.8 having an asymmetrical shape ensures that the cord assembly 63003 can only be mated to the magnetic receptacle 212.8″ in a predetermined orientation that prevents the contacts 212.8.2, 212.8.4 from being connected to electrical contacts of the cord assembly 63003 in an incorrect (e.g., inverted) manner. This keyed, asymmetrical configuration provides polarity protection and prevents damage to the robot's electronics that could result from reversed power connections.

g. Other Alternative Embodiments

In various alternative embodiments, substitutions of components and materials may be made to alter the characteristics of the charging system. For instance, the active cooling system 5000 may be implemented using a solid-state thermoelectric cooling (TEC) module, commonly known as a Peltier device, in place of or in addition to forced-air fans. A TEC module could be thermally coupled to the heat spreader 4166 or the passive thermal transfer device 5200, where it would actively pump heat from the WPT electronics to an external heat sink. This embodiment provides silent, vibration-free cooling, which is advantageous in noise-sensitive or cleanroom environments, and allows for highly targeted and precisely controlled cooling of critical power electronics, improving their efficiency and operational lifespan. To augment or replace tactile feedback mechanisms, the support cradle 3300 may be equipped with non-contact proximity sensors, such as capacitive or ultrasonic sensors, arranged on the inner surface 3303. These sensors would generate real-time distance data to detect the robot's alignment and approach velocity prior to physical contact, enabling the robot's controller to make fine, closed-loop adjustments for a smoother and more reliable docking maneuver. In a further embodiment, the transmitter coils 4109 could be formed from superconducting wire which, when operated at cryogenic temperatures via an integrated cryocooler, would nearly eliminate resistive losses and enable ultra-high efficiency power transfer. For modular implementations, the major components may be joined using electro-permanent magnets, which require only a momentary pulse of electricity to switch their magnetic state but no continuous power to maintain a strong connection, allowing for rapid, tool-less assembly and disassembly with inherent safety against power failure.

Further embodiments may alter the data and power transfer methods. To provide a high-bandwidth and electromagnetically immune data interface, the system may incorporate a robust blind-mate optical fiber coupler, such as one utilizing TOSLINK or SFP standards. This coupler would be integrated into a feature like an alignment post 3306 and designed with self-aligning features to create a reliable physical optical link upon docking, even with minor positional tolerances. This permits the rapid offload of large sensor data logs without susceptibility to EMI from the power transfer system. To enhance security, a hardware-rooted mutual authentication system may be implemented using Physically Unclonable Function (PUF) integrated circuits in both the robot 1 and the station electronics assembly 3500. This system requires a successful, cryptographically secure challenge-response protocol, which is unique to the physical microstructure of each chip and thus resistant to cloning, before energizing the high-power systems. As an alternative to inductive power transfer, the system may utilize capacitive power transfer (CPT). In this embodiment, large-area conductive plates on the charging station and robot act as electrodes to transfer power via a high-frequency, high-voltage AC signal. This approach avoids the use of heavy ferrite materials, reduces magnetic field emissions, and can be engineered with specific geometries to contain fringing electric fields for safe operation.

The structural and geometric configuration of the charging system may be varied to suit different operational environments. In one embodiment, the entire docking station 3000 may be mounted directly to a wall with a hinged support cradle 3300 that folds down for use and up to conserve floor space, secured in both positions by a positive locking mechanism. In another configuration, the single waist-engaging support cradle 3300 may be replaced by two independent vertical posts extending from the base 3100 to engage with receptacles under the arms of the robot 1, potentially offering greater rotational stability. To enhance durability, the vertical support portion 3204 may incorporate a compliant mechanism, such as a spring or visco-elastic damper, to absorb docking impacts and reduce mechanical stress on both the station and the robot's chassis. The charging methodology may also be altered; for instance, a direct-contact DC fast-charging system may be implemented using conductive floor plates in the base 3100 that mate with retractable, self-cleaning contacts in the robot's feet 92, which may employ a wiping or brushing action upon extension to clear debris and ensure low contact resistance. Alternatively, the wireless power transmitter 4020 may be embodied as a modular array of low-profile inductive floor tiles, forming a “charging carpet” where an intelligent controller energizes only the specific tiles directly beneath the robot, optimizing efficiency and safety. A specialized version of this could be an inductive mat placed at a threshold or doorway for rapid opportunity charging during brief operational pauses.

Additional variations can provide adaptability and portability. To accommodate robots of different sizes or configurations, the charging tower 3180 and support cradle 3300 may feature a telescoping or otherwise height-adjustable mechanism. This could be motorized and automated, using a sensor on the station to identify the robot model and adjust to a pre-set optimal height. For temporary deployments, the entire dock may be designed to be collapsible, with a hinged vertical support portion 3204 and a fold-down base 3100, utilizing robust, quick-connect electrical couplings to allow it to fold into a compact form for transport. To achieve a minimal footprint, the system may consist solely of a wall-mounted bracket incorporating the support cradle 3300 and a small, flip-down foot shelf for temporary registration during docking, transferring the static load of the robot to the building structure. In another embodiment, the wireless power transmitter coils 4020 can be housed within a floor-recessed trench covered by a durable, non-metallic, and magnetically transparent composite material, creating a flush “parking stripe” charger that does not obstruct human traffic or other vehicles like forklifts.

Alterations to the charging methodology and process can further enhance autonomy and efficiency. In one embodiment, the charging station itself may be a mobile, self-powered, autonomous robot that navigates to a stationary work robot 1 to initiate charging, managed by a central fleet control system to minimize downtime across multiple work robots. The robot 1 may also be programmed to adopt a kneeling or prone posture for charging on a low-profile floor mat containing WPT transmitter coils, a method which achieves a very stable center of gravity and allows for larger, more powerful coils to be placed on the robot's torso or knees. The initiation of charging (step 6214) can be simplified by using a mechanical-only trigger, such as a pressure sensor or limit switch in the support cradle 3300, which directly signals the charging controller 4104 upon proper seating of the robot. Furthermore, the charging process may be augmented to include a dedicated battery conditioning phase, wherein the controller executes low-power, pulsed charging cycles to balance cells, measure internal impedance to track battery health, and perform diagnostics, potentially extending the battery's long-term operational lifespan.

The charging system may be integrated with additional functionalities to enhance security and utility. To prevent unauthorized removal or theft of the robot 1, the support cradle 3300 may be equipped with a physical locking mechanism, such as a solenoid-driven pin or a powerful electromagnet, controlled by the station electronics and requiring digital authentication before release. The system may also be extended to enable peer-to-peer power sharing between robots. In this configuration, robots could be equipped with a secondary, short-range power transfer interface, such as a retractable magnetic or conductive “bump” connector. This would allow a sufficiently charged robot, dispatched by a fleet manager, to donate a negotiated amount of energy to a critically low-power robot, enabling it to complete its task or reach a permanent charging station, thus increasing the resilience of the entire robotic system. In some embodiments, the peer-to-peer power sharing protocol may include a negotiation phase in which the donor robot and the recipient robot exchange battery state-of-charge data and a proposed energy transfer amount, and in which the donor robot verifies that it will retain sufficient charge to reach its own assigned docking station 3000 after the transfer is complete.

### I. INDUSTRIAL APPLICATION

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 19/000,626, 19/006,191, 19/033,973, 19/038,657, 19/064,596, 19/066,122, 19/180,106, 19/223,945, 19/224,109, 19/224,252, 19/249,517, 19/252,392, 19/252,708, 19/442,030, 19/443,231, 19/443,345, 19/536,458, 19/538,967, 19/552,233, 19/557,667, 19/557,966, 19/557,999, 19/558,158, 19/066,122, 19/180,106, 19/249,517, 19/286,240, 19/319,712, 19/323,751, 19/325,415, 19/325,486, 19/329,008, 19/337,852, 19/337,899, 19/347,690, 19/347,994, 19/351,294, 19/352,959, 19/355,393, 19/355,531, 19/355,786, 19/378,092, 19/378,308; and (iii) U.S. Design patents application Ser. Nos. 29/889,764, 29/928,748, 29/935,680, 29/954,572, 29/967,462, 29/993,115, and 29/998,761; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A humanoid robot comprising:
a torso;
a battery pack housed within the torso and configured to provide power to the humanoid robot;
a magnetic receptacle arranged on the torso of the humanoid robot, the magnetic receptacle comprising at least one magnet configured to magnetically couple with a corresponding magnet of a magnetic connector of a cable assembly;
a receiver coil assembly positioned within the magnetic receptacle, the receiver coil assembly configured to receive wireless power from a transmitter coil assembly housed within the magnetic connector of the cable assembly; and
a charging controller electrically coupled to the receiver coil assembly and the battery pack, the charging controller configured to convert alternating current induced in the receiver coil assembly to direct current for charging the battery pack.

2. The humanoid robot of claim 1, wherein the at least one magnet of the magnetic receptacle comprises a controllable electromagnet, and wherein the humanoid robot is configured to de-energize the controllable electromagnet to release the magnetic connector from the magnetic receptacle.

3. The humanoid robot of claim 1, wherein the at least one magnet of the magnetic receptacle is arranged behind the receiver coil assembly.

4. The humanoid robot of claim 1, wherein the at least one magnet of the magnetic receptacle and the corresponding magnet of the magnetic connector are configured such that the magnetic connector passively self-attaches to the magnetic receptacle when the humanoid robot moves into close proximity to the magnetic connector.

5. The humanoid robot of claim 1, wherein the humanoid robot is configured to, while the magnetic connector is coupled to the magnetic receptacle and while the receiver coil assembly is receiving wireless power from the transmitter coil assembly, move within a working area defined at least in part by a reach of the cable assembly.

6. The humanoid robot of claim 5, wherein the humanoid robot is configured to be partly or entirely powered by power received via the receiver coil assembly while moving within the working area.

7. The humanoid robot of claim 5, wherein the humanoid robot is configured to:
determine that a task will cause the humanoid robot to move outside the working area; and
in response to determining that the task will cause the humanoid robot to move outside the working area, detach the magnetic connector from the magnetic receptacle.

8. The humanoid robot of claim 1, wherein the magnetic receptacle is located at a lower extent of the torso and proximate to a waist of the humanoid robot.

9. The humanoid robot of claim 1, wherein the magnetic receptacle is located on a rear extent of the torso below a cervical-thoracic junction of the humanoid robot.

10. The humanoid robot of claim 1, wherein the magnetic receptacle is located on a rear extent of the torso at or above a cervical-thoracic junction of the humanoid robot.

11. The humanoid robot of claim 1, wherein the charging controller comprises:
a rectifier configured to convert the alternating current induced in the receiver coil assembly to a rectified direct current voltage; and
a DC-to-DC converter configured to regulate the rectified direct current voltage for charging the battery pack.

12. The humanoid robot of claim 1, further comprising a compute communicatively coupled to the charging controller, wherein the compute is configured to establish a data communication link with a docking station via the cable assembly to communicate charging information.

13. The humanoid robot of claim 12, wherein the charging information comprises at least one of a state of charge of the battery pack, a temperature of the battery pack, a voltage received by the receiver coil assembly, or fault information.

14. The humanoid robot of claim 1, further comprising a pair of arm assemblies coupled to the torso, wherein the humanoid robot is configured to grip the magnetic connector with a hand of one of the arm assemblies and bring the magnetic connector within 5 cm of the magnetic receptacle in order to connect the humanoid robot to the cable assembly.

15. A humanoid robot comprising:
a torso;
a battery pack housed within the torso and configured to provide power to the humanoid robot;
a magnetic receptacle arranged on the torso of the humanoid robot, the magnetic receptacle comprising:
at least one magnet configured to magnetically couple with a corresponding magnet of a magnetic connector of a cable assembly; and
a plurality of conductive contacts configured to electrically couple with corresponding conductive contacts of the magnetic connector when the magnetic connector is coupled to the magnetic receptacle;
a charging controller electrically coupled to the plurality of conductive contacts and the battery pack, the charging controller configured to receive direct current via the plurality of conductive contacts for charging the battery pack; and
a compute communicatively coupled to the charging controller and configured to establish a data communication link with a docking station via the cable assembly.

16. The humanoid robot of claim 15, wherein the plurality of conductive contacts comprises an array of spring-loaded pins configured to engage with corresponding contact surfaces of the magnetic connector.

17. The humanoid robot of claim 15, wherein the plurality of conductive contacts are non-directional such that circuits are properly connected regardless of a rotational position of the magnetic connector relative to the magnetic receptacle.

18. The humanoid robot of claim 15, wherein the magnetic receptacle further comprises a port housing having an asymmetrical shape such that the magnetic connector can only be mated to the magnetic receptacle in a predetermined orientation.

19. A system comprising:
a humanoid robot comprising:
a torso;
a battery pack housed within the torso and configured to provide power to the humanoid robot; and
a magnetic receptacle arranged on a rear extent of the torso of the humanoid robot, the magnetic receptacle comprising at least one magnet; and
a docking station comprising:
a cable assembly comprising a cable and a magnetic connector coupled to an end of the cable, the magnetic connector comprising a corresponding at least one magnet configured to magnetically couple with the at least one magnet of the magnetic receptacle when the magnetic connector is brought into proximity to the magnetic receptacle; and
a power supply unit configured to provide power to the cable assembly for charging the battery pack of the humanoid robot when the magnetic connector is coupled to the magnetic receptacle.

20. The system of claim 19, wherein the docking station further comprises a retractor assembly coupled to the cable assembly, the retractor assembly configured to extend and retract the cable as the humanoid robot moves.
